(19) United States
(12) Patent Application Publication
(10) Pub. No.: US 2009/0172674 A1
(43) Pub. Date: Jul. 2, 2009

(54) MANAGING THE COMPUTER COLLECTION OF INFORMATION IN AN INFORMATION TECHNOLOGY ENVIRONMENT

(75) Inventors: Mythili K. BOBAK, Lagrangeville, NY (US); Tim A. McCONNELL, Lexington, KY (US); Michael D. SWANSON, Springfield, OR (US)

Correspondence Address: HESLIN ROTHENBERG FARLEY & MESITI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 11/965,917

(22) Filed: Dec. 28, 2007

(51) Int. Cl. G06F 9/46

(52) U.S. Cl. 718/101

(57) ABSTRACT

The collection of information in an Information Technology environment is dynamically managed. Processing associated with a batch of requests executed to obtain information is adjusted in real-time based on whether responses to the requests executed within an allotted time frame were received. The adjustments may include adjusting the time allotted to execute a batch of requests, adjusting the number of requests in a batch, and/or adjusting the execution priority of the requests within a batch.

### TECHNICAL FIELD

This invention relates, in general, to managing customer environments to provide support for business resiliency, and in particular, to managing the collection of information in an Information Technology environment to ensure the processing of requests for the information has minimal impact on the environment, but provides the most appropriate information to be used in managing the environment.

### BACKGROUND OF THE INVENTION

Today, customers attempt to manually manage and align their availability management with their information technology (IT) infrastructure. Changes in either business needs or the underlying infrastructure are often not captured in a timely manner and require considerable rework, leading to an inflexible environment.

Often high availability solutions and disaster recovery technologies are handled via a number of disparate point products that target specific scopes of failure, platforms or applications. Integrating these solutions into an end-to-end solution is a complex task left to the customer, with results being either proprietary and very specific, or unsuccessful.

Customers do not have the tools and infrastructure in place to customize their availability management infrastructure to respond to failures in a way that allows for a more graceful degradation of their environments. As a result, more drastic and costly actions may be taken (such as a site switch) when other options (such as disabling a set of applications or users) could have been offered, depending on business needs.

Coordination across availability management and other systems management disciplines is either nonexistent or accomplished via non-reusable, proprietary, custom technology.

There is little predictability as to whether the desired recovery objective will be achieved, prior to time of failure. There are only manual, labor intensive techniques to connect recovery actions with the business impact of failures and degradations.

Any change in the underlying application, technologies, business recovery objectives, resources or their interrelationships require a manual assessment of impact to the hand-crafted recovery scheme.

### SUMMARY OF THE INVENTION

Based on the foregoing, a need exists for a capability to facilitate management of an IT environment. In one example, a need exists for a capability that manages the collection of information usable in managing the environment. As one example, a batch of requests (or queries) is executed within an allocated time interval. Then, depending on whether responses were received for the requests, processing associated with the batch of requests is adjusted in real-time to improve batch execution in a next iteration.

The shortcomings of the prior art are overcome and additional advantages are provided through the provision of a computer-implemented method to manage the collection of information in an Information Technology (IT) environment. The method includes, for instance, executing a batch of queries within an allocated time period; determining, in response to completion of the allocated time period, whether a response was not obtained for one or more queries of the batch of queries; and dynamically adjusting, in real-time, processing associated with the batch of queries, in response to the determining.

Computer program products and systems relating to one or more aspects of the present invention are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a processing environment to incorporate and use one or more aspects of the present invention;

FIG. 2 depicts another embodiment of a processing environment to incorporate and use one or more aspects of the present invention;

FIG. 3 depicts yet a further embodiment of a processing environment to incorporate and use one or more aspects of the present invention;

FIG. 4 depicts one embodiment of a Business Resilience System used in accordance with an aspect of the present invention;

FIG. 5A depicts one example of a screen display of a business resilience perspective, in accordance with an aspect of the present invention;

FIG. 5B depicts one example of a screen display of a Recovery Segment, in accordance with an aspect of the present invention;

FIG. 6A depicts one example of a notification view indicating a plurality of notifications, in accordance with an aspect of the present invention;

FIG. 6B depicts one example of a notification message sent to a user, in accordance with an aspect of the present invention;

FIG. 7 depicts one example of a Recovery Segment of the Business Resilience System of FIG. 4, in accordance with an aspect of the present invention;

FIG. 8A depicts examples of key Recovery Time Objective properties for a particular resource, in accordance with an aspect of the present invention;

FIG. 8B depicts one example in which Recovery Time Objective properties collectively form an observation of a Pattern System Environment, in accordance with an aspect of the present invention;

FIG. 9 depicts one embodiment of an overview of a Business Resilience Asynchronous Distributor (BRAD), in accordance with an aspect of the present invention;

FIG. 10 depicts one embodiment of various classes used to implement a BRAD, in accordance with an aspect of the present invention;

FIG. 11 depicts one example of a plurality of hosting containers hosting resources of a Recovery Segment, in accordance with an aspect of the present invention;

FIG. 12 depicts one example of a BR manager interacting with BRAD distributors, in accordance with an aspect of the present invention;

FIG. 13 depicts one example of a dependency graph for a Recovery Segment, in accordance with an aspect of the present invention;

FIGS. 14A-14B depict one embodiment of an overview of a periodic poll process used in accordance with an aspect of the present invention;

FIG. 15 depicts one embodiment of the logic to deploy a BRAD, in accordance with an aspect of the present invention;

FIG. 16 depicts one embodiment of the logic to initialize a BRAD, in accordance with an aspect of the present invention;

FIGS. 17A-17H depict one embodiment of the logic to initiate periodic poll observation, in accordance with an aspect of the present invention;

FIGS. 18A-18B depict one embodiment of the logic to process BRAD requests, in accordance with an aspect of the present invention;

FIG. 19 depicts one embodiment of the BRAD state query logic, in accordance with an aspect of the present invention;

FIG. 20 depicts one embodiment of the BRAD query thread logic, in accordance with an aspect of the present invention;

FIGS. 21A-21E depict one embodiment of the logic to respond to a request, in accordance with an aspect of the present invention;

FIGS. 22A-22E depict one embodiment of the logic to complete a BRAD client request, in accordance with an aspect of the present invention; and

FIG. 23 depicts one embodiment of a computer program product incorporating one or more aspects of the present invention.

### DETAILED DESCRIPTION OF THE INVENTION

In managing a customer's environment, such as its business environment, there is a set of requirements unaddressed by existing technology, which causes unpredictable down time, large impact failures and recoveries, and significant extra labor cost, with resulting loss of business revenue. These requirements include, for instance:
1. Ensuring that there is a consistent recovery scheme across the environment, linked to the business application, across the different types of resources; not a different methodology performed by platform silo. The recovery is to match the scope of the business application, not limited in scope to a single platform. The recovery is to be end-to-end and allow for interaction across multiple vendor products. In one example, a business application is defined as a process that is supported by IT services. It is supportive of the products and/or services created by a customer. It can be of fine granularity (e.g., a specific service/product provided) or of coarse granularity (e.g., a group of services/products provided).
2. Ability to group together mixed resource types (servers, storage, applications, subsystems, network, etc.) into logical groupings aligned with business processes requirements for availability.
3. Ability to share resources across logical groups of resources; ability to nest these logical group definitions, with specifications for goal policy accepted and implemented at each level.
4. Pre-specified recommendations for resource groupings, with customization possible, and pattern matching customer configuration with vendor or customer provided groupings/relationships—to avoid requiring customers to start from scratch for definitions.
5. Ability to group together redundant resources with functional equivalence—use during validation when customer has less redundancy than required to meet the Recovery Time Objective (RTO) goal; in recovery to select an alternate resource for one that has failed.
6. Ability to configure the definition of what constitutes available, degraded, or unavailable based on customer's own sensitivity for a given grouping of resources, and business needs, and further aggregate the state across various resources to produce an overall state for the business application. The state is to be assessed real time, based on what is actually occurring in the system at the time, rather than fixed definitions. In some cases, a performance slowdown might flag a degraded environment, and in other cases, a failure may be necessary before flagging a degraded or unavailable environment. The definitions of available, degraded and unavailable are to be consumed by an availability system that evaluates them in the context of a policy, and then determines appropriate action, including possibly launching recovery automatically.
7. Ability to relate the redundancy capability of relevant resources to the availability status of a business application.
8. Allow customers to configure when recovery actions can be delegated to lower level resources, particularly since resource sharing is becoming more relevant in many customer environments.
9. Include customer or vendor best practices for availability as prespecified workflows, expressed in a standards based manner, that can be customized.
10. Ability to specify quantitative business goals for the recovery of logical groupings of resources, effecting both how the resources are pre-configured for recovery, as well as recovered during errors. One such quantitative goal is Recovery Time Objective (RTO). As part of the specification of quantitative business goals, to be able to include time bias of applications, and facilitate the encoding of appropriate regulatory requirements for handling of certain workloads during changing business cycles in selected businesses, such as financial services.
11. Decomposition of the overall quantified RTO goal to nested logical groups; processing for shared groups having different goals.
12. Ability to configure redundancy groupings and co-location requirements with resources from other vendors, using a representation for resources (which may be, for example, standards based), with ability to clearly identify the vendor as part of the resource definition.
13. Ability to use customer's own historical system measures to automatically generate various system environments, then use these system environments when specifying quantitative recovery goals (since recovery time achievability and requirements are not consistent across time of day, business cycle, etc.). The function is to be able to incorporate historical information from dependent resources, as part of the automatic generation of system environments.
14. Specification of statistical thresholds for acceptability of using historical information; customer specification directly of expected operation times and directive to use customer specified values.
15. Environments are matched to IT operations and time of day, with automatic processing under a new system environment at time boundaries—no automatic internal adjustment of RTO is to be allowed, rather changed if the customer has specified that a different RTO is needed for different system environments.
16. Goal Validation—Prior to failure time. Ability to see assessment of achievable recovery time, in, for instance, a Gantt chart like manner, detailing what is achievable for each resource and taking into account overlaps of recovery sequences, and differentiating by system environment. Specific use can be during risk assessments, management requests for additional recovery related resources, mitigation plans for where there are potentials for RTO miss. Example customer questions:
   What is my expected recovery time for a given application during “end of month close” system environment?
   What is the longest component of that recovery time?
   Can I expect to achieve the desired RTO during the “market open” for stock exchange or financial services applications?
   What would be the optimal sequence and parallelization of recovery for the resources used by my business application?
17. Ability to prepare the environment to meet the desired quantitative business goals, allowing for tradeoffs when shared resources are involved. Ensure that both automated and non-automated tasks can be incorporated into the pre-conditioning. Example of customer question: What would I need to do for pre-conditioning my system to support the RTO goal I need to achieve for this business application?
18. Ability to incorporate operations from any vendors' resources for pre-conditioning or recovery workflows, including specification of which pre-conditioning operations have effect on recoveries, which operations have dependencies on others, either within vendor resources or across resources from multiple vendors.
19. Customer ability to modify pre-conditioning workflows, consistent with supported operations on resources.
20. Ability to undo pre-conditioning actions taken, when there is a failure to complete a transactionally consistent set of pre-conditioning actions; recognize the failure, show customers the optional workflow to undo the actions taken, allow them to decide preferred technique for reacting to the failure—manual intervention, running undo set of operations, combination of both, etc.
21. Ability to divide pre-conditioning work between long running and immediate, nondisruptive short term actions.
22. Impact only the smallest set of resources required during recovery, to avoid negative residual or side effects for attempting to recover a broader set of resources than what is actually impacted by the failure.
23. Choosing recovery operations based on determination of which recovery actions address the minimal impact, to meet goal, and then prepare for subsequent escalation in event of failure of initial recovery actions.
24. Choosing a target for applications and operating systems (OS), based on customer co-location specifications, redundancy groups, and realtime system state.
25. Ability for customer to indicate specific effect that recovery of a given business process can have on another business process—to avoid situations where lower priority workloads are recovered causing disruption to higher priority workloads; handling situations where resources are shared.
26. Ability to prioritize ongoing recovery processing over configuration changes to an availability system, and over any other administration functions required for the availability system.
27. Ability for recoveries and pre-conditioning actions to run as entire transactions so that partial results are appropriately accounted for and backed out or compensated, based on actual effect (e.g., during recovery time or even pre-conditioning, not all actions may succeed, so need to preserve a consistent environment).
28. Allow for possible non-responsive resources or underlying infrastructure that does not have known maximum delays in response time in determining recovery actions, while not going beyond the allotted recovery time.
29. Allow customer to change quantified business recovery goals/targets without disruption to the existing recovery capability, with appropriate labeling of version of the policy to facilitate interaction with change management systems.
30. Allow customers to change logical groupings of resources that have assigned recovery goals, without disruption to the existing recovery capability, with changes versioned to facilitate interaction with change management systems.
31. Ability to specify customizable human tasks, with time specifications that can be incorporated into the goal achievement validation so customers can understand the full time involved for a recovery and where focusing on IT and people time is critical to reducing RTO.
32. There is a requirement/desire to implement dynamically modified redundancy groupings for those resources which are high volume—automatic inclusion based on a specified set of characteristics and a matching criteria.
33. There is a requirement/desire to automatically add/delete resources from the logical resource groupings for sets of resources that are not needing individual assessment.

The above set of requirements is addressed, however, by a Business Resiliency (BR) Management System, of which one or more aspects of the present invention are included. The Business Resiliency Management System provides, for instance:
1. Rapid identification of fault scope.
   Correlation and identification of dependencies between business functions and the supporting IT resources.
   Impact analysis of failures affecting business functions, across resources used within the business functions, including the applications and data.
   Isolation of failure scope to smallest set of resources, to ensure that any disruptive recovery actions effect only the necessary resources.
2. Rapid granular and graceful degradation of IT service.
   Discontinuation of services based on business priorities.
   Selection of alternate resources at various levels may include selection of hardware, application software, data, etc.
   Notifications to allow applications to tailor or reduce service consumption during times of availability constraints.
3. Integration of availability management with normal business operations and other core business processes.
   Policy controls for availability and planned reconfiguration, aligned with business objectives.
   Encapsulation, integration of isolated point solutions into availability IT fabric, through identification of affected resources and operations initiated by the solutions, as well as business resiliency.
   Goal based policy support, associated with Recovery Segments that may be overlapped or nested in scope.
   Derivation of data currency requirements, based on business availability goals.

One goal of the BR system is to allow customers to align their supporting information technology systems with their business goals for handling failures of various scopes, and to offer a continuum of recovery services from finer grained process failures to broader scoped site outages. The BR system is built around the idea of identifying the components that constitute a business function, and identifying successive levels of recovery that lead to more complex constructs as the solution evolves. The various recovery options are connected by an overall BR management capability that is driven by policy controls.

Various characteristics of one embodiment of a BR system include:
1. Capability for dynamic generation of recovery actions, into a programmatic and manageable entity.
2. Dynamic generation of configuration changes required/desired to support a customer defined Recovery Time Objective (RTO) goal.
3. Dynamic definition of key Pattern System Environments (PSEs) through statistical analysis of historical observations.
4. Validation of whether requested RTO goals are achievable, based on observed historical snapshots of outages or customer specified recovery operation time duration, in the context of key Pattern System Environments.
5. BR system dynamic, automatic generation and use of standards based Business Process Execution Language (BPEL) workflows to specify recovery transactions and allow for customer integration through workflow authoring tools.
6. Ability to configure customized scopes of recovery, based on topologies of resources and their relationships, called Recovery Segments (RSs).
7. Best practice workflows for configuration and recovery, including, but not limited to, those for different resource types: servers, storage, network, and middleware, as examples.
8. Ability to customize the definition of available, degraded, unavailable states for Recovery Segments.
9. Ability to represent customers' recommended configurations via best practice templates.
10. Ability to define the impact that recovery of one business application is allowed to have on other business applications.
11. Ability to correlate errors from the same or multiple resources into related outages and perform root cause analysis prior to initiating recovery actions.
12. Quantified policy driven, goal oriented management of unplanned outages.
13. Groupings of IT resources that have associated, consistent recovery policy and recovery actions, classified as Recovery Segments.
14. Handling of situations where the underlying error detection and notifications system itself is unavailable.

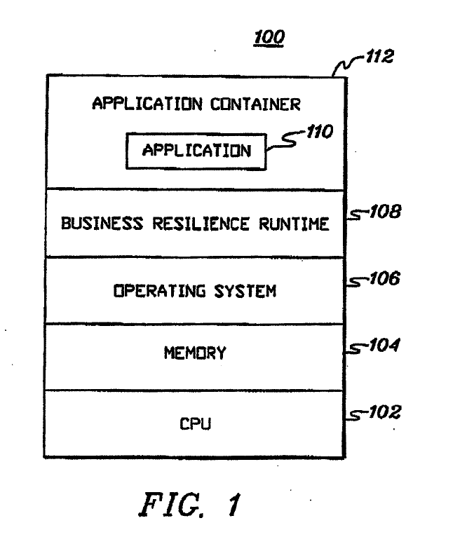

A Business Resilience System is capable of being incorporated in and used by many types of environments. One example of a processing environment to incorporate and use aspects of a BR system, including one or more aspects of the present invention, is described with reference to FIG. 1.

Processing environment 100 includes, for instance, a central processing unit (CPU) 102 coupled to memory 104 and executing an operating system 106. Examples of operating systems include AIX® and z/OS®, offered by International Business Machines Corporation; Linux; etc. AIX® and z/OS® are registered trademarks of International Business Machines Corporation, Armonk, N.Y., U.S.A. Other names used herein may be registered trademarks, trademarks or product names of International Business Machines Corporation or other companies.

The operating system manages execution of a Business Resilience Runtime Component 108 of a Business Resilience System, described herein, and one or more applications 110 of an application container 112.

As examples, processing environment 100 includes an IBM® System z™ processor or a pSeries® server offered by International Business Machines Corporation; a Linux server; or other servers, processors, etc. Processing environment 100 may include more, less and/or different components than described herein. (pSeries® is a registered trademark of International Business Machines Corporation, Armonk, N.Y., USA.)

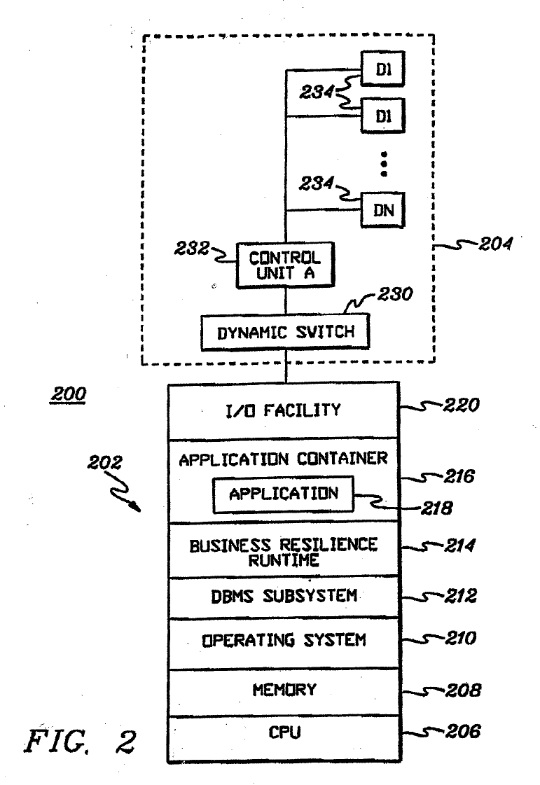

Another example of a processing environment to incorporate and use aspects of a BR System, including one or more aspects of the present invention, is described with reference to FIG. 2.

As shown, a processing environment 200 includes for instance, a central processing complex 202 coupled to an input/output (I/O) subsystem 204. Central processing complex 202 includes, for instance, a central processing unit 206, memory 208, an operating system 210, a database management system 212, a Business Resilience Runtime Component 214, an application container 216 including one or more applications 218, and an I/O facility 220.

I/O facility 220 couples central processing complex 202 to I/O subsystem 204 via, for example, a dynamic switch 230. Dynamic switch 230 is coupled to a control unit 232, which is further coupled to one or more I/O devices 234, such as one or more direct access storage devices (DASD).

Processing environments 100 and/or 200 may include, in other embodiments, more, less and/or different components.

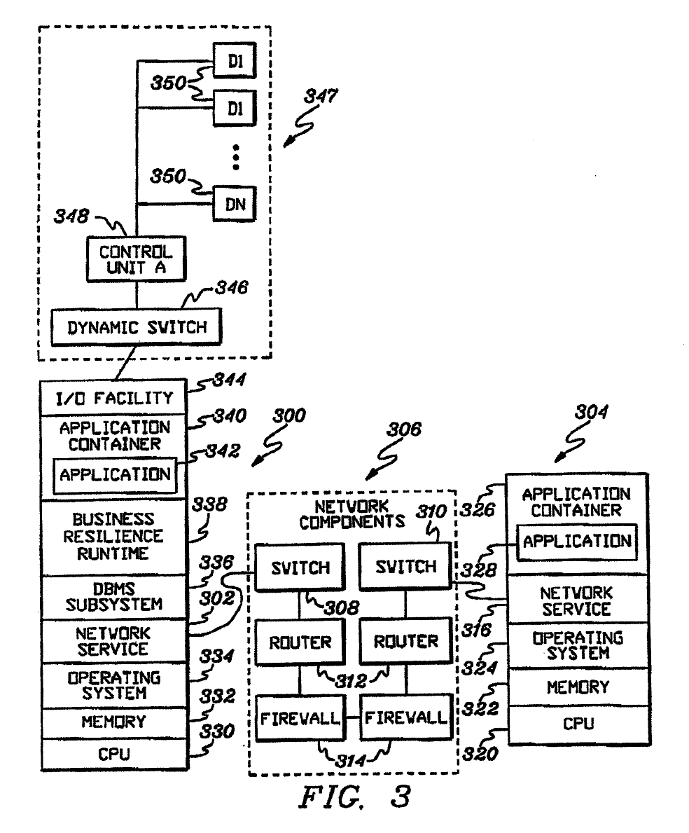

In yet another embodiment, a central processing complex 300 (FIG. 3) further includes a network service 302, which is used to couple a central processing complex 300 to a processing environment 304 via a network subsystem 306.

For example, network service 302 of central processing complex 300 is coupled to a switch 308 of network subsystem 306. Switch 308 is coupled to a switch 310 via routers 312 and firewalls 314. Switch 310 is further coupled to a network service 316 of processing environment 304.

Processing environment 304 further includes, for instance, a central processing unit 320, a memory 322, an operating system 324, and an application container 326 including one or more applications 328. In other embodiments, it can include more, less and/or different components.

Moreover, CPC 300 further includes, in one embodiment, a central processing unit 330, a memory 332, an operating system 334, a database management system 336, a Business Resilience Runtime Component 338, an application container 340 including one or more applications 342, and an I/O facility 344. It also may include more, less and/or different components.

I/O facility 344 is coupled to a dynamic switch 346 of an I/O subsystem 347. Dynamic switch 346 is further coupled to a control unit 348, which is coupled to one or more I/O devices 350.

Although examples of various environments are provided herein, these are only examples. Many variations to the above environments are possible and are considered within the scope of the present invention.

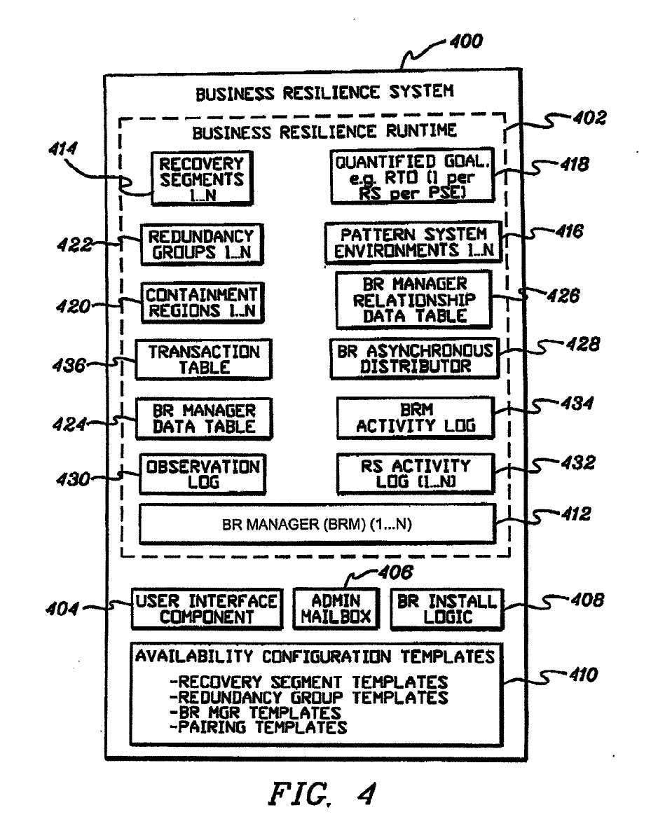

In the above-described environments, a Business Resilience Runtime Component of a Business Resilience System is included. Further details associated with a Business Resilience Runtime Component and a Business Resilience System are described with reference to FIG. 4.

In one example, a Business Resilience System 400 is a component that represents the management of recovery operations and configurations across an IT environment. Within that Business Resilience System, there is a Business Resilience Runtime Component (402) that represents the management functionality across multiple distinct Recovery Segments, and provides the service level automation and the support of creation of the recovery sequences. In addition, there are user interface (404), administration (406), installation (408) and configuration template (410) components within the Business Resilience System that enable the administrative operations that are to be performed. Each of these components is described in further detail below.

Business Resilience Runtime Component 402 includes a plurality of components of the BR System that are directly responsible for the collection of observations, creation of PSEs, policy acceptance, validation, error detection, and formulation of recovery sequences. As one example, Business Resilience Runtime Component 402 includes the following components:
1. One or more Business Resilience Managers (BRM) (412).
   The Business Resilience Manager (BRM) is the primary component containing logic to detect potential errors in the IT environment, perform assessment to find resources causing errors, and formulate recovery sequences to reestablish the desired state for resources for all Recovery Segments that may be impacted.
   The Business Resilience Manager is a component of which there can be one or more. It manages a set of Recovery Segments, and has primary responsibility to formulate recovery sequences. The association of which Recovery Segments are managed by a given BRM is determined at deployment time by the customer, with the help of deployment time templates. BRMs are primarily responsible for operations that relate to error handling and recovery workflow generation, and cross RS interaction.
2. One or more Recovery Segments (RS) (414).
   Recovery Segments are customer-defined groupings of IT resources to which consistent availability policy is assigned. In other words, a Recovery Segment acts as a context within which resource recovery is performed. In many cases, Recovery Segments are compositions of IT resources that constitute logical entities, such as a middleware and its related physical resources, or an “application” and its related components.
   There is no presumed granularity of a Recovery Segment. Customers can choose to specify fine-grained Recovery Segments, such as one for a given operating system, or a coarser grained Recovery Segment associated with a business process and its component parts, or even a site, as examples.
   Relationships between IT resources associated with a RS are those which are part of the IT topology.
   Recovery Segments can be nested or overlapped. In case of overlapping Recovery Segments, there can be policy associated with each RS, and during policy validation, conflicting definitions are reconciled. Runtime assessment is also used for policy tradeoff.
   The Recovery Segment has operations which support policy expression, validation, decomposition, and assessment of state.
   The number of Recovery Segments supported by a BR System can vary, depending on customer configurations and business needs.
   One BRM can manage multiple Recovery Segments, but a given RS is managed by a single BRM. Further, Recovery Segments that share resources, or are subset/superset of other Recovery Segments are managed by the same BRM, in this example. Multiple BRMs can exist in the environment, depending on performance, availability, and/or maintainability characteristics.
3. Pattern System Environments (PSEs) (416).
   Pattern System Environments (PSEs) are representations of a customer's environment. Sets of observations are clustered together using available mathematical tooling to generate the PSEs. In one embodiment, the generation of a PSE is automatic. PSE is associated with a given RS, but a PSE may include information that crosses RSs.
   As one example, the representation is programmatic in that it is contained within a structure from which information can be added/extracted.
4. Quantified Recovery Goal (418).
   A quantified recovery goal, such as a Recovery Time Objective (RTO), is specified for each Recovery Segment that a customer creates. If customers have multiple Pattern System Environments (PSEs), a unique RTO for each PSE associated with the RS may be specified.
5. Containment Region (CR) (420).
   Containment Region(s) are components of the BR System which are used at runtime to reflect the scope and impact of an outage. A Containment Region includes, for instance, identification for a set of impacted resources, as well as BR specific information about the failure/degraded state, as well as proposed recovery. CRs are associated with a set of impacted resources, and are dynamically constructed by BR in assessing the error.
   The original resources reporting degraded availability, as well as the resources related to those reporting degraded availability, are identified as part of the Containment Region. Impacted resources are accumulated into the topology by traversing the IT relationships and inspecting the attributes defined to the relationships. The Containment Region is transitioned to an inactive state after a successful recovery workflow has completed, and after all information (or a selected subset in another example) about the CR has been logged.
6. Redundancy Groups (RG) (422).
   Redundancy Group(s) (422) are components of the BR System that represent sets of logically equivalent services that can be used as alternates when a resource experiences failure or degradation. For example, three instances of a database may form a redundancy group, if an application server requires connectivity to one of the set of three, but does not specify one specific instance.
   There can be zero or more Redundancy Groups in a BR System.
   Redundancy Groups also have an associated state that is maintained in realtime, and can contribute to the definition of what constitutes available, degraded, or unavailable states. In addition, Redundancy Groups members are dynamically and automatically selected by the BR System, based on availability of the member and co-location constraints.
7. BR Manager Data Table (BRMD) (424).
   BR maintains specific internal information related to various resources it manages and each entry in the BR specific Management Data (BRMD) table represents such a record of management. Entries in the BRMD represent IT resources.
8. BR Manager Relationship Data Table (BRRD) (426).
   BR maintains BR specific internal information related to the pairings of resources it needs to interact with, and each entry in the BR specific Relationship Data (BRRD) table represents an instance of such a pairing. The pairing record identifies the resources that participate in the pairing, and resources can be any of those that appear in the BRMD above. The BRRD includes information about the pairings, which include operation ordering across resources, failure and degradation impact across resources, constraint specifications for allowable recovery actions, effect an operation has on resource state, requirements for resource to co-locate or anti-co-locate, and effects of preparatory actions on resources.
9. BR Asynchronous Distributor (BRAD) (428).
   The BR Asynchronous Distributor (BRAD) is used to handle asynchronous behavior during time critical queries for resource state and key properties, recovery, and for getting observations back from resources for the observation log.
10. Observation Log (430).
   The Observation Log captures the information that is returned through periodic observations of the environment. The information in the Observation Log is used by cluster tooling to generate Pattern System Environments (PSE).
11. RS Activity Log (432).
   Each RS has an activity log that represents the RS actions, successes, failures. Activity logs are internal BR structures. Primarily, they are used for either problem determination purposes or at runtime, recovery of failed BR components. For example, when the RS fails and recovers, it reads the Activity Log to understand what was in progress at time of failure, and what needs to be handled in terms of residuals.
12. BRM Activity Log (434).
   The BRM also has an activity log that represents BRM actions, success, failures. Activity logs are internal BR structures.
13. Transaction Table (TT) (436).
   The transaction table is a serialization mechanism used to house the counts of ongoing recovery and preparatory operations. It is associated with the RS, and is referred to as the RS TT.

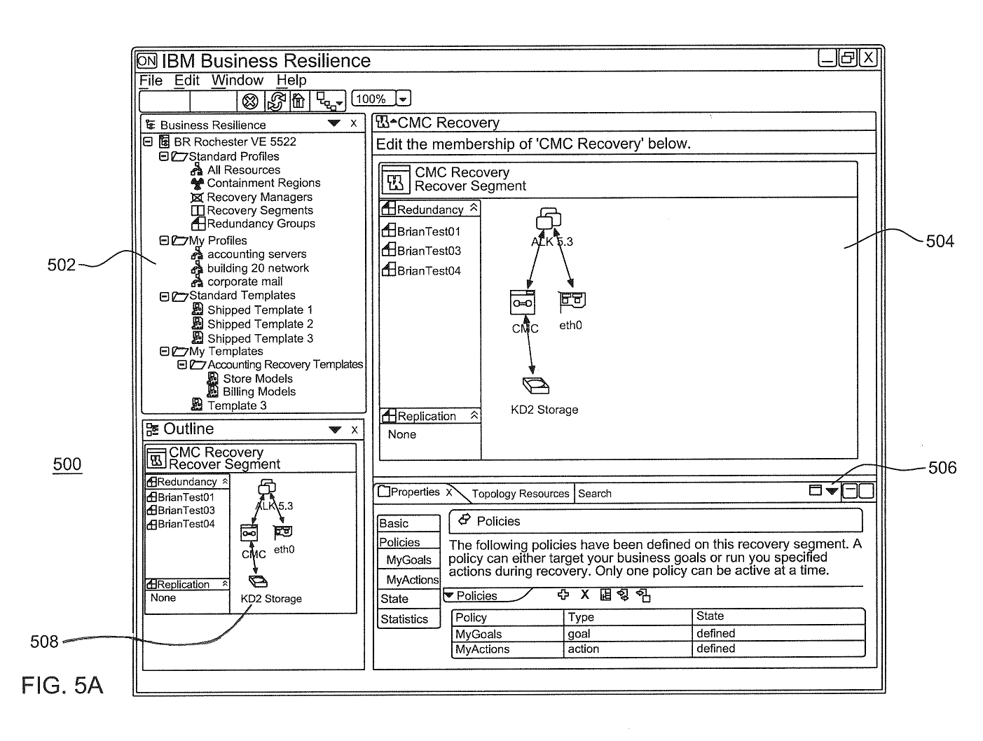

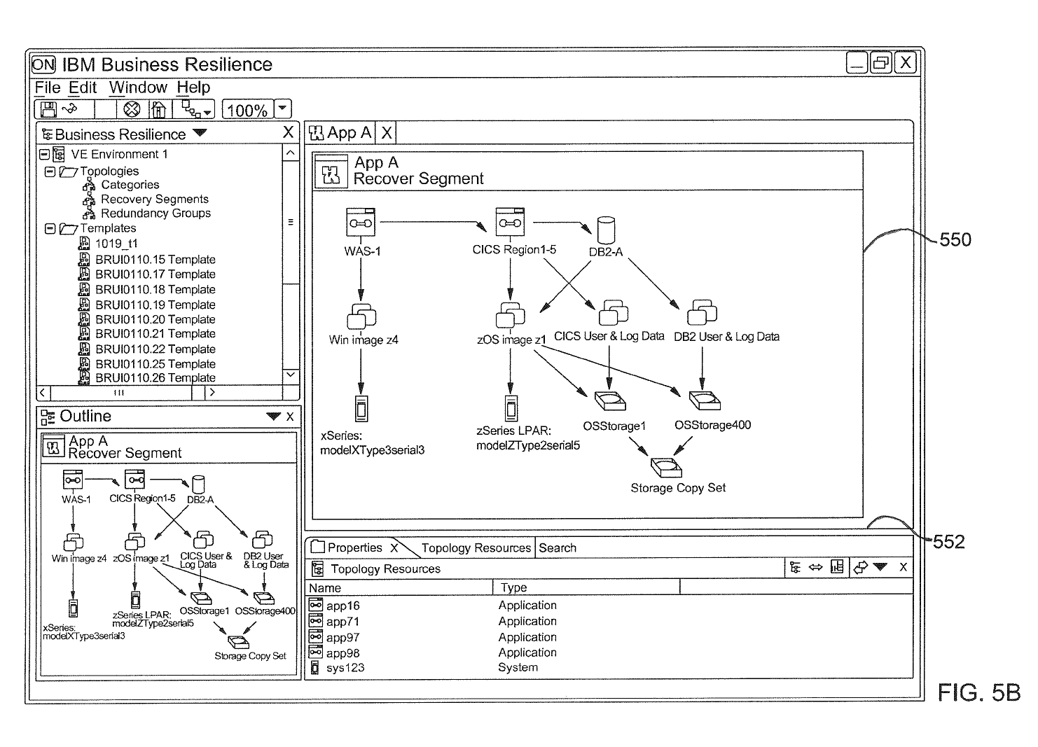

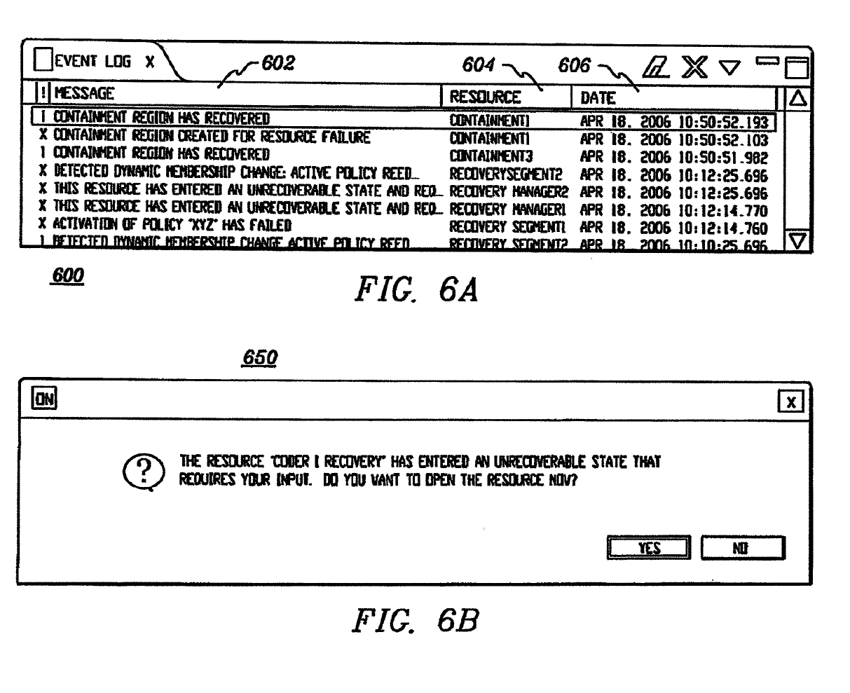

In addition to the Business Resilience Runtime Component of the BR system, the BR system includes the following components, previously mentioned above.
User Interface (UI) Component (404).
   The User interface component is, for instance, a graphical environment through which the customer's IT staff can make changes to the BR configuration. As examples: create and manage Recovery Segments; specify recovery goals; validate achievability of goals prior to failure time; view and alter BR generated workflows.
   The user interface (UI) is used as the primary interface for configuring BR. It targets roles normally associated with a Business Analyst, Solution Architect, System Architect, or Enterprise Architect, as examples.
   One purpose of the BR UI is to configure the BR resources. It allows the user to create BR artifacts that are used for a working BR runtime and also monitors the behaviors and notifications of these BR resources as they run. In addition, the BR UI allows interaction with resources in the environment through, for instance, relationships and their surfaced properties and operations. The user can add resources to BR to affect recovery and behaviors of the runtime environment.
   The BR UI also surfaces recommendations and best practices in the form of templates. These are reusable constructs that present a best practice to the user which can then be approved and realized by the user.
   Interaction with the BR UI is based on the typical editor save lifecycle used within, for instance, the developmental tool known as Eclipse (available and described at www.Eclipse.org). The user typically opens or edits an existing resource, makes modifications, and those modifications are not persisted back to the resource until the user saves the editor.
   Predefined window layouts in Eclipse are called perspectives. Eclipse views and editors are displayed in accordance with the perspective's layout, which can be customized by the user. The BR UI provides a layout as exemplified in the screen display depicted in FIG. 5A.
   Screen display 500 depicted in FIG. 5A displays one example of a Business Resilience Perspective. Starting in the upper left corner and rotating clockwise, the user interface includes, for instance:
      1. Business Resilience View 502
      This is where the user launches topologies and definition templates for viewing and editing.
      2. Topology/Definition Template Editor 504
      This is where the editors are launched from the Business Resilience View display. The user can have any number of editors open at one time.
      3. Properties View/Topology Resources View/Search View 506
      The property and topology resource views are driven off the active editor. They display information on the currently selected resource and allow the user to modify settings within the editor.
      4. Outline View 508
      This view provides a small thumbnail of the topology or template being displayed in the editor. The user can pan around the editor quickly by moving the thumbnail.
   The topology is reflected by a RS, as shown in the screen display of FIG. 5B. In FIG. 5B, a Recovery Segment 550 is depicted, along with a list of one or more topology resources 552 of the RS (not necessarily shown in the current view of the RS).
   In one example, the BR UI is created on the Eclipse Rich Client Platform (RCP), meaning it has complete control over the Eclipse environment, window layouts, and overall behavior. This allows BR to tailor the Eclipse platform and remove Eclipse artifacts not directly relevant to the BR UI application, allowing the user to remain focused, while improving usability.
   BR extends the basic user interface of Eclipse by creating software packages called “plugins’ that plug into the core Eclipse platform architecture to extend its capabilities. By implementing the UI as a set of standard Eclipse plug-ins, BR has the flexibility to plug into Eclipse, WebSphere Integration Developer, or Rational product installs, as examples. The UI includes two categories of plug-ins, those that are BR specific and those that are specific to processing resources in the IT environment. This separation allows the resource plug-ins to be potentially re-used by other products.
   By building upon Eclipse, BR has the option to leverage other tooling being developed for Eclipse. This is most apparent in its usage of BPEL workflow tooling, but the following packages and capabilities are also being leveraged, in one embodiment, as well:
      The Eclipse platform provides two graphical toolkit packages, GEF and Draw2D, which are used by BR, in one example, to render topology displays and handle the rather advanced topology layouts and animations. These packages are built into the base Eclipse platform and provide the foundation for much of the tooling and topology user interfaces provided by this design.
      The Eclipse platform allows building of advanced editors and forms, which are being leveraged for BR policy and template editing. Much of the common support needed for editors, from the common save lifecycle to undo and redo support, is provided by Eclipse.
      The Eclipse platform provides a sophisticated Welcome and Help system, which helps introduce and helps users to get started configuring their environment. Likewise, Eclipse provides a pluggable capability to create task instructions, which can be followed step-by-step by the user to accomplish common or difficult tasks.
BR Admin Mailbox (406) (FIG. 4).
   The BR Admin (or Administrative) Mailbox is a mechanism used by various flows of the BR runtime to get requests to an administrator to take some action. The Admin mailbox periodically retrieves information from a table, where BR keeps an up-to-date state.
   As an example, the Admin Mailbox defines a mechanism where BR can notify the user of important events needing user attention or at least user awareness. The notifications are stored in the BR database so they can be recorded while the UI is not running and then shown to the user during their next session.
   The notifications are presented to the user, in one example, in their own Eclipse view, which is sorted by date timestamp to bubble the most recent notifications to the top. An example of this view is shown in FIG. 6A. As shown, a view 600 is presented that includes messages 602 relating to resources 604. A date timestamp 606 is also included therewith.
   Double clicking a notification opens an editor on the corresponding resource within the BR UI, which surfaces the available properties and operations the user may need to handle the notification.
   The user is able to configure the UI to notify them whenever a notification exceeding a certain severity is encountered. The UI then alerts 650 the user of the notification and message when it comes in, as shown in FIG. 6B, in one example.
   When alerted, the user can choose to open the corresponding resource directly. If the user selects No, the user can revisit the message or resource by using the above notification log view.
BR Install Logic (408) (FIG. 4).
   The BR Install logic initializes the environment through accessing the set of preconfigured template information and vendor provided tables containing resource and relationship information, then applying any customizations initiated by the user.
Availability Configuration Templates (410):
   Recovery Segment Templates
      The BR System has a set of Recovery Segment templates which represent common patterns of resources and relationships. These are patterns matched with each individual customer environment to produce recommendations for RS definitions to the customer, and offer these visually for customization or acceptance.
   Redundancy Group Templates
      The BR System has a set of Redundancy Group templates which represent common patterns of forming groups of redundant resources. These are optionally selected and pattern matched with each individual customer environment to produce recommendations for RG definitions to a customer.
   BR Manager Deployment Templates
      The BR System has a set of BR Manager Deployment templates which represent recommended configurations for deploying the BR Manager, its related Recovery Segments, and the related BR management components. There are choices for distribution or consolidation of these components. Best practice information is combined with optimal availability and performance characteristics to recommend a configuration, which can then be subsequently accepted or altered by the customer.
   Pairing Templates
      The BR System has a set of Pairing Templates used to represent best practice information about which resources are related to each other.

The user interface, admin mailbox, install logic and/or template components can be part of the same computing unit executing BR Runtime or executed on one or more other distributed computing units.

To further understand the use of some of the above components and their interrelationships, the following example is offered. This example is only offered for clarification purposes and is not meant to be limiting in any way.

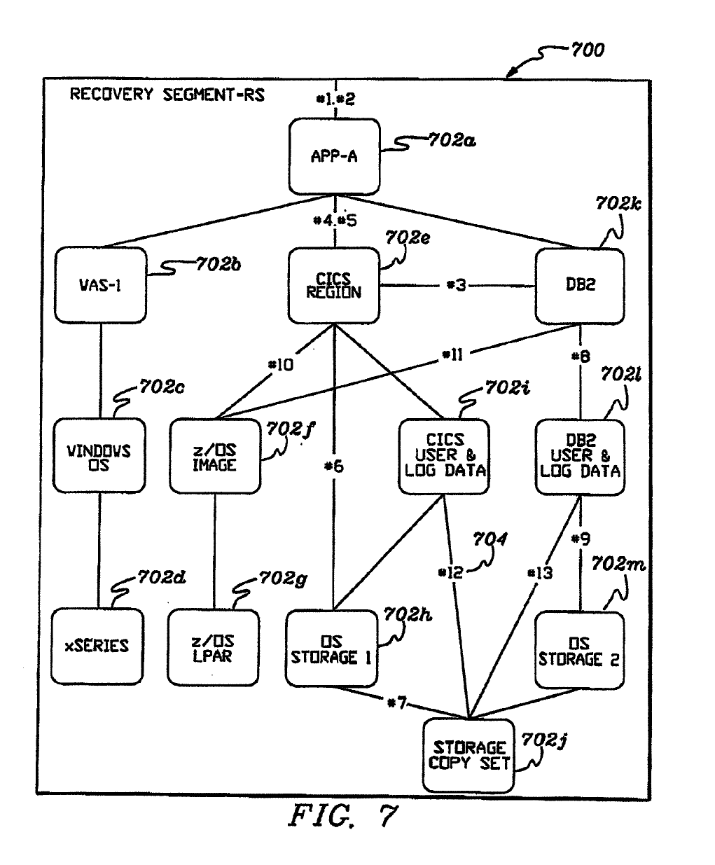

Referring to FIG. 7, a Recovery Segment RS 700 is depicted. It is assumed for this Recovery Segment that:
The Recovery Segment RS has been defined associated with an instantiated and deployed BR Manager for monitoring and management.
Relationships have been established between the Recovery Segment RS and the constituent resources 702a-702m.
A goal policy has been defined and validated for the Recovery Segment through interactions with the BR UI.
The following impact pairings have been assigned to the resources and relationships:

| Rule | Resource #1 | State | Resource #2 | State |
|---|---|---|---|---|
| 1 | App-A | Degraded | RS | Degraded |
| 2 | App-A | Unavailable | RS | Unavailable |
| 3 | DB2 | Degraded | CICS | Unavailable |
| 4 | CICS | Unavailable | App-A | Unavailable |
| 5 | CICS | Degraded | App-A | Degraded |
| 6 | OSStorage-1 | Unavailable | CICS | Degraded |
| 7 | OSStorage-1 | Unavailable | Storage Copy Set | Degraded |
| 8 | DB2 User & | Degraded | DB2 | Degraded |
| | Log Data | | | |
| 9 | OSStorage-2 | Unavailable | DB2 User & Log Data | Degraded |
| 10 | z/OS | Unavailable | CICS | Unavailable |
| 11 | z/OS | Unavailable | DB2 | Unavailable |
| 12 | Storage | Degraded | CICS User & | Degraded |
| | Copy Set | | Log Data | |
| 13 | Storage | Degraded | DB2 User & Log Data | Degraded |
| | Copy Set | | | |

The rules in the above table correspond to the numbers in the figure. For instance, #12 (704) corresponds to Rule 12 above.
Observation mode for the resources in the Recovery Segment has been initiated either by the customer or as a result of policy validation.
The environment has been prepared as a result of that goal policy via policy validation and the possible creation and execution of a preparatory workflow.
The goal policy has been activated for monitoring by BR.

As a result of these conditions leading up to runtime, the following subscriptions have already taken place:
The BRM has subscribed to runtime state change events for the RS.
RS has subscribed to state change events for the constituent resources.

These steps highlight one example of an error detection process:
The OSStorage-1 resource 702h fails (goes Unavailable).
RS gets notified of state change event.
1^{st} level state aggregation determines:
   Storage Copy Set→Degraded
   CICS User & Log Data→Degraded
   DB2 User & Log Data→Degraded
   DB2→Degraded
   CICS→Unavailable
   App-A→Unavailable
1^{st} level state aggregation determines:
   RS→Unavailable
BRM gets notified of RS state change. Creates the following Containment Region:

| Resource | Reason |
|---|---|
| OSStorage-1 | Unavailable |
| Storage Copy Set | Degraded |
| CICS User & Log Data | Degraded |
| DB2 User & Log Data | Degraded |
| DB2 | Degraded |
| App-A | Unavailable |
| CICS | Unavailable |
| RS | Unavailable |

Creates a recovery workflow based on the following resources:

| Resource | State |
|---|---|
| OSStorage-1 | Unavailable |
| Storage Copy Set | Degraded |
| CICS User & Log Data | Degraded |
| DB2 User & Log Data | Degraded |
| DB2 | Degraded |
| App-A | Unavailable |
| CICS | Unavailable |
| RS | Unavailable |

In addition to the above, BR includes a set of design points that help in the understanding of the system. These design points include, for instance:

### Goal Policy Support

BR is targeted towards goal based policies—the customer configures his target availability goal, and BR determines the preparatory actions and recovery actions to achieve that goal (e.g., automatically).

Availability management of the IT infrastructure through goal based policy is introduced by this design. The BR system includes the ability to author and associate goal based availability policy with the resource Recovery Segments described herein. In addition, support is provided to decompose the goal policy into configuration settings, preparatory actions and runtime procedures in order to execute against the deployed availability goal. In one implementation of the BR system, the Recovery Time Objective (RTO—time to recover post outage) is a supported goal policy. Additional goal policies of data currency (e.g., Recovery Point Objective) and downtime maximums, as well as others, can also be implemented with the BR system. Recovery Segments provide the context for association of goal based availability policies, and are the scope for goal policy expression supported in the BR design. The BR system manages the RTO through an understanding of historical information, metrics, recovery time formulas (if available), and actions that affect the recovery time for IT resources.

RTO goals are specified by the customer at a Recovery Segment level and apportioned to the various component resources grouped within the RS. In one example, RTO goals are expressed as units of time intervals, such as seconds, minutes, and hours. Each RS can have one RTO goal per Pattern System Environment associated with the RS. Based on the metrics available from the IT resources, and based on observed history and/or data from the customer, the RTO goal associated with the RS is evaluated for achievability, taking into account which resources are able to be recovered in parallel.

Based on the RTO for the RS, a set of preparatory actions expressed as a workflow is generated. This preparatory workflow configures the environment or makes alterations in the current configuration, to achieve the RTO goal or to attempt to achieve the goal.

In terms of optimizing RTO, there are tradeoffs associated with the choices that are possible for preparatory and recovery actions. Optimization of recovery choice is performed by BR, and may include interaction at various levels of sophistication with IT resources. In some cases, BR may set specific configuration parameters that are surfaced by the IT resource to align with the stated RTO. In other cases, BR may request that an IT resource itself alter its management functions to achieve some portion of the overall RS RTO. In either case, BR aligns availability management of the IT resources contained in the RS with the stated RTO.

### Metrics and Goal Association

In this design, as one example, there is an approach to collecting the required or desired metrics data, both observed and key varying factors, system profile information that is slow or non-moving, as well as potential formulas that reflect a specific resource's use of the key factors in assessing and performing recovery and preparatory actions, historical data and system information. The information and raw metrics that BR uses to perform analysis and RTO projections are expressed as part of the IT resources, as resource properties. BR specific interpretations and results of statistical analysis of key factors correlated to recovery time are kept as BR Specific Management data (BRMD).

### Relationships Used by BR, and BR Specific Resource Pairing Information

BR maintains specific information about the BR management of each resource pairing or relationship between resources. Information regarding the BR specific data for a resource pairing is kept by BR, including information such as ordering of operations across resources, impact assessment information, operation effect on availability state, constraint analysis of actions to be performed, effects of preparatory actions on resources, and requirements for resources to co-locate or anti-co-locate.

### Evaluation of Failure Scope

One feature of the BR function is the ability to identify the scope and impact of a failure. The BR design uses a Containment Region to identify the resources affected by an incident. The Containment Region is initially formed with a fairly tight restriction on the scope of impact, but is expanded on receiving errors related to the first incident. The impact and scope of the failure is evaluated by traversing the resource relationships, evaluating information on BR specific resource pairing information, and determining most current state of the resources impacted.

### Generation and Use of Workflow

Various types of preparatory and recovery processes are formulated and in some cases, optionally initiated. Workflows used by BR are dynamically generated based on, for instance, customer requirements for RTO goal, based on actual scope of failure, and based on any configuration settings customers have set for the BR system.

A workflow includes one or more operations to be performed, such as Start CICS, etc. Each operation takes time to execute and this amount of time is learned based on execution of the workflows, based on historical data in the observation log or from customer specification of execution time for operations. The workflows formalize, in a machine readable, machine editable form, the operations to be performed.

In one example, the processes are generated into Business Process Execution Language (BPEL) compliant workflows with activities that are operations on IT resources or specified manual, human activities. For example, BRM automatically generates the workflows in BPEL. This automatic generation includes invoking routines to insert activities to build the workflow, or forming the activities and building the XML (Extensible Mark-Up Language). Since these workflows are BPEL standard compliant, they can be integrated with other BPEL defined workflows which may incorporate manual activities performed by the operations staff. These BR related workflows are categorized as follows, in one example:
Preparatory—Steps taken during the policy prepare phase in support of a given goal, such as the setting of specific configuration values, or the propagation of availability related policy on finer grained resources in the Recovery Segment composition. BR generates preparatory workflows, for instance, dynamically. Examples of preparatory actions include setting up storage replication, and starting additional instances of middleware subsystems to support redundancy.
Recovery—Steps taken as a result of fault detection during runtime monitoring of the environment, such as, for example, restarting a failed operating system (OS). BR generates recovery workflows dynamically, in one example, based on the actual failure rather than a prespecified sequence.
Preventive—Steps taken to contain or fence an error condition and prevent the situation from escalating to a more substantial outage or impact; for example, the severing of a failed resource's relationship instances to other resources. Preventive workflows are also dynamically generated, in one example.
Return—Steps taken to restore the environment back to ‘normal operations’ post recovery, also represented as dynamically generated workflows, as one example.

### Capturing of Workflow Information

Since the set of BR actions described above modify existing IT environments, visibility to the actions that are taken by BR prior to the actual execution is provided. To gain trust in the decisions and recommendations produced by BR, the BR System can run in ‘advisory mode’. As part of advisory mode, the possible actions that would be taken are constructed into a workflow, similar to what would be done to actually execute the processes. The workflows are then made visible through standard workflow authoring tooling for customers to inspect or modify. Examples of BPEL tooling include:
Bolie, et al., BPEL Cookbook: Best Practices for SOA-based Integration and Composite Applications Development, ISBN 1904811337, 2006, PACKT Publishing, hereby incorporated herein by reference in its entirety;
Juric, et al., Business Process Execution Language for Web Services: BPEL and BPEL YWS, ISBN 1-904811-18-3, 2004, PACKT Publishing, hereby incorporated herein by reference in its entirety.
http://www-306.ibm.com/software/integration/wid/about/?S_CMP=rnav
http://www.eclipse.org/bpel/
http://www.parasoft.com/jsp/products/home.jsp;jessionid=aaa56iqFywA-HJ?product=BPEL&redname=googbpelm&referred=searchengine%2Fgoogle%Fbpel

### Tooling Lifestyle, Support of Managed Resources and Roles

BR tooling spans the availability management lifecycle from definition of business objectives, IT resource selection, availability policy authoring and deployment, development and deployment of runtime monitors, etc. In one example, support for the following is captured in the tooling environment for the BR system:
Visual presentation of the IT resources & their relationships, within both an operations and administration context.
Configuration and deployment of Recovery Segments and BRMs.
Authoring and deployment of a BR policy.
Modification of availability configuration or policy changes for BR.
BPEL tooling to support viewing of BR created, as well as customer authored, workflows.
BPEL tooling to support monitoring of workflow status, related to an operations console view of IT resource operational state.

### Policy Lifecycle

The policy lifecycle for BR goal policies, such as RTO goals, includes, for example:
Define—Policy is specified to a RS, but no action is taken by the BRM to support the policy (observation information may be obtained).
Validate—Policy is validated for syntax, capability, etc.; preparatory workflow created for viewing and validation by customer.
Prepare—Preparatory action workflows are optionally executed.
Activate—Policy is activated for runtime monitoring of the environment.
Modify—Policy is changed dynamically in runtime.

### Configurable State Aggregation

One of the points in determining operational state of a Recovery Segment is that this design allows for customers to configure a definition of specific ‘aggregated’ states, using properties of individual IT resources. A Recovery Segment is an availability management context, in one example, which may include a diverse set of IT resources.

The customer may provide the rules logic used within the Recovery Segment to consume the relevant IT resource properties and determine the overall state of the RS (available, degraded and unavailable, etc). The customer can develop and deploy these rules as part of the Recovery Segment availability policy. For example, if there is a database included in the Recovery Segment, along with the supporting operating system, storage, and network resources, a customer may configure one set of rules that requires that the database must have completed the recovery of in-flight work in order to consider the overall Recovery Segment available. As another example, customers may choose to configure a definition of availability based on transaction rate metrics for a database, so that if the rate falls below some value, the RS is considered unavailable or degraded, and evaluation of ‘failure’ impact will be triggered within the BR system. Using these configurations, customers can tailor both the definitions of availability, as well as the rapidity with which problems are detected, since any IT resource property can be used as input to the aggregation, not just the operational state of IT resources.

### Failure During Workflow Sequences of Preparatory, Recovery, Preventive

Failures occurring during sequences of operations executed within a BPEL compliant process workflow are intended to be handled through use of BPEL declared compensation actions, associated with the workflow activities that took a failure. The BR System creates associated “undo” workflows that are then submitted to compensate, and reset the environment to a stable state, based on where in the workflow the failure occurred.

### Customer Values

The following set of customer values, as examples, are derived from the BR system functions described above, listed here with supporting technologies from the BR system:
Align total IT runtime environment to business function availability objectives:
   RS definition from representation of IT Resources;
   Goal (RTO) and action policy specification, validation and activation; and
   Tooling by Eclipse, as an example, to integrate with IT process management.
Rapid, flexible, administrative level:
   Alteration of operation escalation rules;
   Customization of workflows for preparatory and recovery to customer goals;
   Customization of IT resource selection from RG based on quality of service (QoS);
   Alteration of definition of IT resource and business application state (available, degraded, or unavailable);
   Customization of aggregated state;
   Modification of topology for RS and RG definition;
   Selection of BR deployment configuration;
   Alteration of IT resource recovery metrics;
   Customization of generated Pattern System Environments; and
   Specification of statistical tolerances required for system environment formation or recovery metric usage.
Extensible framework for customer and vendor resources:
   IT resource definitions not specific to BR System; and
   Industry standard specification of workflows, using, for instance, BPEL standards.
Adaptive to configuration changes and optimization:
   IT resource lifecycle and relationships dynamically maintained;
   System event infrastructure utilized for linkage of IT resource and BR management;
   IT resource recovery metrics identified and collected;
   IT resource recovery metrics used in forming Pattern System Environments;
   Learned recovery process effectiveness applied to successive recovery events;
   System provided measurement of eventing infrastructure timing;
   Dynamic formation of time intervals for aggregation of related availability events to a root cause; and
   Distribution of achieved recovery time over constituent resources.
Incremental adoption and coexistence with other availability offerings:
   Potential conflict of multiple managers for a resource based on IT representation;
   Workflows for recovery and preparatory reflect operations with meta data linked to existing operations;
   Advisory mode execution for preparatory and recovery workflows; and
   Incremental inclusion of resources of multiple types.
Support for resource sharing:
   Overlapping and contained RS;
   Merger of CR across RS and escalation of failure scope; and
   Preparatory and recovery workflows built to stringency requirements over multiple RS.
Extensible formalization of best practices based on industry standards:
   Templates and patterns for RS and RG definition;
   Preparatory and recovery workflows (e.g., BPEL) for customization, adoption; and
   Industry standard workflow specifications enabling integration across customer and multiple vendors.
Integration of business resilience with normal runtime operations and IT process automation:
   Option to base on IT system wide, open industry standard representation of resources;
   BR infrastructure used for localized recovery within a system, cluster and across sites; and
   Utilization of common system infrastructure for events, resource discovery, workflow processing, visualization.

Management of the IT environment is adaptively performed, as described herein and in a U.S. patent application “Adaptive Business Resiliency Computer System for Information Technology Environments,” (POU920070364US1), Bobak et al., co-filed herewith, which is hereby incorporated herein by reference in its entirety.

Many different sequences of activities can be undertaken in creating a BR environment. The following represents one possible sequence; however, many other sequences are possible. This sequence is provided merely to facilitate an understanding of a BR system and one or more aspects of the present invention. This sequence is not meant to be limiting in any way. In the following description, reference is made to various U.S. patent applications, which are co-filed herewith.

On receiving the BR and related product offerings, an installation process is undertaken. Subsequent to installation of the products, a BR administrator may define the configuration for BR manager instances with the aid of BRM configuration templates.

Having defined the BRM configuration a next step could be to define Recovery Segments as described in “Recovery Segments for Computer Business Applications,” (POU920070108US1), Bobak et al., which is hereby incorporated herein by reference in its entirety.

Definition of a RS may use a representation of resources in a topology graph as described in “Use of Graphs in Managing Computing Environments,” (POU920070112US1), Bobak et al., which is hereby incorporated herein by reference in its entirety.

It is expected that customers will enable BR operation in “observation” mode for a period of time to gather information regarding key metrics and operation execution duration associated with resources in a RS.

At some point, sufficient observation data will have been gathered or a customer may have sufficient knowledge of the environment to be managed by BR. A series of activities may then be undertaken to prepare the RS for availability management by BR. As one example, the following steps may be performed iteratively.

A set of functionally equivalent resources may be defined as described in “Use of Redundancy Groups in Runtime Computer Management of Business Applications,” (POU920070113US1), Bobak et al., which is hereby incorporated herein by reference in its entirety.

Specification of the availability state for individual resources, redundancy groups and Recovery Segments may be performed as described in “Use of Multi-Level State Assessment in Computer Business Environments,” (POU920070114US1), Bobak et al., which is hereby incorporated herein by reference in its entirety.

Representations for the IT environment in which BR is to operate may be created from historical information captured during observation mode, as described in “Computer Pattern System Environment Supporting Business Resiliency,” (POU920070107US1), Bobak et al., which is hereby incorporated herein by reference in its entirety. These definitions provide the context for understanding how long it takes to perform operations which change the configuration—especially during recovery periods.

Information on relationships between resources may be specified based on recommended best practices—expressed in templates—or based on customer knowledge of their IT environment as described in “Conditional Computer Runtime Control of an Information Technology Environment Based on Pairing Constructs,” (POU920070110US1), Bobak et al., which is hereby incorporated herein by reference in its entirety. Pairing processing provides the mechanism for reflecting required or desired order of execution for operations, the impact of state change for one resource on another, the effect execution of an operation is expected to have on a resource state, desire to have one subsystem located on the same system as another and the effect an operation has on preparing the environment for availability management.

With preliminary definitions in place, a next activity of the BR administrator might be to define the goals for availability of the business application represented by a Recovery Segment as described in “Programmatic Validation in an Information Technology Environment,” (POU920070111US1), Bobak et al., which is hereby incorporated herein by reference in its entirety.

Managing the IT environment to meet availability goals includes having the BR system prioritize internal operations. The mechanism utilized to achieve the prioritization is described in “Serialization in Computer Management,” (POU920070105US1), Bobak et al., which is hereby incorporated herein by reference in its entirety.

Multiple operations are performed to prepare an IT environment to meet a business application's availability goal or to perform recovery when a failure occurs. The BR system creates workflows to achieve the required or desired ordering of operations, as described in “Dynamic Generation of Processes in Computing Environments,” (POU920070123US1), Bobak et al., which is hereby incorporated herein by reference in its entirety.

A next activity in achieving a BR environment might be execution of the ordered set of operations used to prepare the IT environment, as described in “Dynamic Selection of Actions in an Information Technology Environment,” (POU920070117US1), Bobak et al., which is hereby incorporated herein by reference in its entirety.

Management by BR to achieve availability goals may be initiated, which may initiate or continue monitoring of resources to detect changes in their operational state, as described in “Real-Time Information Technology Environments,” (POU920070120US1), Bobak et al., which is hereby incorporated herein by reference in its entirety. Monitoring of resources may have already been initiated as a result of “observation” mode processing.

Changes in resource or redundancy group state may result in impacting the availability of a business application represented by a Recovery Segment. Analysis of the environment following an error is performed. The analysis allows sufficient time for related errors to be reported, insures gathering of resource state completes in a timely manner and insures sufficient time is provided for building and executing the recovery operations—all within the recovery time goal, as described in “Management Based on Computer Dynamically Adjusted Discrete Phases of Event Correlation,” (POU920070119US1), Bobak et al., which is hereby incorporated herein by reference in its entirety.

A mechanism is provided for determining if events impacting the availability of the IT environment are related, and if so, aggregating the failures to optimally scope the outage, as described in “Management of Computer Events in a Computer Environment,” (POU920070118US1), Bobak et al., which is hereby incorporated herein by reference in its entirety.

Ideally, current resource state can be gathered after scoping of a failure. However, provisions are made to insure management to the availability goal is achievable in the presence of non-responsive components in the IT environment, as described herein, in accordance with one or more aspects of the present invention.

With the outage scoped and current resource state evaluated, the BR environment can formulate an optimized recovery set of operations to meet the availability goal, as described in “Defining a Computer Recovery Process that Matches the Scope of Outage,” (POU920070124US1), Bobak et al., which is hereby incorporated herein by reference in its entirety.

Formulation of a recovery plan is to uphold customer specification regarding the impact recovery operations can have between different business applications, as described in “Managing Execution Within a Computing Environment,” (POU920070115US1), Bobak et al., which is hereby incorporated herein by reference in its entirety.

Varying levels of recovery capability exist with resources used to support a business application. Some resources possess the ability to perform detailed recovery actions while others do not. For resources capable of performing recovery operations, the BR system provides for delegation of recovery if the resource is not shared by two or more business applications, as described in “Conditional Actions Based on Runtime Conditions of a Computer System Environment,” (POU920070116US1), Bobak et al., which is hereby incorporated herein by reference in its entirety.

Having evaluated the outage and formulated a set of recovery operations, the BR system resumes monitoring for subsequent changes to the IT environment.

In support of mainline BR system operation, there are a number of activities including, for instance:
Coordination for administrative task that employ multiple steps, as described in “Adaptive Computer Sequencing of Actions,” (POU920070106US1), Bobak et al., which is hereby incorporated herein by reference in its entirety.
Use of provided templates representing best practices in defining the BR system, as described in “Defining and Using Templates in Configuring Information Technology Environments,” (POU920070109US1), Bobak et al., which is hereby incorporated herein by reference in its entirety.
Use of provided templates in formulation of workflows, as described in “Using Templates in a Computing Environment,” (POU920070126US1), Bobak et al., which is hereby incorporated herein by reference in its entirety.
Making changes to the availability goals while supporting ongoing BR operation, as described in “Non-Disruptively Changing a Computing Environment,” (POU920070122US1), Bobak et al., which is hereby incorporated herein by reference in its entirety.
Making changes to the scope of a business application or Recovery Segment, as described in “Non-Disruptively Changing Scope of Computer Business Applications Based on Detected Changes in Topology,” (POU920070125US1), Bobak et al., which is hereby incorporated herein by reference in its entirety.
Detecting and recovery for the BR system is performed non-disruptively, as described in “Managing Processing of a Computing Environment During Failures of the Environment,” (POU920070365US1), Bobak et al., which is hereby incorporated herein in its entirety.

In order to build a BR environment that meets recovery time objectives, IT configurations within a customer's location are to be characterized and knowledge about the duration of execution for recovery time operations within those configurations is to be gained. IT configurations and the durations for operation execution vary by time, constituent resources, quantity and quality of application invocations, as examples. Customer environments vary widely in configuration of IT resources in support of business applications. Understanding the customer environment and the duration of operations within those environments aids in insuring a Recovery Time Objective is achievable and in building workflows to alter the customer configuration of IT resources in advance of a failure and/or when a failure occurs.

A characterization of IT configurations within a customer location is built by having knowledge of the key recovery time characteristics for individual resources (i.e., the resources that are part of the IT configuration being managed; also referred to as managed resources). Utilizing the representation for a resource, a set of key recovery time objective (RTO) metrics are specified by the resource owner. During ongoing operations, the BR manager gathers values for these key RTO metrics and gathers timings for the operations that are used to alter the configuration. It is expected that customers will run the BR function in “observation” mode prior to having provided a BR policy for availability management or other management. While executing in “observation” mode, the BR manager periodically gathers RTO metrics and operation execution durations from resource representations. The key RTO metrics properties, associated values and operation execution times are recorded in an Observation log for later analysis through tooling. Key RTO metrics and operation execution timings continue to be gathered during active BR policy management in order to maintain currency and iteratively refine data used to characterize customer IT configurations and operation timings within those configurations.

Examples of RTO properties and value range information by resource type are provided in the below table. It will be apparent to those skilled in the art that additional, less, and/or different resource types, properties and/or value ranges may be provided.

| Resource Type | Property | Value Range |
|---|---|---|
| Operating System | Identifier | Text |
| | State | Ok, stopping, planned stop, |
| | | stopped, starting, error, lost |
| | | monitoring capability, unknown |
| | Memory Size | Units in MB |
| | Number of systems in sysplex, if | integer |
| | applicable | |
| | Last IPL time of day | Units in time of day/clock |
| | Type of last IPL | Cold, warm, emergency |
| | Total Real Storage Available | Units in MB |
| | GRS Star Mode | Yes or No |
| | Complete IPL time to reach | Units of elapsed time |
| | ‘available’ | |
| | Total CPU using to reach | Units of elapsed time |
| | available during IPL | |
| | Total CPU delay to reach | Units of elapsed time |
| | available during IPL | |
| | Total Memory using to reach | Units in MB |
| | available during IPL | |
| | Total Memory delay to reach | Units of elapsed time |
| | available during IPL | |
| | Total i/o requests | Integer value, number of requests |
| | Total i/o using to reach available | Units of elapsed time |
| | during IPL | |
| | Total i/o delay to reach available | Units of elapsed time |
| | during IPL | |
| Computer System (LPAR, | Identifier | Text |
| Server, etc.) | | |
| | State | Ok, stopping, stopped, planned |
| | | down, starting, error, lost |
| | | monitoring capability, unknown |
| | Type of CPU - model, type, | Text value |
| | serial | |
| | Number of CPUs | integer |
| | Number of shared processors | integer |
| | Number of dedicated processors | integer |
| | Last Activate Time of Day | Units in time of day/clock |
| Network Components | | |
| Group of Network Connections | Identity | |
| | Operational State | Ok, Starting, Disconnected, |
| | | Stopping, Degraded, Unknown |
| | State of each associated Network | Text |
| | Application Connection | |
| | Performance Stats on loss and | Complex |
| | delays | |
| | Recovery Time for any | Units in elapsed time |
| | associated application network | |
| | connections | |
| | Number of active application | Integer |
| | network connections associated | |
| | at time of network problem | |
| | Stopped Time/duration for | Units in elapsed time |
| | group of connectoins | |
| | Maximum Network Recovery | Units in elapsed time |
| | Time for any application | |
| | connection in group | |
| | Maximum Number of active | Integer |
| | connections at time of network | |
| | problem encountered, for any | |
| | application connection in group | |
| | Maximum Number of | Integer |
| | connections processed at time of | |
| | network recovery, for the group | |
| | of connections | |
| | Maximum network connection | Units in elapsed time |
| | recovery time/duration for any | |
| | application connection in the | |
| | group | |
| | Maximum Number of | Integer |
| | connections dropped at time of | |
| | application network connection | |
| | recovery, for any application | |
| | connection in the group | |
| Network Application Connection | Identity | Text |
| | State | Ok, Stopping, Degraded, Error, |
| | | Unknown |
| | Configuration Settings | Complex |
| | Associated TCP/IP Parameter | Text |
| | Settings | |
| | Requirement Policies | QoS or BR policies |
| | Performance Statistics, rules, | Complex |
| | service class, number of active | |
| | Network OS services | |
| | State update Interval | Units of elapsed time |
| | Last restart time of day | Units in time of day/clock |
| | Last Restart Time/Duration | Units in elapsed time |
| | Network Recovery Time for app | Units in elapsed time |
| | connection | |
| | Number of active connections at | Integer |
| | time of network problem | |
| | encountered, on a per app | |
| | connection basis | |
| | Number of connections | Integer |
| | processed at time of network | |
| | recovery, for the app connection | |
| | application network connection | Units in elapsed time |
| | recovery time/duration | |
| | Number of connections at time of | Integer |
| | application network connection | |
| | problem encountered | |
| | Number of connections | Integer |
| | processed at time of application | |
| | network connection recovery | |
| | Number of connections dropped | Integer |
| | at time of application network | |
| | connection recovery | |
| Network Host Connection | Identity | Text |
| | State | Ok, Stopping, Degraded, Error, |
| | | Unknown |
| | Configuration Settings | Complex |
| | Associated TCP/IP Parameter | Text |
| | Settings | |
| | Requirement Policies | QoS or BR policies |
| | Performance Statistics, rules, | Complex |
| | service class, number of active | |
| | Network OS services | |
| | State update Interval | Units of elapsed time |
| | Last restart time of day | Units in time of day/clock |
| | Last Restart Time/Duration | Units in elapsed time |
| | Number of QoS Events, | Integer |
| | indicating potential degradation | |
| | Number of QoS Events handled, | Integer |
| | Last handled QoS Event | Text |
| Database Subsystem | Name, identifier | Text |
| | Operational State | Operational, Nonoperational, |
| | | starting, stopping, in recovery, |
| | | log suspended, backup initiated, |
| | | restore initiated, restore |
| | | complete, in checkpoint, |
| | | checkpoint completed, applying |
| | | log, backing out inflights, |
| | | resolving indoubts, planned |
| | | termination, lost monitoring |
| | | capability |
| | Time spent in log apply | Units of elapsed time |
| | Time spent during inflight | Units of elapsed time |
| | processing | |
| | Time spent during indoubt | Units of elapsed time |
| | processing | |
| | Total time to restart | Units of elapsed time |
| | Checkpoint frequency | Units of time |
| | Backout Duration | Number of records to read back |
| | | in log during restart processing |
| | CPU Used during Restart | Units of elapsed time |
| | CPU Delay during Restart | Units of elapsed time |
| | Memory Used during Restart | Units in MB |
| | Memory Delay during Restart | Units of elapsed time |
| | I/O Requests during restart | Integer value of number of |
| | | requests |
| | I/O using during restart | Units of elapsed time |
| | I/O Delay during restart | Units of elapsed time |
| Database Datasharing Group | Identifer | Text |
| | Operational State | Operational, nonoperational, |
| | | degraded (some subset of |
| | | members non operational), lost |
| | | monitoring capability |
| | Number of locks in Shared | Integer value |
| | Facility | |
| | Time spent in lock cleanup for | Elapsed time value |
| | last restart | |
| Database | Identifier | Text |
| Tablespace | Identifier | Text |
| Transaction Region | Identifier | Text |
| | Name | Text |
| | Associated job name | Text |
| | Maximum number of tasks/ | Integer value |
| | threads | |
| | Restart type for next restart | Warm, cold, emergency |
| | Forward log name | Text |
| | System log name | Text |
| | Operational State | Operational, nonoperational, in |
| | | recovery, starting, stop normal |
| | | first quiesce, stop normal second |
| | | quiesce, stop normal third |
| | | quiesce |
| | Time spent in log apply | Units of elapsed time |
| | Time during each recovery stage | Units of elapsed time |
| | Total time to restart | Units of elapsed time |
| | CPU Used during Restart | Units of elapsed time |
| | CPU Delay during Restart | Units of elapsed time |
| | Memory Used during Restart | Units in MB |
| | Memory Delay during Restart | Units of elapsed time |
| | I/O Requests during restart | Integer value of number of |
| | | requests |
| | I/O connect time during restart | Units of elapsed time |
| | I/O Delay during restart | Units of elapsed time |
| | System Logsize | Units in MB |
| | Forward Logsize | Units in MB |
| | Activity Keypoint frequency | Integer - number of writes before |
| | | activity checkpoint taken |
| | Average Transaction Rate for | Number of transactions per |
| | this region | second, on average |
| Transaction Group | Group name | Text |
| Transaction Region File | Filename | Text |
| | Region Name | Text |
| | Dataset Name | Text |
| | Operational State | Operational/enabled, |
| | | nonoperational/disabled |
| | Open status | Open, closed, closing |
| Transaction | Identifier | Text |
| | Operational State | Running, failed, shunted, retry in |
| | | progress |
| | Region Name (s) that can run this | Text |
| | transaction | |
| | Program Name | Text |
| Logical Replication Group of | Identity | Text |
| related datasets | | |
| | State | |
| | Required currency characteristics | Complex |
| | for datasets | |
| | Required consistency | Complex |
| | characteristics for datasets | |
| Replication Group | Identity | |
| | State | |
| Replication Session | Identity | |
| | State | Established, in progress |
| | | replication, replication successful |
| | | complete |
| | Type of Session | Flash copy, metro mirror, etc. |
| | Duration of last replication | Units in elapsed time |
| | Time of Day for last replication | Units in time of day/clock |
| | Amount of data replicated at last | Units in MB |
| | replication | |
| Roleset | Identity | Text |
| | State | |
| CopySet | Identity | Text |
| | State | |
| Dataset | Identity | Text |
| | State | Open, Closed |
| Storage Group | Identity | Text |
| | State | |
| Storage Volume | Identity | Text |
| | State | Online, offline, boxed, unknown |
| Logical Storage Subsystem | Identity | Text |
| | State | |
| Storage Subsystem | Identity | Text |
| | State | |
| | Subsystem I/O Velocity - ratio of | |
| | time channels are being used | |
| Replication Link (Logical) | Identity | Text |
| between Logical Subsystems | | |
| | State | Operational, nonoperational, |
| | | degraded redundancy |
| | Number of configured pipes | Integer |
| | Number of operational pipes | Integer |

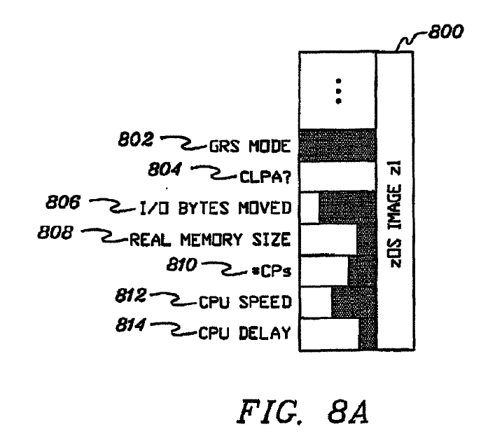

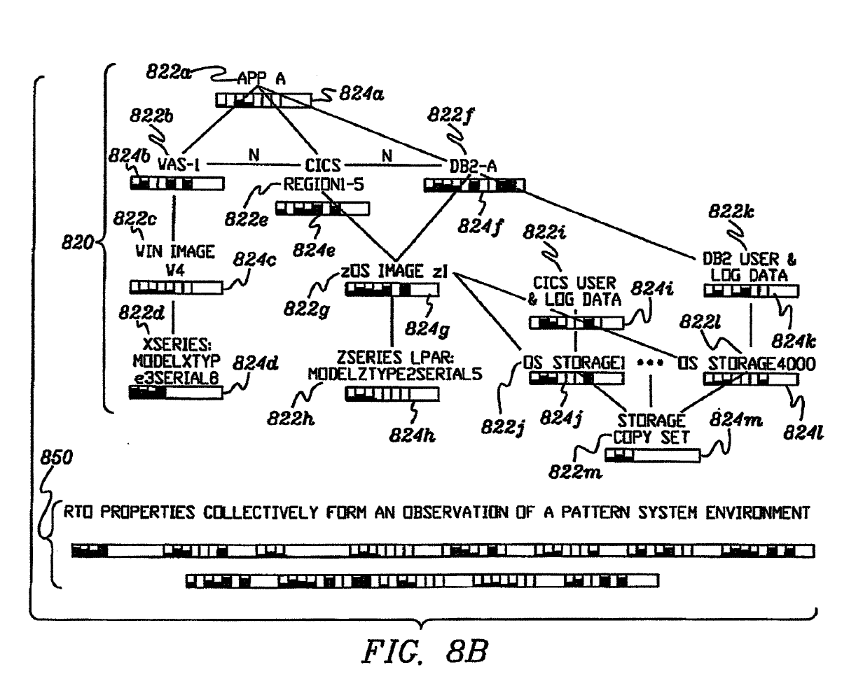

A specific example of key RTO properties for a z/OS® image is depicted in FIG. 8A. As shown, for a z/OS® image 800, the following properties are identified: GRS mode 802, CLPA? (i.e., Was the link pack area page space initialized?) 804, I/O bytes moved 806, real memory size 808, # CPs 810, CPU speed 812, and CPU delay 814, as examples.

The z/OS® image has a set of RTO metrics associated therewith, as described above. Other resources may also have its own set of metrics. An example of this is depicted in FIG. 8B, in which a Recovery Segment 820 is shown that includes a plurality of resources 822a-m, each having its own set of metrics 824a-m, as indicated by the shading.

Further, in one example, the RTO properties from each of the resources that are part of the Recovery Segment for App A have been gathered by BR and formed into an “observation” for recording to the Observation log, as depicted at 850.

Resources have varying degrees of functionality to support RTO goal policy. Such capacity is evaluated by BR, and expressed in resource property RTOGoalCapability in the BRMD entry for the resource. Two options for BR to receive information operation execution timings are: use of historical data or use of explicitly customer configured data. If BR relies on historical data to make recovery time projections, then before a statistically meaningful set of data is collected, this resource is not capable of supporting goal policy. A mix of resources can appear in a given RS—some have a set of observations that allow classification of the operation execution times, and others are explicitly configured by the customer.

Calculation of projected recovery time can be accomplished in two ways, depending on customer choice: use of historical observations or use of customers input timings. The following is an example of values for the RTOGoalCapability metadata that is found in the BRMD entry for the resource that indicates this choice:

| | |
|---|---|
| UseHistoricalObservations | The resource has a collection of statistically |
| | meaningful observations of recovery time, |
| | where definition of ‘statistically valid’ is |
| | provided on a resource basis, as default |
| | by BR, but tailorable by customers |
| UseCustomerInputTimings | The customer can explicitly set the operation |
| | timings for a resource |

If the customer is in observation mode, then historical information is captured, regardless of whether the customer has indicated use of explicitly input timings or use of historical information.

The administrator can alter, on a resource basis, which set of timings BR is to use. The default is to use historical observations. In particular, a change source of resource timing logic is provided that alters the source that BR uses to retrieve resource timings. The two options for retrieving timings are from observed histories or explicitly from admin defined times for operation execution. The default uses information from the observed histories, gathered from periodic polls. If the customer defines times explicitly, the customer can direct BR to use those times for a given resource. If activated, observation mode continues and captures information, as well as running averages, and standard deviations. The impact to this logic is to alter the source of information for policy validation and formulation of recovery plan.

With respect to the historical observations, there may be a statistically meaningful set of observations to verify. The sample size should be large enough so that a time range for each operation execution can be calculated, with a sufficient confidence interval. The acceptable number of observations to qualify as statistically meaningful, and the desired confidence interval are customer configurable using BR UI, but provided as defaults in the BRMD entry for the resource. The default confidence interval is 95%, in one example.

There are metrics from a resource that are employed by BR to enable and perform goal management. These include, for instance:

| Metric | Qualification |
|---|---|
| Last observed recovery/restart time | In milliseconds; |
| | or alternately specifying units to use in calculations |
| The key factors and associated | Captured at last observed recovery time, and capturable |
| values of the resource that affect | at a point in time by BR |
| recovery time | |
| The key factors and associated | Captured at last observed recovery time, and capturable |
| values of the resource that affect | at a point in time by BR |
| other dependent resources’ recovery | |
| times | |
| Observed time interval from ‘start’ | If there are various points in the resource recovery |
| state to each ‘non-blocking’ state | lifecycle at which it becomes non-blocking to other |
| | resources which depend upon it, then: |
| | Observed time interval from ‘start’ state to each |
| | ‘non-blocking’ state |
| Resource Consumption Information | If the resource can provide information about its |
| | consumption, or the consumption of dependent |
| | resources, on an interval basis, then BR will use this |
| | information in forming PSEs and classifying timings. |
| | One example of this is: cpu, i/o, memory usage |
| | information that is available from zOS WLM for an |
| | aggregation of processes/address spaces over a given |
| | interval. |

There is also a set of information about the resource that is employed—this information is provided as defaults in the BRMD entry for the resource, but provided to the BR team in the form of best practices information/defaults by the domain owners:
The operational state of the resource at which the observed recovery time interval started.
The operational state of the resource at which the observed recovery time interval ended.
The operational states of the resource at which point it can unblock dependent resources (example: operational states at which a DB2 could unblock new work from CICS, at which it could allow processing of logs for transactions ongoing at time of failure . . . ).
Values of statistical thresholds to indicate sufficient observations for goal managing the resource (number of observations, max standard deviations, confidence level).

In addition to the resources defined herein as part of the IT configuration that is managed, there are other resources, referred to herein as assessed resources. Assessed resources are present primarily to provide observation data for PSE formation, and to understand impact(s) on managed resources. They do not have a decomposed RTO associated with them nor are they acted on for availability by BR. Assessed resources have the following characteristics, as examples:
Are present to collect observation data for PSE formation.
Are present to understand impacts on managed resources.
No decomposed RTO is associated with an assessed resource.
They are resources on which resources managed by BR depend upon, but are not directly acted on for availability by BR.
They are resources removed (or not explicitly added) from the actively monitored set of resources by the BR admin during RS definition.
They are resources that BR does not try to recover and BR thus will not invoke any preparatory or recovery operations on them.

Similarly, there are likely scenarios where a resource exists in a customer environment that already has an alternative availability management solution, and does not require BR for its availability. However, since other resources that are managed by BR may be dependent on them, they are observed and assessed in order to collect observation data and understand their impacts on managed resources. Additionally, there may be resources that do not have alternative management solutions, but the customer simply does not want them managed by BR, but other managed resources are dependent upon them. They too are classified as assessed resources.

These assessed resources share many of the same characteristics of managed resources, such as, for example:
They have an entry in the BRMD, depending on their use, and the BRMD entry has an indication of assessed vs. managed.
The RS subscribes to state change notifications for assessed resources (and possibly other notifiable properties).
Relationships between observed and managed resources are possible (and likely).
BR monitors for lifecycle events on assessed resources in the same manner as for managed resources.
Assessed resources can be added and/or removed from Recovery Segments.
They can be used to contribute to the aggregated state of an RS.

Finally, there are a few restrictions that BR imposes upon assessed resources, in this embodiment:
Again, BR does not invoke any workflow operations on assessed resources.
A resource that is shared between two Recovery Segments is not categorized as an assessed resource in one RS and a managed resource in the other. It is one or the other in the RS's, but not both.

To facilitate the building of the customer's IT configuration, observations regarding the customer's environment are gathered and stored in an observation log. In particular, the observation log is used to store observations gathered during runtime in customer environments, where each observation is a collection of various data points. They are created for each of the Recovery Segments that are in “observation” mode. These observations are used for numerous runtime and administrative purposes in the BR environment. As examples the observations are used:
To perform statistical analysis from the BR UI to form characterizations of customers' normal execution environments, represented in BR as Pattern System Environments (PSE).
To classify operations on resources into these PSEs for purposes of determining operation execution duration.
Help determine approximate path length of operations that are pushed down from BR to the resources, and possibly to the underlying instrumentation of each resource.
Help determine approximate path length of activities executed within BPEL workflows.
Finally, the data collected via the observation is also used to update the metadata associated with the resource (i.e., in the BRMD table) where appropriate.

BR gathers observations during runtime when “observation mode” is enabled at the Recovery Segment level. There are two means for enabling observation mode, as examples:
1. The BR UI allows the administrator to enable observation mode at a Recovery Segment, which will change its “ObservationMode” resource property to “True”, and to set the polling interval (default=15 minutes). The Recovery Segment is defined in order to allow observation mode, but a policy does not have to be defined or activated for it.
2. Once a policy is defined though and subsequently activated, observation mode is set for the Recovery Segment (due to the data being used in managing and monitoring the customer's environment). Thus, it is set automatically at policy activation, if not already set explicitly by the administrator (see 1 above) using the default polling interval (15 minutes).

The administrator may also disable observation mode for a Recovery Segment, which stops it from polling for data and creating subsequent observation records for insertion in the log. However, the accumulated observation log is not deleted. In one example, an RS remains in observation mode throughout its lifecycle. The UI displays the implications of disabling observation mode.

In BR, the observations that are collected by BR during runtime can be grouped into two categories, as examples:
1. Periodic poll.
2. Workflow (includes workflow begin/end, and workflow activity begin/end).

A periodic poll observation is a point-in-time snapshot of the constituent resources in a Recovery Segment. Observation data points are collected for those resources in the Recovery Segment(s) which have associated BR management data for any of the following reasons, as examples:
1. Resource has RTO properties.
2. Resource has operations.
3. Resource participates in the aggregated state for the Recovery Segment, in which it is contained.
4. Resource participates in any of the six types of pairing rules.

The full value of these observations is derived for an RS when they include data that has been gathered for its constituent resources, plus the resources that those are dependent upon. In one embodiment, the administrator is not forced to include all dependent resources when defining a Recovery Segment, and even if that were the case, there is nothing that prevents them from deleting various dependent resources. When defining a Recovery Segment, the BR UI provides an option that allows the customer to display the dependency graph for those resources already in the Recovery Segment. This displays the topology from the seed node(s) in the Recovery Segment down to and including the dependent leaf nodes. The purpose of this capability is to give the customer the opportunity to display the dependent nodes and recommend that they be included in the Recovery Segment.

Preparatory and recovery workflows are built by the BR manager to achieve the customer requested RTO policy based on resource operations timings. During active policy monitoring by the BR manager, measurements of achieved time for operations are recorded in observations to the log and used to maintain the running statistical data on operation execution times. Observations written to the log may vary in the contained resource RTO metrics and operation execution timings.

Observations are also collected from any of the BPEL workflows created by BR in the customer's environment. There is a standard template that each BR BPEL workflow uses. As part of that template, observation data is captured at the start of, during, and at the completion of each workflow. Specifically, in one example, one observation is created at the end of the workflow with data accumulated from completion of each activity. This information is used to gather timings for workflow execution for use in creating subsequent workflows at time of failure.

In accordance with an aspect of the present invention, management of an IT environment, such as an IT environment that supports Business Resiliency, is facilitated by the controlled gathering of information used to manage the environment.

Today, Business Resilience technologies typically rely solely on the reliability of incoming event processing, and do very little (if any) collection of state during normal operations for querying or ascertaining the state of resources. In addition, if such queries are performed, there are no components to allow for the collection of this information in a manner that minimizes overhead and ensures ability to meet required goals, such as a Recovery Time Objective. The drawbacks include potentially stale (and inaccurate) information to be used in making recovery decisions; queries that are initiated that cause delay beyond what the recovery time tolerance will allow for a business application; and failure to initiate assessment of state during normal operations to determine an expected level of performance for resources during various times of the day.

A technique of distributing queries asynchronously is provided herein, in which the underlying services being invoked support synchronous behavior (i.e., once a query or request is submitted, the process does nothing until a response is returned). (In this embodiment, the services do not support asynchronous behavior (i.e., after submission of a query, the process continues performing other actions and does not wait for a response in order to proceed). However, in another embodiment, both synchronous and asynchronous behaviors are supported.) The queries are distributed via a distributor. The queries support a tolerance for wait time which is dependent on the context of the invocation, and the distributor further parallelizes the queries across the set of input resources. Both the technique used to invoke the distributor, along with the processing within the distributor, are covered by this process. Various characteristics associated with this process include, for instance, a parallelized asynchronous distributor; wait tolerance in context of invocation; minimization of performance impact; adjustment of microintervals; handling of a responses missing timeout window; response handling; and local optimizations, each of which is described below.

### 1. Parallelized Asynchronous Distributor

In one embodiment, the Asynchronous Distributor of this process parallelizes queries to underlying services that are synchronous in nature. The problem with a large set of synchronous services that need to be invoked is the performance impact of waiting for each successive response, when processing potentially multiple thousands of requests. The wait time for responses could exceed what can be tolerated by many applications, including applications that manage the infrastructure, such as for business resiliency. The asynchronous distributor described herein accepts a batch of requests from any client invocation, and in this case, the business resiliency management components, and parallelizes each request of the batch to run on a separate thread. The request to the service itself is synchronous, as that is what the service supports. However, across the batch of requests, the threads parallelize the queries. In a complex environment, the expectation is to have multiple asynchronous distributors, placed in a locally optimized way. The services that each distributor has local optimization capability for are kept by the invoker, so queries can be directed to the appropriate asynchronous distributor.

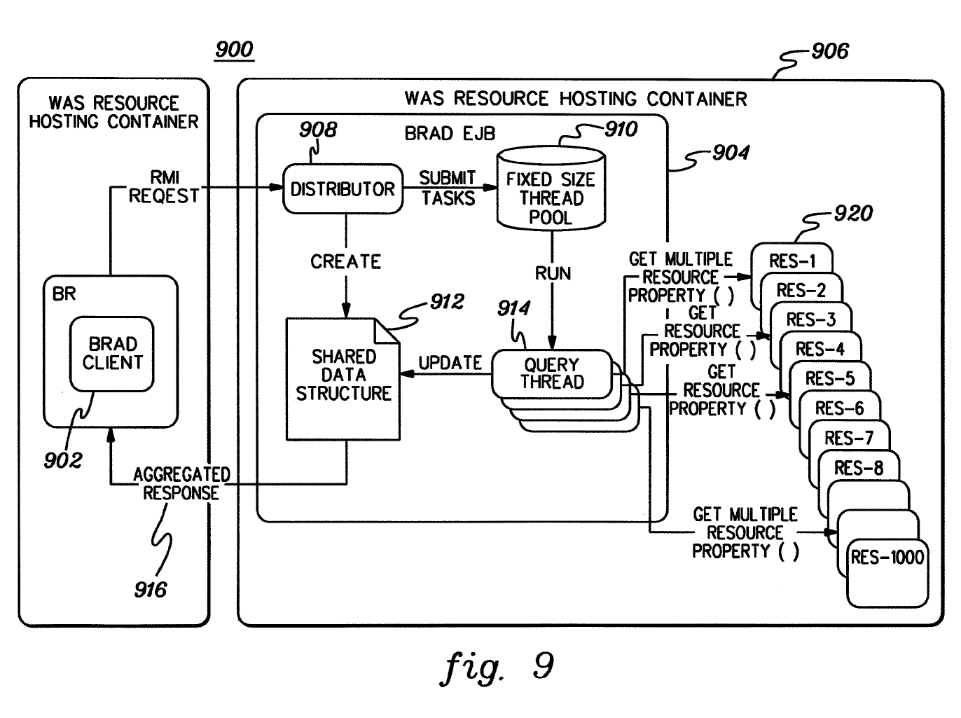

One example of a high level view of an asynchronous distributor 900 is depicted in FIG. 9. In one implementation, web services and Enterprise Java Beans are utilized for implementation of the BR Asynchronous Distributor (BRAD). As an example, the hosting environment may be the WebSphere Application Server (WAS) offered by International Business Machines Corporation.

BR has a design point for scale that is targeted to the large, complex environment. During recovery processing, BR expects that potentially a large set of resources are impacted. In large z/OS® Sysplex environments, it is not unusual to expect anywhere from 500,000 to 1,000,000 resources distributed across 25 WebSphere containers (assuming each WAS container supports 25,000 instances). In cases where a large number of these resources are to be queried within a short period of time, it is impractical to try to accomplish this in a synchronous manner. In fact, synchronous query during a recovery process that is time sensitive will be an issue even for just a single query.

Further details relating to BRAD and FIG. 9 are described further below.

### 2. Wait Tolerance In Context of Invocation

One of the areas of difficulty in synchronous behavior of the underlying services is the expected or allowed time for wait. By definition, synchronous services return when they have completed, either successfully or unsuccessfully. They are not constrained by a time period, but instead, are considered as time independent. When there are critical time dependent invocations of large sets of these services, the wait time cannot be predicted or guaranteed to complete within a given window. The asynchronous distributor described herein accepts from its caller a time sensitive context that allows each thread mentioned in item (1) to be allocated a timeout. In this manner, the caller's tolerance for wait time is applied to the query. The distributor explicitly sets a timer around the query invocation and if the timer expires prior to query completion for that individual query, the response is returned as null. The timeout is on an individual basis, so if the batch contains 100 requests, and 97 complete in the allocated time, and 3 of them do not complete, the other 97 still contain response information. The timeout is not fixed by the distributor, but can vary by the invoker on each call to the distributor.

Using this technique, the underlying synchronous services operate within a time sensitive bound, and processing of the client using the distributor (in this case, business resiliency) can explicitly have control over whether ‘sufficient’ data has been received for the allowed time, or whether additional queries have to be initiated to the same or alternate interfaces to determine the information. Business resilience uses this distributor in multiple contexts, both for collecting observations during normal operations, as well as during recovery time error assessment processing.

### 3. Minimization of Performance Impact

One of the goals of the asynchronous distributor is the minimization of performance impact to the invoker and to the overall system during the query processing. In some cases, the invoker requires responses as soon as available, but large spikes in performance can be caused by submitting a significant number of parallel queries in a small interval of time. As a result, the invoker methodology used by business resilience varies depending on the context of the invocation.

Normal observation invocation:
Periodic poll observations are used to collect various data points for each of the resources in the Recovery Segments that are being monitored or observed in runtime. These observations are not as time sensitive as the queries following a failure, but nevertheless, they are used for numerous and important runtime and administrative purposes, and they are to be collected in a manner that is non-disruptive, unobtrusive, and imparts little or no degradation to the runtime environment.
When the distributors are used for getting observations of resources during normal operations, the goal is to spread the queries out over the entire interval that is available for the observation so that the performance impact can be flattened as much as possible. In this case, the invoker calculates a set of batches, based on the interval allowed for the entire observation, and on the number of queries to be initiated in total during the observation.
The batches are then submitted, in a phased manner to the various asynchronous distributors in the system, keeping the impact of an observation to a minimum, but at the same time collecting the observation responses within the interval allowed.
The technique used by the business resilience client in this case is to send batched requests across the set of asynchronous distributors that are responsible for the services to be queried, and calculate an appropriate wait time between the batched requests so that the overall observation across all services to be queried consumes the entire interval. In that manner, the performance impact of an observation is kept to the minimum possible.

Error assessment invocation:
BR has detected a failure in the customer environment and has to create a recovery process in order to handle the failure according to the RTO goal policy associated with the impacted Recovery Segment(s). When this happens BR is to determine the current operational state of the impacted resources to correctly formulate that recovery process. It cannot rely on the state that was last processed by the underlying eventing infrastructure, since an unbounded delay on the message delivery might result in unpredictable or undesirable results.
When the distributors are used for acquiring most current state during a failure situation, the tolerance for wait time is very limited, and driven in the case of business resiliency, directly by the, for instance, Recovery Time Objective (RTO) of the Recovery Segment being assessed. For example, if the RTO is 10 seconds, the allowed wait for each synchronous query to complete is calculated based on the window intervals that are used to determine root cause. For example, specifically the calculation for the wait time is: (Time interval to accumulate related errors)—(Time interval to delay initiation of resource state query). These intervals can be calculated in a number of different ways. One example of calculating time intervals for related errors is described in “Management of Computer Events in a Computer Environment,” Bobak et al. (IBM Docket No. POU920070118US1), which is hereby incorporated herein by reference in its entirey.

### 4. Adjustment of Microintervals

In cases where business resilience uses the distributors for normal observations, there is an explicit wait between batches to ensure the spread of requests over the complete interval. However, in some cases, processing for the complete set of requests may not complete in time, and in some cases, processing for the complete set of requests may complete in less time than the complete interval. The business resilience component that invokes the distributors for normal observations measures the time to invoke the complete set of distributor requests and adjusts the wait interval between batches (the microinterval), along with the time that each query is allocated to complete accordingly based on responses. In this manner, the batching of queries and the thread timeout used by the distributors are dynamically adjusted continuously to optimize for minimum performance overhead to the system.

### 5. Handling of Responses Missing Timeout Window

In some cases, processing the complete set of requests to the distributors may not complete in the allocated time. The business resilience component invoking the distributor tracks the missed responses and calculates a running average of request to response percentage. Notification is then sent to the administrator so that intervals can be adjusted if necessary, or problems with repeatedly slow responding resources can be investigated.

### 6. Response Handling

The requests to the distributors are, for instance, asynchronous, and each distributor sends responses back to the invoker for each batch that is to be processed. The responses back to the invoker from the distributors are parallelized, and may occur out of order since the invocation is asynchronous. Tokens are used as part of the request and response to correlate the response back and ensure that any time sensitive query responses are associated with the correct observation or discarded, if more recent information has been received on a more current error assessment. For performance reasons related to locking of database records, the business resilience components centralize update of runtime management information by the invoker, after the asynchronous distributors have all responded, for a given query or state assessment.

### 7. Local Optimizations

The design for asynchronous collection of information works optimally when the asynchronous distributors themselves can be placed in a manner that is optimized with the services that they will be asked to invoke. Although that is not a strict requirement of the design, it is a further optimization that is incorporated by the business resilience design. Lists of which services are hosted by a given application server, on a given OS, can be programmatically collected and maintained, and the invocation logic apportions requests to the asynchronous distributors based on those services that are most local to each distributor. The services that are part of a batch request that comes to a distributor from a business resilience invocation for normal observation or state assessment is based on programmatic inspection of the list that identifies services and where the services are hosted. The distributors are deployed into the same environment for the services to which they will initiate query requests. In this way, network communication costs and full marshalling/demarshalling costs between the distributor and each of the parallelized queries can be avoided. Because of the nature of the services being invoked in the case of business resilience, the service request will not fail if the distributor that invokes the service is not local, but rather executes in a non-optimized manner. As a result, the business resilience design places the distributors in an optimized manner in the environment so that invoked services are localized as much as possible.

### BRAD Implementation

The BRAD EJB may be implemented as an EJB 3.0 stateless session bean so that multiple BRAD clients can simultaneously access it and invoke methods on it. The Java beans that comprise the EJB itself execute within an EJB container, such as the IBM® WebSphere Application Server (WAS). The BRAD clients may optionally reside and execute within an EJB container, but are not specifically required to do so. The EJB is to have both a local and a remote interface so that the clients can invoke operations on it either remotely if they are in the different EJB containers (or on different servers) or locally if they are in the same EJB container (or on the same physical server).

The BRAD EJB is deployed and resides within each of the WAS containers in the BR environment that hosts resources. This allows BR to take advantage of the local optimization available within the same container when invoking operations on resources. In one implementation, the BRAD is written in Java, which allows Java-to-Java communications via Remote Method Invocation (RMI). The parameters passed on the requests/responses are internal to the BRAD mechanism, and are therefore, optimized, for example, by eliminating the need to marshal, unmarshal, and parse XML files.

Logically, there are three components to the BRAD, as depicted in FIG. 9:

1. BRAD Client 902
The BRAD client functionally resides as part of the BR environment (RS and BRM) and funnels the requests to the appropriate BRADs in the BR environment. This so-called funneling is not arbitrary in this embodiment. BR utilizes WebSphere local optimization and strives to only do local Web Services calls as part of the BRAD functionality. As mentioned above, a BRAD EJB 904 is deployed in each of the WAS containers 906 in the BR environment, and in order to ensure local Web Services calls, BR maintains the deployment information for each of the resources it is managing. Thus, the BRAD client utilizes this deployment information to direct the requests to the proper BRADs based on the resources that are to be queried.
Requests to the BRAD EJB by the BRAD client are made asynchronously, in one example. The client requests the list of resources to query, the request type so that the BRAD EJB knows exactly what it is being asked to do, a token to identify the client so the response can be returned, and a maximum time that the client can afford to wait for a response, as examples.

2. Distributor 908
The Distributor is the function of the BRAD EJB that fields the requests from the clients, fulfill the requests, aggregates the responses from the various resources that are being queried, and provides the aggregated response to the client. The distributor fulfills the request by creating a number of asynchronous tasks, or threads in Java, so that each thread can synchronously query a resource. Creating a large number of threads would normally be fairly expensive but Java provides a thread pool implementation for cases where a large number of short-lived threads are to be created, which is the case for BR. Also, threads created from the same process share the same data, which is leveraged by BR, as well.
Initially, the distributor creates a new thread pool 910. For a periodic poll observation, the thread pool is created with a fixed number of threads (i.e., newFixedThreadPool). A fixed number is used for the simple reason that it is not the intent of the BRAD to create so many threads in a simultaneous manner as to degrade the performance of the runtime environment; the intention is to stagger the threads as much as possible. Thus, a thread pool with a fixed number of threads ensures that if too many tasks are submitted simultaneously, the thread pool automatically queues them until threads become available. However, during a recovery scenario, BR cannot afford a lot of time for the response. Thus, the thread pool created in this case is a cached thread pool (i.e., newCachedThreadPool), which means that each task executes immediately using idle threads if available, or new threads as necessary are created. In this scenario, BR is more concerned with getting a response as quickly as possible. Also, in this scenario, the resource queries are only for the operational state of the resource.
Secondly, the distributor creates a data structure 912 to be shared by all the threads, and then simply submits the tasks to the thread pool. Each task essentially involves a query to a resource based on the list provided by the client. As each query thread 914 completes, it updates its section of the shared data structure, accepts a new task if any have been queued up in the thread pool, or goes idle if there are no outstanding tasks.
If all the submitted tasks complete within the allotted time specified by the client, the distributor invokes a graceful shutdown of the thread pool (via, for instance, the ThreadPoolExecutor.shutdown( ) method), which closes the pool to new tasks and all threads in the pool die. The distributor builds an aggregated response 916 from the allocated data structure shared by all the threads and asynchronously passes it back to the BRAD client.
In some cases though, not all the query threads return within the necessary time allowed by the caller, or may fail for sundry reasons. When this occurs, the distributor performs an immediate shutdown of the thread pool (by, for instance, invoking the ThreadPoolExecturor.shutdownNow( ) method), which cancels the unstarted tasks, and interrupts the running threads. Then, it creates the aggregated response and passes it back to the BRAD client. The client is responsible for properly handling the resultant gaps in the response for the queries that did not execute. In most cases, the client simply uses previously-cached values for the missing data.

3. Query Thread 914
Each Query thread queries the resource 920 that is submitted to it on the task from the distributor. The operation that is invoked by the query thread is governed by the request type from BR and the metadata associated with the resource type. In one implementation, it invokes a web service call to query the resource, but since it is running in the same container as the resource, that invocation is optimized by WebSphere. In other cases, it may be possible that a direct RMI call to the resource is possible and allowed. Other mechanisms for requesting state and property/value data from a resource may be supported including, for instance, direct invocation of documented interfaces to a resource, use of CIM (Common Information Model) and interfaces, and requests made to agents of a resource which maintain management information for the resource. All means of retrieving data regarding a resource are supportable from the BRAD mechanism. Once the query thread receives the response from the resource, it updates the response in its portion of the shared data structure created by the distributor, and either accepts a new task if any have been queued up in the thread pool, or goes idle if there are no outstanding tasks.

The list of resource representations running in each WAS container are maintained at the Recovery Segment level in a RS.BRAD_List. That list is initialized when the Recovery Segment is defined and associated with a particular BRM via the BR UI. This list only pertains to the resources in the Recovery Segment though, not all the resources in the environment. For every constituent resource in the Recovery Segment there is a corresponding entry in the list that indicates the WAS server and hosting container, which may be derived from a JMX interface (described, e.g., in Java™ and JMX: Building Manageable Systems, Heather Kreger, Ward Harold, Leigh Williamson, Addison-Wesley Professional, Jan. 9, 2003 (ISBN-10: 0672324083; ISBN-13: 978-0672324086); and Java Management Extensions, J. Seven Perry, O'Reilly Media, Inc., 1st edition, Jun. 15, 2002 (ISBN-10: 0596002459; ISBN-13: 978-0596002459), each of which is hereby incorporated herein in its entirety) to each of the WAS containers hosting resource representations. It is also the responsibility of the Recovery Segment to keep the RS.BRAD_List current in case a resource is moved, or one is encountered in the RS but does not contain a corresponding WAS hosting entry in the list. If a new resource is encountered in the RS that is hosted in a container without a deployed BRAD EJB in it, a notification is sent to the administrator's mailbox indicating that one is to be deployed.

As previously mentioned, each distributor EJB uses a fixed-set thread pool for requests. The exact number of threads used is governed by the number of resources that have to be queried and the amount of time the requester allows for it to complete its allotted work. During recovery time, the list of resources is provided from the BRM for Containment Region(s) and the tolerance for delay is calculated based upon the timing framework and will likely be very short, which forces a larger sized pool of threads. During observation mode, the Recovery Segment provides a list of resources to the distributors and evenly staggers the number of calls to each distributor based upon the number of resources in the RS.BRAD_List, and the amount of time per periodic interval (which will likely be considerably longer since the default is 15 minutes). Additionally, a pacing technique in the BRAD client logic continuously adjusts the response tolerance and number of resources to batch per request based upon the elapsed time of previous requests. The number of resources batched per request starts with a default of 20, but adjusts slightly higher or lower as necessary or desired with each periodic interval. If the RS eventually determines that sufficient data is not being collected per observation to be useful, a notification is sent to the administrator's mailbox indicating that the polling interval may be too small and should be increased.

### BRAD Classes

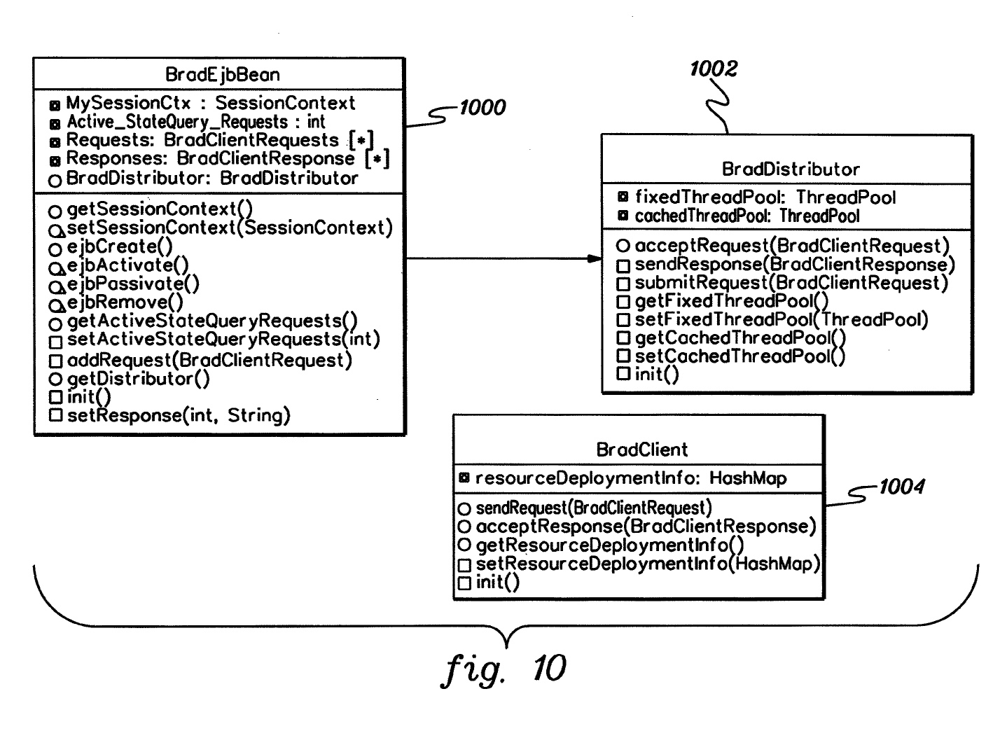

With reference to FIG. 10, one example of the major classes used to implement BRAD is described.

A BradEjbBean class 1000 implements the JAVA SessionBean interface class. It may be implemented as a singleton class to ensure there is only a single instance for each resource hosting container. Since it implements the SessionBean interface class, in one example, it implements the following operations and attributes, which are specific to session beans, not to BR.
Attribute: mySessionCtx is an instance of SessionContext.
Operation: setSessionContext( ).
Operation: getSessionContext( ).
Operation: ejbCreate( ).
Operation: ejbRemove( ).
Operation: ejbActivate( ).
Operation: ebjPassivate( ).

The following operations and attributes are specific to the BR implementation (also shown in the figure):
Attribute: Active_StateQuery_Requests is used to maintain a count of the state query requests outstanding to various threads querying the resources. It is used to ensure that resource state queries have a higher priority than BRAD periodic poll observation type requests.
Attribute: BradDistributor is used to field requests from the BRAD clients and to send corresponding responses to these same clients. It is described in more detail below.
Attribute: Requests is an array of the BradClientRequests from the BRAD clients via the BradDistributor class.
Attribute: Responses is an array of BradClientResponses to be sent to the BRAD clients via the BradDistributor class. Each BradClientResponse is a hashmap with an entry for each resource in the corresponding request.
Operation: getActiveStateQueryRequests( ) is a public getter method to read the Active_StateQuery_Requests attribute.
Operation: setActiveStateQueryRequests( ) is a private setter method to set the Active_StateQuery_Requests attribute.
Operation: init( ) is used to initialize the BradEjb during instantiation.
Operation: addRequest( ) is used to add a new BradClientRequest from a BRAD client (via the BradDistributor) to the requests array.
Operation: getDistributor( ) is used by clients to get access to the BradDistributor singleton instance.
Operation: setResponse( ) is used by the BradDistributor to set the response from a resource for a specific request and resource.

A BradDistributor class 1002 encapsulates the functions used to communicate with the BRAD clients and the resources that are to be queried. Except for accepting requests from BRAD clients, the method invocations on the distributor are driven by the BradEjb class. Thus, all the knowledge entailed with which resources to query when can be encapsulated in the BradEjb, and the distributor only handles the various communications with the clients and the resources. In one example, it is implemented as a singleton class so that there is only a single instance for each BRAD EJB, and should be instantiated during the init( ) method of the BradEjb class. One example of the BradDistributor operations and attributes is described below:
Attribute: fixedThreadPool to be used for periodic poll type requests.
Attribute: cachedThreadPool to be used for resource state query type requests.
Operation: init( ) is used to initialize the threadpools during instantiation.
Operation: acceptRequest( ) is public so that it can be invoked via the BRAD clients to initiate a request to the BRAD. The BradClientRequest includes an array of resources to query, the request type, the BRAD client token, and the maximum wait time. This is the only public method for the distributor; all the others are invoked by the BradEjb, in this implementation.
Operation: sendResponse( ) is invoked via the BradEjb class when it determines that a response is to be sent to a specific client.
Operation: submitRequest( ) is invoked via the BradEjb class when it determines that a request operation is to be submitted to the various resources.
Operation: getFixedThreadPool( ).
Operation: setFixedThreadPool( ) is private and is used during the init( ) method, as one example.
Operation: getCachedThreadPool( ).
Operation: setCachedhreadPool( ) is private and should be used during the init( ) method, in one example.

A BradClient class 1004 is used to communicate to the BRAD EJB, and can utilize either the remote or local homes of the EJB. One embodiment of the BradClient operations and attributes is described below:
Attribute: resourceDeploymentInfo is a hashmap used to store the information for the resources in the BR environment.
Operation: sendRequest( ) is used to asynchronously initiate a request to the BRAD, passing a BradClientRequest parameter.
Operation: acceptResponse( ) method is invoked by the BRAD EJB when it has a response for a previous request.
Operation: getResourceDeploymentInfo( ).
Operation: setResourceDeploymentInfo( ) is private and is used during the init( ) method, in one example.
Operation: init( ) is used to initialize the client during instantiation.

### BRAD Interactions With RS

During runtime periodic poll, observations are gathered from the environment by each Recovery Segment that is in observation mode. The data that is to be collected for a periodic poll are, for instance:
1. State.
2. State query execution time.
3. RTO metrics.
4. Properties that participate in any pairing rules for the resource.
5. Operation execution time.
6. Local time where the resource is being hosted.
7. Local time where the instrumentation is being hosted.
8. Round trip delay times between the RS and the BRAD EJB, between the BRAD EJB and the resource, and between the resource and it's instrumentation.

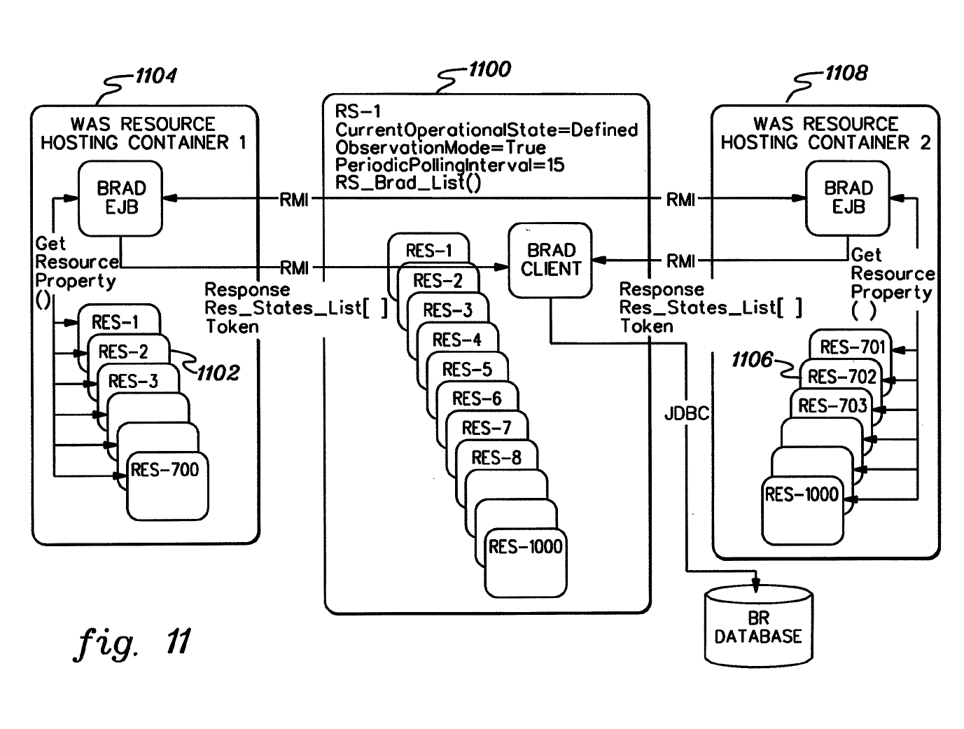

The data is used to populate the observation record and to maintain cached values in RS and BRMD for usage during recovery failures. The Recovery Segment interactions with the BR Asynchronous Distributor in the environment are described in more detail in the example below.
As previously mentioned, each Recovery Segment maintains a number of resource properties that are used to govern the rate and pace of observation requests sent to the various BR distributors. For example:
   1. The PeriodPollingInterval determines how often observations are collected. It is set by the administrator when the RS is placed into observation mode. The default is 15 minutes, in one example.
   2. BRAD_List determines where the resources in the Recovery Segment are hosted.
In the example shown in FIG. 11, the periodic polling interval and the number of resources per request use the default values, and the BRAD_List has been previously populated such that of the 1000 resources in this Recovery Segment (Ref. #1100), 700 resources (Ref. #1102) are hosted in WAS Hosting Container 1 (Ref. #1104) and the remaining 300 resources (Ref. #1106) are hosted in WAS Hosting Container 2 (Ref. #1108).
The BRAD client uses the properties above to calculate that a total of 50 requests (i.e., 1000/20) to the distributors are required within each polling interval of 15 minutes. Likewise, the Recovery Segment calculates that each of those requests is to be fulfilled within 18 seconds (i.e., 15*60/50) in order for all of them to be processed within each 15 minute polling interval.
The client basically starts iterating through the BRAD_List sending a list of resources asynchronously to one of the distributors, waits 18 seconds, and sends another request to another distributor, until all requests have been sent to all the BRAD EJBs. Again, in one example, RMI is used to communicate from EJB to EJB and as part of each request message is the type of request (i.e., Periodic Poll) so that the BRAD knows how to react, and an observation token for aggregating the responses from the resources into a single response.
Each BRAD EJB is then responsible for instantiating the thread pool with a fixed number of threads, which is based on the number of resources in the list to query, and the amount of time allotted for the request, and submitting the full set of tasks to the thread pool. Each query thread that gets dispatched synchronously invokes the necessary operation(s) on the resource provided in the task to collect the pertinent observation data points. The operations to invoke or the properties to be queried are maintained in the metadata associated with the resource type in the BRMD, and passed along as part of the request from the BRAD client. Each resource query is typically performed in a separate thread. In one implementation, the query for state is invoked with the single GetResourceProperty operation, since the timings for that state execution are required during recovery time and are separately maintained in the observation log. However, in another implementation, the GetMultipleResourceProperty operation may be used, if multiple properties are to be gathered from the same resource.
The aggregated responses from the BRAD EJB are returned to the caller (i.e., BRAD Client) and inserted directly into the observation log that is part of the BR database. Additionally, the cache that is maintained at the Recovery Segment is also updated. If all the resources have not responded in a timely fashion, their slots in the observation are empty, but will likely get populated on the next cycle, since the Recovery Segment continuously adjusts the response tolerance based upon the elapsed time of previous requests, and the order of the resources provided in the requests to the distributors. So, for example, a resource provided in the first request in a polling interval might be in the second request in the next polling interval. It's not catastrophic to miss an observation now and then for a few resources, but the administrator is alerted if too little data is being collected to be useful.
At the next observation interval, the entire process continues again, but takes into account the elapsed time from the previous requests to the distributors to try to ensure enough time is allotted for each subsequent request. Again, the order of the resources in the request may be altered.
Finally, if the BRAD client encounters a resource that is not in the BRAD_List for its Recovery Segment, it finds the appropriate WAS container where it is hosted (based on the EPR), inserts it into the list, and updates the BRMD table. If it cannot be determined, a notification is sent to the admin mailbox.

### BRAD Interaction With BRM

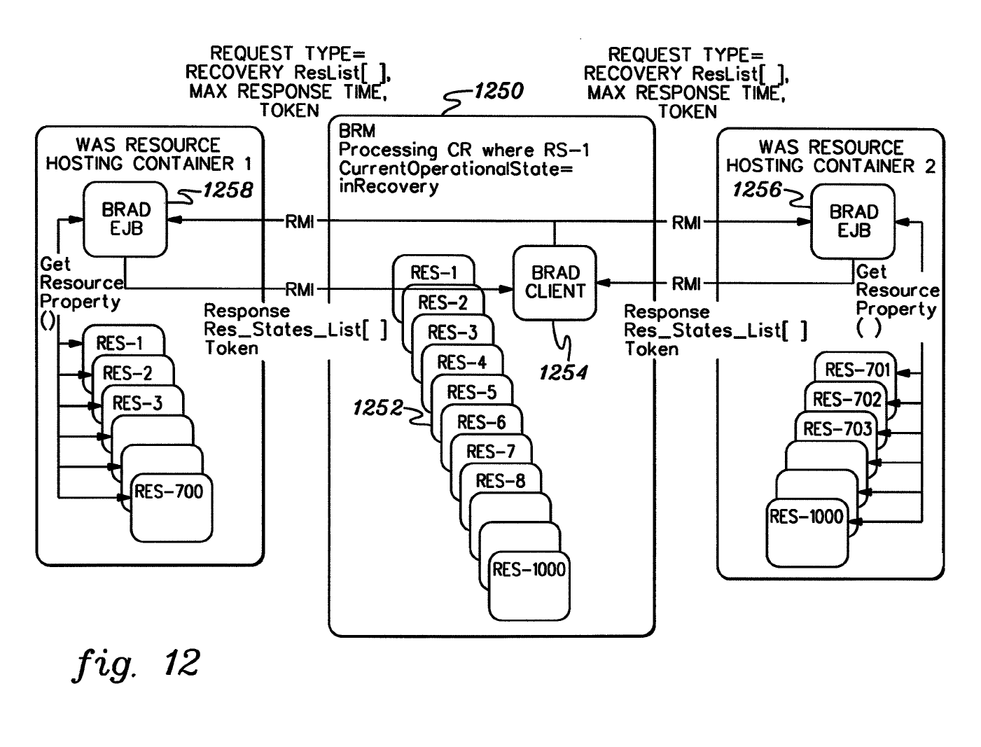

The interaction pattern for the BR Manager with the distributors is a bit different than that of the Recovery Segment. The BR Manager interacts with the BRAD distributors during a time of failure when expediency is very important.
In the example shown in FIG. 12, a BR Manager 1250 has a Containment Region with a large list of impacted resources 1252, and it is able to obtain the hosting environment, which in one implementation, may be a WAS environment, of each of them from the Recovery Segments involved in the failure.
A BRAD client component 1254 of the BR Manager sends a single request to each of the two BRADs 1256, 1258 hosting resources in its Containment Region, along with a request type and a token to correlate the responses upon return, and the maximum time allowed for that request. The request type indicates that it is not a Periodic Poll observation (i.e., State Query), so that the BRAD distributor can act accordingly when creating the thread pool.
A BRAD EJB is designed to handle simultaneous requests from multiple BR Managers and in a recovery scenario it is very likely that it is in the process of servicing one or more periodic poll observation requests at the time that it receives this State Query request. Since recovery flows are categorized with a higher priority than observation flows, the first thing the distributor portion on the BRAD EJB does is perform an immediate shutdown of all the thread pools created on behalf of periodic poll requests (by, for instance, invoking the ThreadPoolExecturor. shutdownNow( ) method on the pool). This cancels the unstarted tasks, and interrupts the running threads for those periodic poll requests. Likewise, any periodic poll requests that are received while processing the failure type request is immediately rejected. The intent is to devote as many resources as possible to fulfilling the state query request.
Each BRAD EJB is then responsible for instantiating a thread pool, and since it is not a periodic poll request, the thread pool is instantiated as a cached thread pool, rather than with a fixed number of threads. Each query thread that gets dispatched synchronously invokes the operation/property to retrieve only the operational state of the resource, in this example, since it is to generate the recovery process.
The BRAD distributor returns the aggregate response message asynchronously back to the BRAD client, passing a list of states for the resources. For those queries that did not finish in a timely manner, or not at all, the BRM can alternatively choose to use a cached state value or even choose to query those resources directly.

### BRAD Interaction With WLM

In one implementation, another BRAD interaction is with the z/OS® Workload Manager (WLM) offered by International Business Machines Corporation. An interface to WLM is provided through the z/OS® OperatingSystem resource representation. WLM provides various RTO and performance metrics for CPU, memory, and I/O consumption and delays for a given set of address spaces. In general, BR interfaces to WLM in the following manner:
At the time that observation mode is enabled for a Recovery Segment, BR determines if there are any z/OS® OperatingSystem resources contained within that Recovery Segment.
If so, BR additionally determines the subsystem resources in the Recovery Segment that are dependent upon that z/OS® operating system. BR queries those subsystem resources to retrieve their process IDs.
During a periodic poll observation, the BRAD client logic passes those process IDs over the BRAD interface to the z/OS® OperatingSystem resource requesting that WLM start sampling for those process IDs (e.g, startApplicationRecoveryMonitor (ProcessIDs)). Returned from that request is a Token that is used on a subsequent request to retrieve the collected data. That token is returned by the BRAD in the aggregated response to the BRAD client.

On the next observation for that z/OS® OperatingSystem resource, that Token is passed back to WLM (via, for instance, the stopApplicationRecoveryMonitor(Token) operation). That accomplishes two things: first, it stops the sampling for those subsystems; and second, it retrieves the RTO and performance metrics gathered by WLM for those address spaces during the periodic poll interval.
Finally, the BRAD EJB (via one of its threads) starts WLM sampling again for the same set of subsystems, and passes the Token along with the WLM data back to the Recovery Segment.

The BRAD client logic at the Recovery Segment parses the data based on the mapping information provided by the z/OS® OperatingSystem resource, and updates the corresponding entries in the observation record (for those corresponding subsystem resources) prior to the insertion of the record into the observation log. That data is also saved in the BRMD entry for the Recovery Segment.

### Periodic Poll Process

A periodic poll observation is a point-in-time snapshot of the constituent resources in a Recovery Segment. Observation data points are collected, in one embodiment, for those resources in the Recovery Segment(s) which have associated BR management data for any of the following reasons:
1. Resource has RTO properties;
2. Resource has operations;
3. Resource participates in the aggregated state for the Recovery Segment it is contained in;
4. Resource participates in any of the pairing rules.

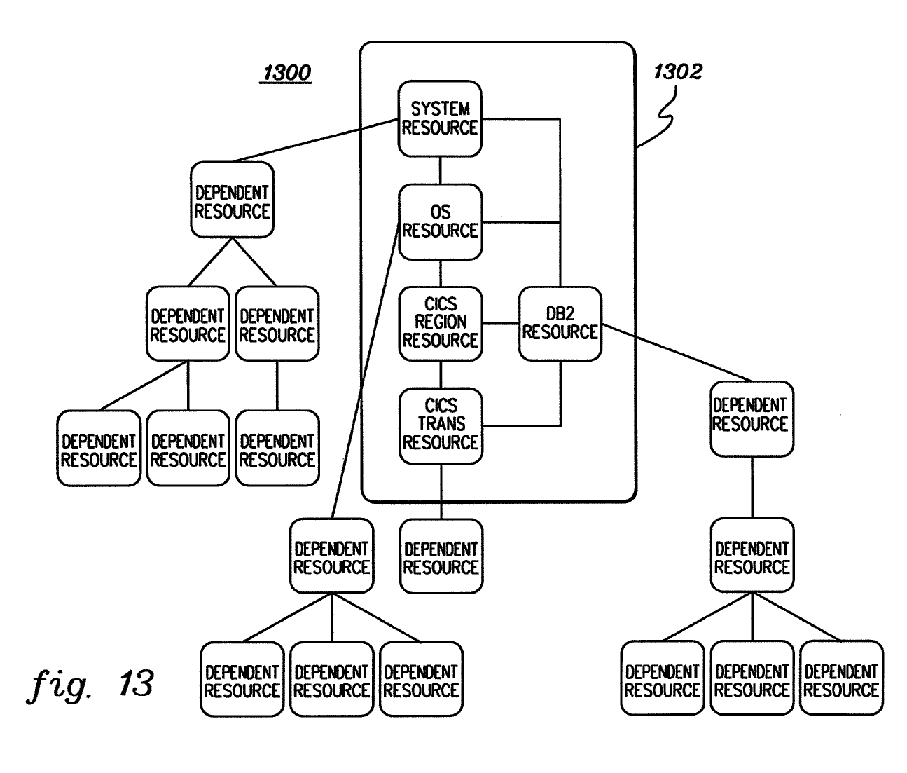

The full value of these observations is derived for a RS when they contain data that has been gathered for its constituent resources, plus the resources that those are dependent upon. Currently, the administrator is not forced to include all dependent resources when defining a Recovery Segment, and even if that were the case, there is nothing that prevents them from deleting various dependent resources. Currently, BR employs a number of best-practices techniques to assist the customer in configuring BR for runtime monitoring and management. A similar technique is implemented in the BR UI to assist the customer for observation mode. Customers are able to define Recovery Segments through the usage of definition templates (which IBM® recommends as a best-practice), or alternatively they may configure Recovery Segments manually. In either case, when defining a Recovery Segment, the BR UI provides an option that allows the customer to display the dependency graph for those resources already in the Recovery Segment. This displays the topology from the seed node(s) in the Recovery Segment down to and including all the dependent leaf nodes. The purpose of this capability is to give the customer the opportunity to display the dependent nodes and recommend that they be included in the Recovery Segment. As an example, a dependency graph 1300 for a Recovery Segment 1302 might look like the graph depicted in FIG. 13.

If the customer selects to accept the recommended proposal, the RS is then expanded to include all the resources, not just the small set originally selected, as shown. Obviously, if the customer chooses not to invoke the UI option (i.e., “Display Dependency Graph”), or chooses not to accept the recommended proposal, the RS is not expanded. However, the administrator is alerted of the subsequent implications of not doing so, and advised against it.

In one example, there may be a set of resources within a Recovery Segment for which the customer added specifically for the purposes of monitoring and management by BR (via a goal policy), and another distinct set that the customer does not desire BR to manage, but still is to be “observed” by BR in order to collect the necessary or desired information to properly manage the managed set of resources for availability. As a result, a new class of resource has been defined to describe these observed resources termed, assessed resources.

While in observation mode, the Recovery Segment is responsible for periodically polling the relevant BR Asynchronous Distributors (BRADs) in the environment for the resources in the Recovery Segment. The RS provides the list of resources for each BRAD to query and an observation token so that the multiple observation records can be correlated together from the BR UI. Each BRAD then invokes the necessary operations on the resources in the list provided by the Recovery Segment, aggregates the responses into a single observation record, and returns it to the Recovery Segment for insertion into the observation log and for updating the metadata associated with the resources via the BRMD tables.

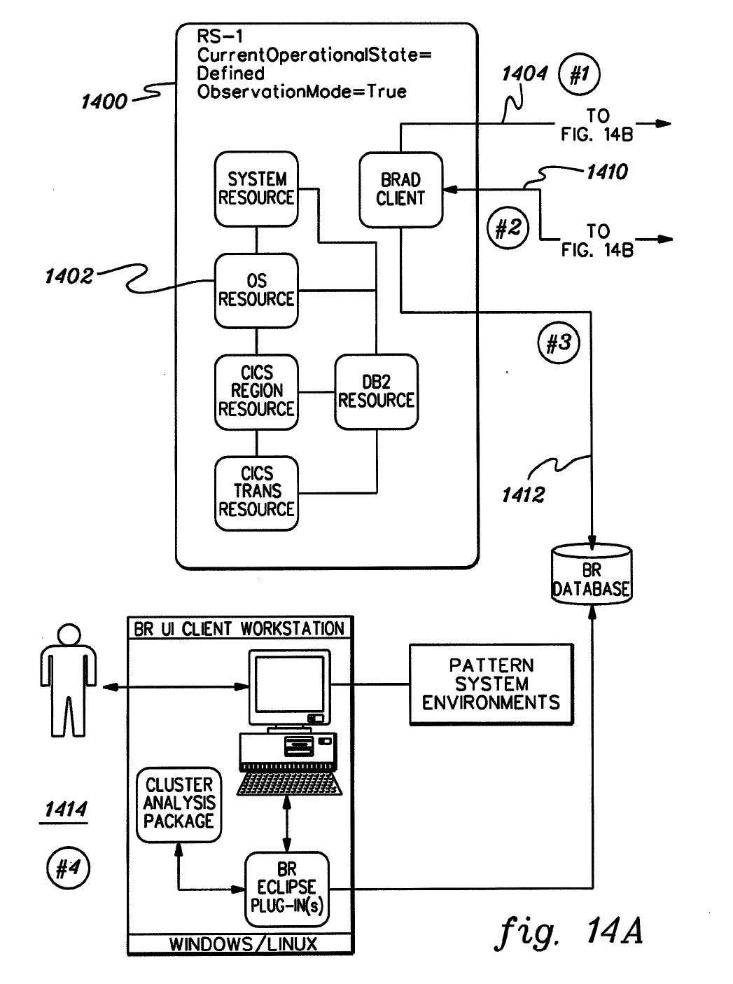

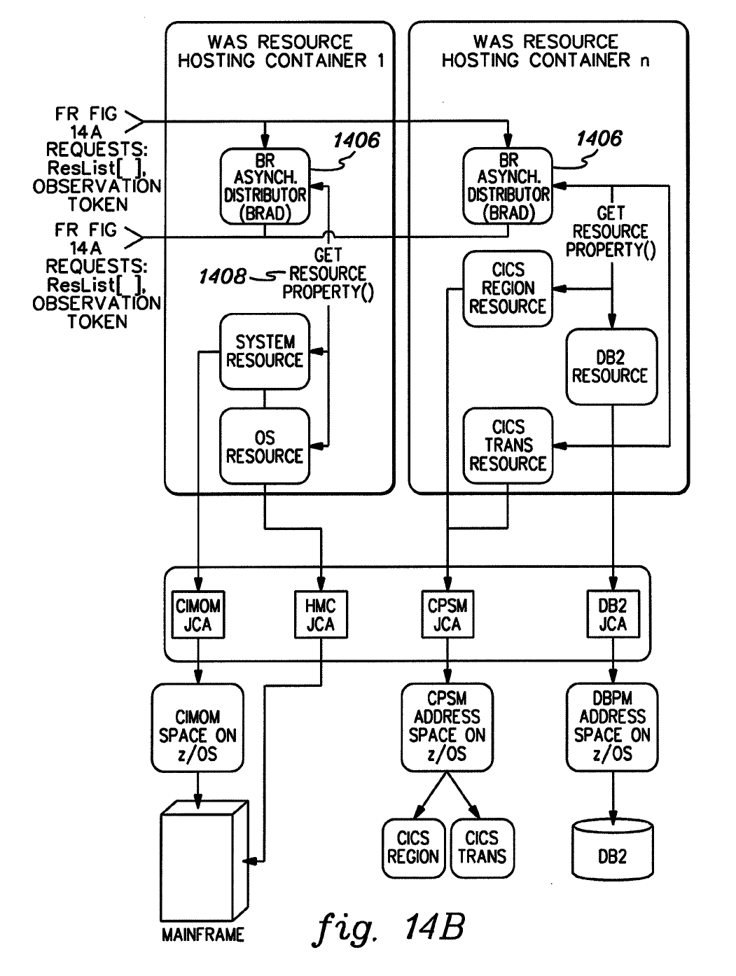

An overview of the periodic poll process is described with reference to FIGS. 14A-14B.
Each Recovery Segment 1400 maintains a list of its constituent resources 1402 along with the deployment information for each resource (e.g., in one implementation, the hosting OS and WAS). At a periodic interval, those RSs in observation mode use that list to send an asynchronous message to each of the relevant BR Asynchronous Distributors (BRADs)1406 in the environment providing the list of resources for each BRAD to query and an observation token so that the multiple observation records can be correlated from the BR UI. See #1, 1404.
Each BRAD 1406 then synchronously invokes operations on the resources in the list provided by the Recovery Segment to collect the observation data points. The operations are those which correspond to, for instance, the RTO key factors for that resource type and the operation to query for state, which are maintained along with the other resource data in the BRMD table. The operations invoked, in one implementation, are typically the GetResourceProperty( ) method 1408, but may possibly require the invocation of other operations on the resource. The BRAD also records the round trip time for the retrieval of this information, since some of the information comes directly from the resource and some may be returned by the resource via its instrumentation (i.e., it is resource and implementation specific). The round trip delay also accounts for any latency delay between the BRAD, the resource, the resource instrumentation, and any latency inherent with the message exchanges.
Similarly, the operation execution duration for each of the exposed operations of the resource is collected, whether they were invoked by BR or not. The assumption is that these durations have been maintained by the resource and BR collects them. Ideally, this should entail only a single query operation invocation on the resource, but since each resource type may be implemented differently that may not always be the case. If the operation durations are not maintained by the resource, then the BRAD client maintains and collects them, but only collects the durations for those operations that BR has invoked. Again, the BRAD records the round trip time for the retrieval of this information.
Observations are aggregated at each BRAD and returned to the caller (#2 1410) for insertion into the Observation log using the correlation token supplied by the Recovery Segment (#3 1412). Using that observation token they can be aggregated into a single observation at the UI for cluster analysis (#4 1414). The Recovery Segment also updates the metadata associated with the resource(s) to maintain running averages and standard deviations for operation execution times and various round trip delays for use during runtime failure and recovery process creation.

The interval for performing periodic observations is based on, for instance, the RS resource property (PERIODIC_POLL_INVERVAL) that is configured via the BR UI. The staggering and pacing of the observation data is governed at the BRAD (via a thread pool to achieve parallelism based on the number of resources to query). The idea again is to not overwhelm or in any way degrade the system with the collection and storing of these observations. Note that since the observation timestamp is calculated by the RS at the end of each interval based on the current value of the PERIODIC_POLL_INVERVAL, it automatically accommodates any UI adjustments to it by the administrator (i.e., increasing or decreasing the interval). Finally, if the interval is altered to an unrealistically small (e.g., 1 minute) or large value (e.g., 999 minutes), the administrator is warned of the implications and advised against such an alteration.

### Dynamic Adjustment of Periodic Poll

Adjustments are made to four factors, as an example, to optimize processing, meet periodic poll interval requirements and minimize overhead of the periodic poll process. These include, for instance, adjustment to initiation cycle of periodic poll; invocation of requests for resources not responding; alteration of number of query threads; and alteration of number of requests per batch, batch size and pacing time for batches.

These processes work in conjunction with each process having an impact on others which is synergistically managed by the overall BRAD process.

The specified periodic poll interval is used as a staring point in determining the timing of batches. The number of requests per batch and the number of resources represented in the RS determines the number of batches. Based on the number of batches and the periodic poll interval, a microinterval for each batch is calculated, as described below. Actual time for the process may be longer or shorter than expected due to delays in request/response processing, delays in responses from resources and processing time for the technique. At the end of the periodic poll cycle, the actual time to complete the cycle is calculated. A ratio of the actual time to the desired periodic poll interval is calculated and used to scale the target periodic poll interval, also described below. Note that the target periodic poll interval is used as the reference point. The scaled periodic poll interval used in the technique is adjusted based on runtime characteristics of the system where the reality of the processing is empirically measured and compensated for by scaling the periodic poll interval for the next cycle.

Responses from BRAD processing include information from resources and an indication if a response from the resource was received before the microinterval timeout. On the next invocation of the BRAD from the periodic poll initiation process, those resources for which a response was not received are processed for threadpool execution first, as described below. Resources which responded in the last periodic poll cycle are processed and made available for threadpool execution after the resources which did not respond. This gives the non-responsive resources from the previous cycle priority and the full microinterval to complete as they have access to the threadpool first.

The number of query threads in the threadpool is initialized based on BR distributed calculations. The number of resources responding and the proportion of the interval used to receive the responses are used to adjust the threadpool size. If all resources have responded and no more than, for instance, 70% of the available interval time has been utilized, the number of threads in the threadpool is decreased, as described below. The threadpool is contracted at a rate of, for instance, 10% of the threads. This is a slow contraction process which requires multiple iterations to shrink the number of threads by half. If all resources have not responded, the number of threadpool threads may be increased. The increase is, for instance, half the percentage of the difference between the number of requests in the batch and the number of resources not responding, as described below. If the percent of response not received is less than, for instance, 10%, the threadpool is set to its maximum size which is equal to the number of requests in the batch. This is a relative rapid increase in the number of threads in order to quickly meet the needs of periodic poll processing. It is paced by the previous number of threads, the number of requests completing and the number of requests not providing a response. Therefore, it adjusts to start increasing rapidly when needed and slow as the target of completing all requests is approached. The limit to the increase in threads in the threadpool is the total number of requests in a batch. At that point, each request is initiated as soon as the cycle begins and has the full microinterval to complete.

Adjustments to the number of requests in a batch is paced to work synergistically with the adjustments to the threadpool number of threads. No change is made to the number of requests in a batch for, for instance, the first 10 iterations of the periodic poll cycle. If at the end of 10 cycles there are resources which are not providing a response, the threadpool adjustments to the number of threads will have practically reached stabilization at the number of threads per batch. The number of requests per batch is adjusted by ⅓, in one example, as described below. This lengthens the microinterval by ⅓ allowing for a larger proportion of resource requests to complete. Adjusting the number of requests per batch also drives the threadpool number of threads processed. If the increased number of requests are not completing, the threadpool has an increased number of threads. Consumption of the additional 33% of requests per periodic poll cycle requires the threadpool number of threads routine approximately 4 cycles to reach maximum threads per threadpool. Therefore, the number of requests per batch is adjusted at most every fourth poll cycle, in this embodiment.

If all batches of requests respond before expiration of the allotted portion of the poll interval, the number of batches may be increased with a corresponding decrease in the number of requests per batch. The total of the not used by requests, i.e., the time difference between that in which the response arrived and the allotted portion of the poll interval, is maintained as responses to requests are received. The minimum response time is also maintained as responses to requests are received, as described below. If the total of the unused time is greater than the smallest response time, the number of batches is increased by one with a corresponding decrease in the number of requests per batch, also described below.

While one embodiment of the above technique is described in the following logic, extensions or alterations are achievable. For example:
Threads which do not respond within a microinterval may not be terminated but continue to execute in order to retrieve resource data;
Ordering of the BRAD_List by resources taking longer to respond to resources taking less time to respond;
Maintaining a history of adjustments to thread counts to stabilize exceptionally frequent or wide variations in resource responsiveness, where the history is used to determine the likely effect of future thread count adjustments;
Alterations to the percentages of responding resources or percentage of microinterval utilized in making adjustments;
Notification to the BR administrator for resources which repeatedly fail to respond within the allotted time interval;
Thresholds for BR administrator warning on percentage of nonresponsive resources; and
Notification to the BR administrator on change of batch size, number of requests per batch or changes in thread pool size.

In the following logic, references are made to services for thread pool management, such as create a thread pool (new); and remove a thread pool (shutdownNow). Descriptions for these services can be found in, for instance, ISBN 0131482025: Core Java™ 2, Volume I—Fundamentals (7th Edition) (Core Series), and ISBN 0131118263: Core Java™ 2, Volume II—Advanced Features (7th Edition) (core Series), each of which is hereby incorporated herein by reference in its entirety.

Deployment of BRAD in Associate RS with BRM

Establishing the BR environment includes interaction with the BR administrator for deployment of BRAD functionality. One step in creation of the BR environment insures the existence of an association of resources being managed and a BRAD instance. Optimally, the BRAD associated with a resource instance is within the same hosting environment enabling low overhead for requests presented from the BRAD to the resource representation for data.

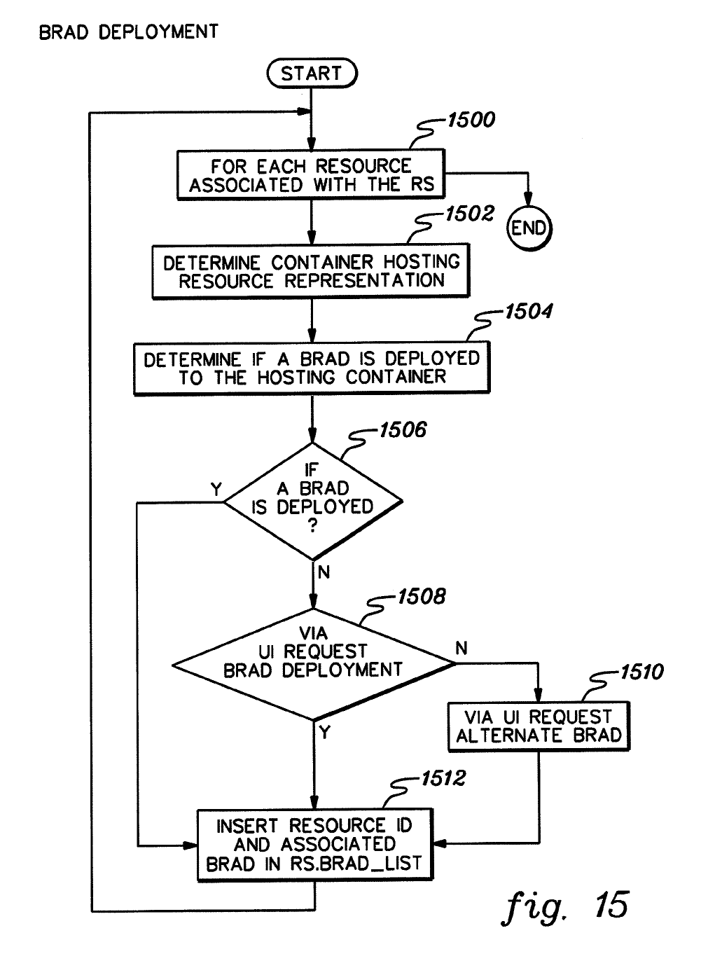

One embodiment of the logic to deploy a BRAD is described with reference to FIG. 15. As one example, the RS component of the BR system performs this logic.

Referring to FIG. 15, each resource associated with the RS is processed, STEP 1500. In one implementation, the resources are determined by retrieving each directed acyclic graph (DAG) of resources associated with the RS which was created when the RS was defined. In another implementation, this is accomplished by retrieving each BRMD table entry having a column showing a pairing with the RS.

A determination is made regarding the hosting environment for the resource representation, STEP 1502. In one implementation, this information may be provided through a UI interaction with the customer. The UI interaction may enable a group of resources to be identified as associated with one hosting container, in one example. Another implementation may invoke a JMX interface to determine the hosting environment.

Further, a determination is made as to whether a BRAD is deployed to the hosting container, STEP 1504. In one implementation, this is accomplished through a UI interaction with the customer where BR administrator assurance of BRAD deployment is obtained. In another implementation, software interfaces may be utilized to determine if BRAD functionality has been deployed.

If a BRAD has not been deployed, INQUIRY 1506, a request to the BR administrator is made via the UI to cause a BRAD to be made operational in the hosting environment, INQUIRY 1508. If the BR administrator does not deploy a BRAD, a UI interaction may request specification of an alternate BRAD to be used to gather data on the resource, STEP 1510.

When a BRAD has been established for the resource (Y from INQUIRY 1508, or Y from INQUIRY 1506, or from STEP 1510), an entry in the RS.BRAD_List is made that includes the identification of the resource and the associated BRAD identification, STEP 1512. Processing then continues at STEP 1500.

### Renew RS.BRAD_LIST

The list of resources associated with a BRAD built during RS deployment is updated during ongoing systems operation. In one implementation, the RS.BRAD_List may be updated when:
Resources are added or deleted from the RS;
If a recovery process is executed as resources may move to a new hosting environment, which may alter the hosting environment for the resource representation with which the BRAD communicates;
On detection of excessively long response intervals to BRAD requests, particularly where there is a disparity between requests made to resources serviced by the same BRAD.

Update to the RS.BRAD_List may be performed as a complete refresh or as a selective alteration. A similar process to establishing the RS.BRAD_List as RS deployment time is followed for a single resource update or for a complete refresh. During runtime, updates can be performed without involvement of the BR administrator, if programming interfaces exist for determining the hosting container for a resource representation and for deploying a BRAD in a hosting container. If programming interfaces do not exist for those functions, notification is provided to the BR administrator through the mailbox.

### BRAD Initialization

BRAD initialization is initiated by, for instance, WAS when the BRAD EJB is started in the WAS container. Two threadpools are allocated, a fixed-size threadpool for periodic observations and a cached threadpool for state queries. The fixed-size threadpool is better suited for queries that are not as time sensitive as the state queries, since it dispatches fewer threads simultaneously, whereas the cached threadpool dispatches the number of threads required immediately.

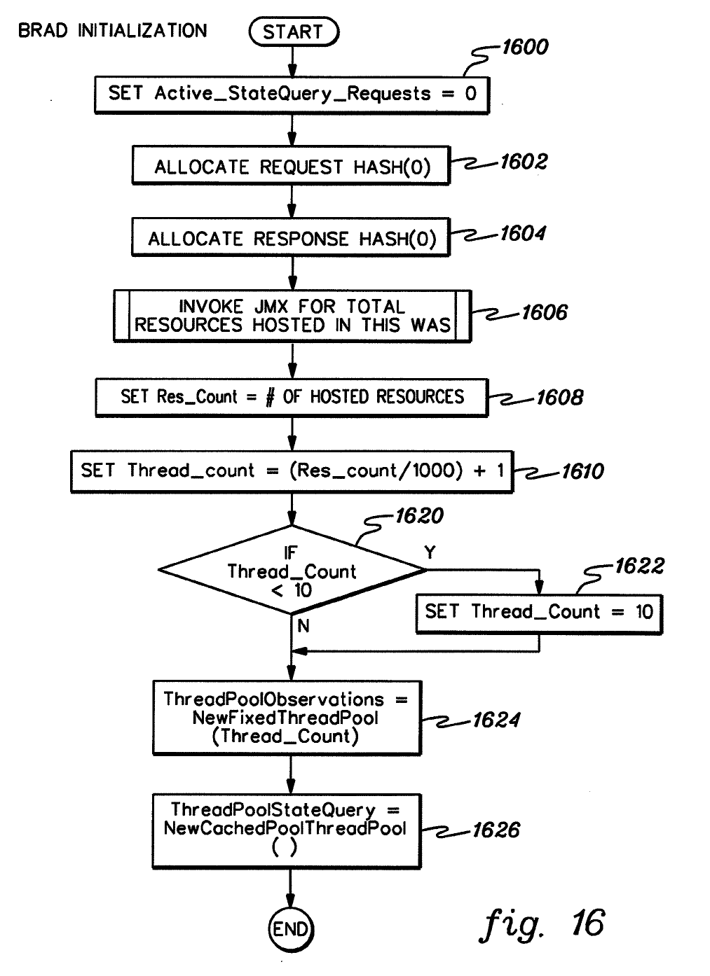

One embodiment of the logic to initialize a BRAD is described with reference to FIG. 16. As one example, this logic is performed by BRAD initialization executed when the BRAD EJB is started in a WAS container.

Referring to FIG. 16, a count of state query requests currently in progress is set to zero for later update when state query requests arrive, STEP 1600. A hash table to maintain the requests that arrive and a hash table for the response to be returned are initialized, STEPs 1602, 1604. A JMX API is used, in one example, to determine the total number of resources being represented on this WAS container, STEP 1606. The count of resources being represented on this WAS container is set to the returned number, STEP 1608.

Two threadpools are created. One of a fixed size for the periodic observations; the other is a cached thread pool for the query states. The threadpools serve as the BRAD dispatcher. The fixed size threadpool has active the number of threads allocated for it. When more tasks are submitted than threads available, they are queued up by the threadpool manager of WAS. As threads free up, tasks are read off the queue provided by the WAS threadpool manager.

The cached threadpool dispatches everything submitted to it through WAS services using free threads if available or allocating new threads. There are no tasks that are not immediately dispatched to the cached thread pool, in this implementation.

In one example, a count of threads for the fixed pool is calculated from the total number of resources divided by 1000 with the result incremented by one, STEP 1610. This number may be adjusted during ongoing operation of the BRAD. If the fixed pool number of threads is less than, for instance, 10, INQUIRY 1620, the count is set to be 10, in this example, STEP 1622. Otherwise, or if set to 10, a fixed thread pool is created through invocation of WAS services with the calculated thread count, STEP 1624.

Additionally, a cached thread pool is created through invocation of WAS services with an unbounded number of threads in order to immediately begin processing of all tasks associated with a query state request, STEP 1626.

Having initialized the BRAD, no further processing is performed until a request for BRAD processing is received as, for example, from periodic poll or state query processing.

### Initiating Observation (Periodic Poll)

At each polling interval, BR sends a query to the set of resources managed for a given RS to collect, for instance, state, RTO metrics, operation execution timings, properties associated with 1st level state aggregation rules, and properties associated with triggers for pairing rules. Roundtrip times and clock variations are also recorded. A part of the information collected is recorded into the Observation Log and part is used to update the BRMD and BRRD information. The observation collection is phased across resources over the polling interval, parallelized and made asynchronous to achieve minimal performance impact.

This logic is initiated when the UI user sets the observation mode resource property for a selected RS, or when policy has been activated. The periodic poll process is operated continuously during BR runtime. Adjustments are made to the number of requests in a batch and the wait time for a batch(s) of requests based on observed response completions, timeouts and time to respond. All requests to the BRADs are performed asynchronously.

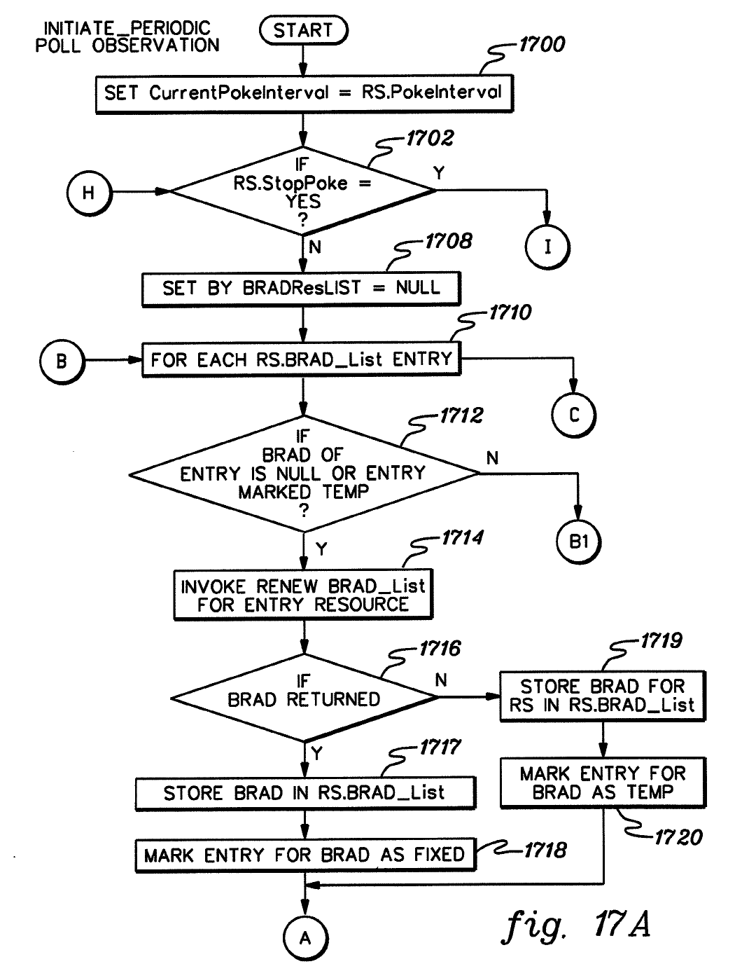

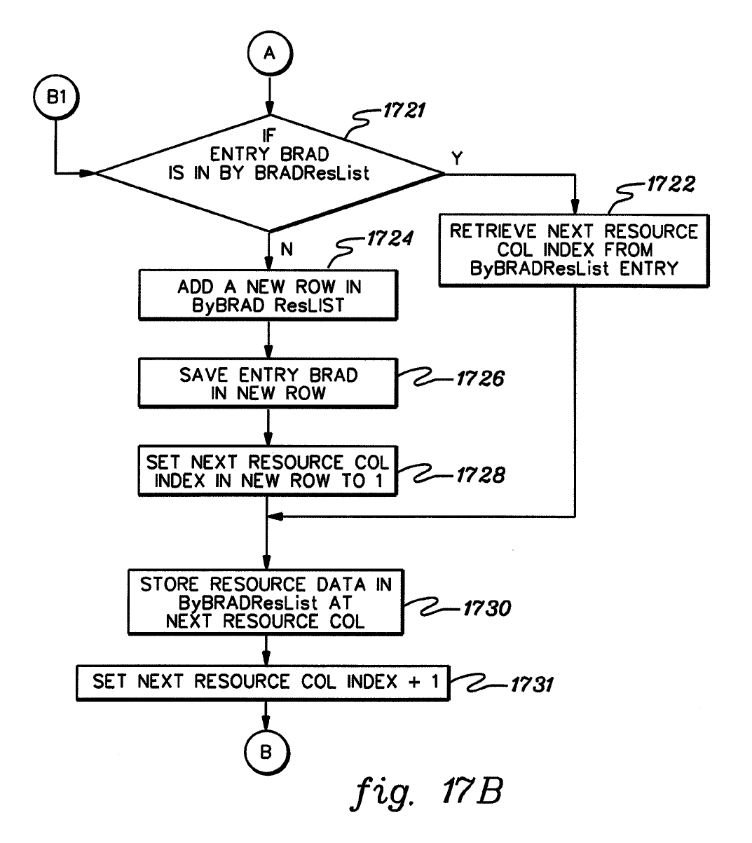

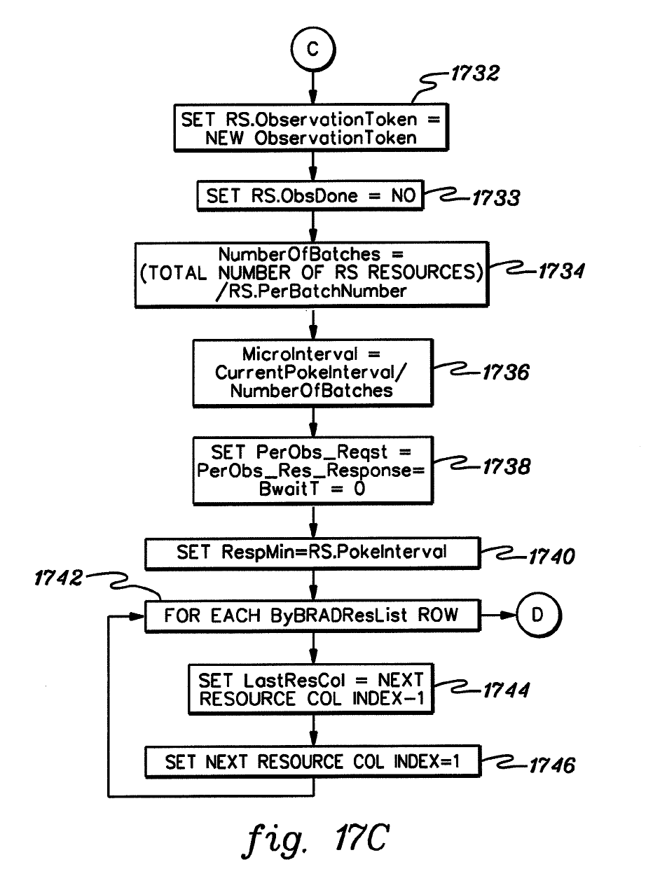

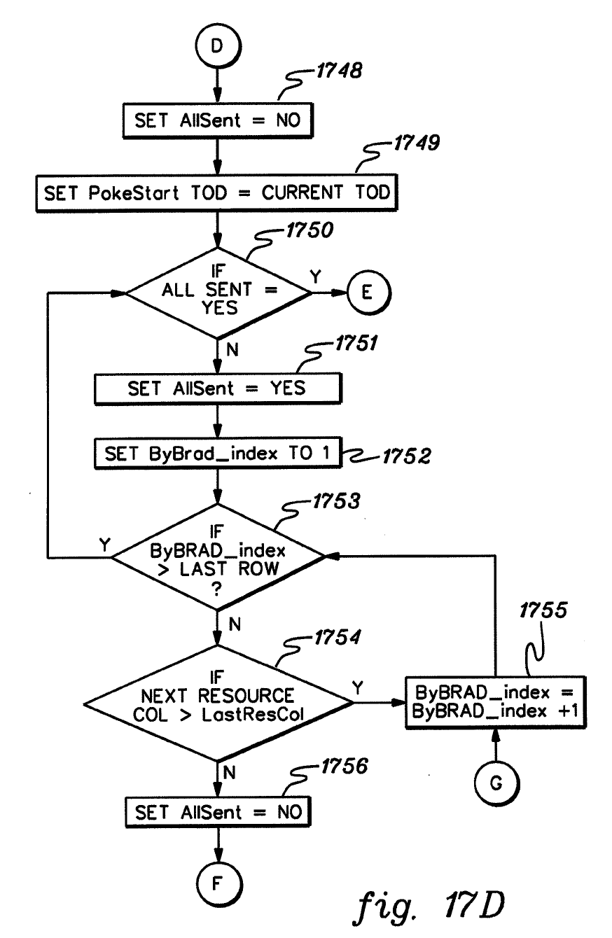

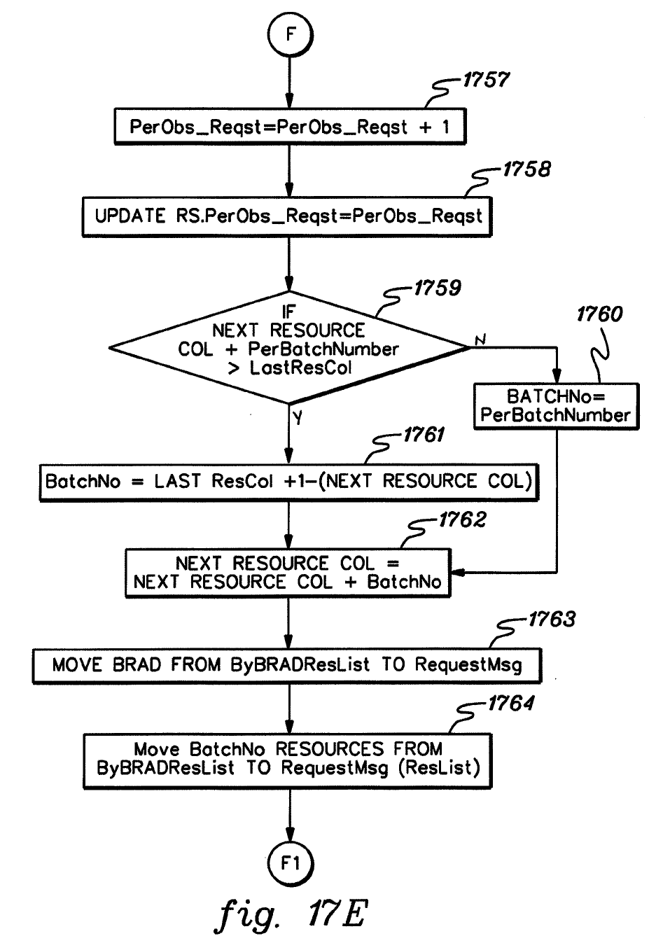

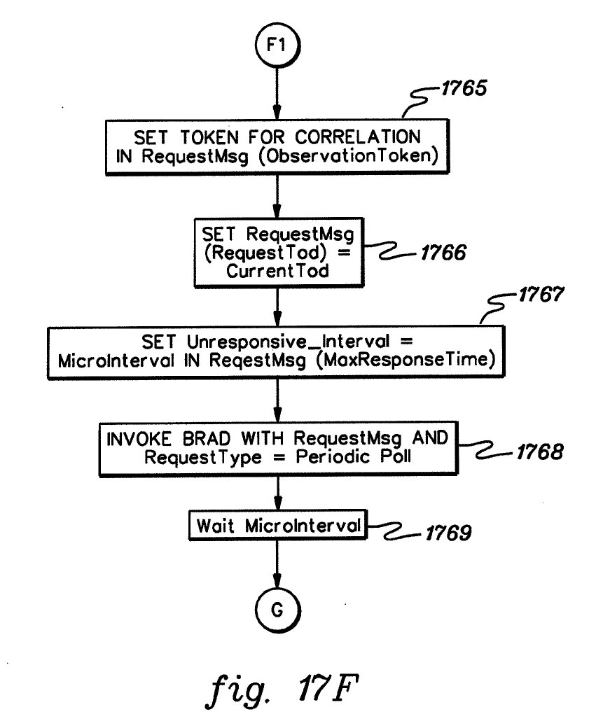

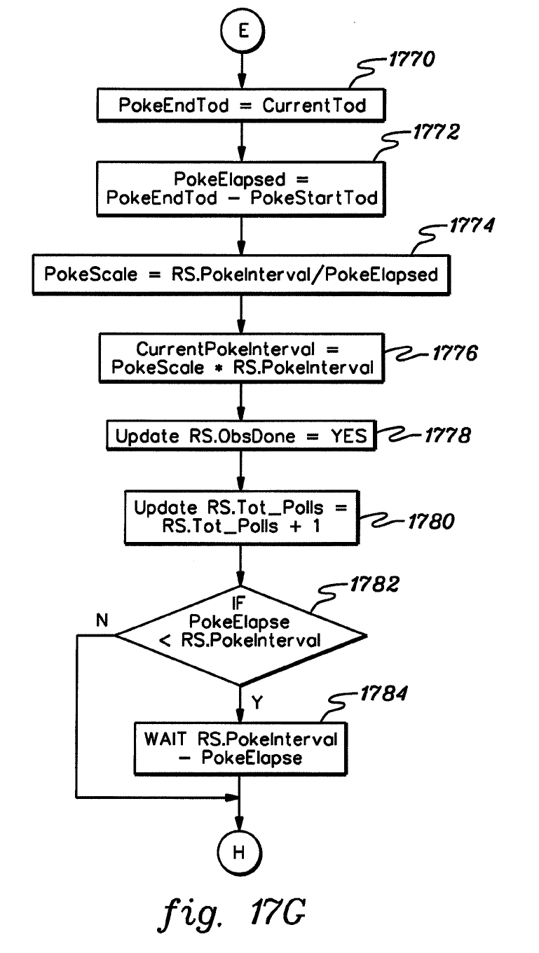

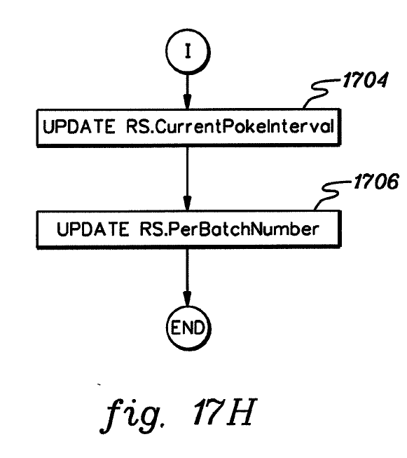

One embodiment of the logic to initiate periodic poll observation is described with reference to FIGS. 17A-17H. This logic is performed by, for example, the RS component of the BR system.

Referring to FIG. 17A, the current interval for poll, CurrrentPokeInterval, is initialized from RS.PokeInterval, STEP 1700. If periodic requests for resource data is to be terminated, INQUIRY 1702, the CurrentPokeInterval and the number of requests in each batch are saved in the RS, as they may have been changed over the execution of BRAD processing, STEPS 1704, 1706. Otherwise, the list of resources associated with each BRAD, ByBRADResList, is set to null in preparation for initialization, STEP 1708. Each resource associated with the RS, as reflected in RS.BRAD_List, is processed, STEP 1710.

If a BRAD is associated with the resource and the associated BRAD is not temporary, INQUIRY 1712, processing proceeds to determine if the BRAD is already in the ByBRADResList, STEP 1721 (FIG. 17B). Otherwise, processing to renew the BRAD associated with the resource is invoked, STEP 1714 (FIG. 17A). If a BRAD is returned for the resource, INQUIRY 1716, it is saved in the RS.BRAD_List, STEP 1717, and the entry is marked as being fixed, STEP 1718. Otherwise, the BRAD associated with the same execution container as the RS is stored in the RS.BRAD_List, STEP 1719, and the entry is marked as temporary, STEP 1720. Being marked as temporary causes processing to attempt to locate a BRAD co-located with the resource on subsequent poll cycle iterations.

The ByBRADResList is built to include a list of resources associated with each BRAD providing service to the RS. If the BRAD associated with the resource has already been placed in the ByBRADResList, INQUIRY 1721 (FIG. 17B), the column index into that row of the ByBRADResList is retrieved, STEP 1722.

Returning to INQUIRY 1721, if the BRAD has not been placed in the list, a new row is created in the ByBRADResList, STEP 1724, the BRAD associated with the resource is stored in the new row, STEP 1726, and the next resource column index in the new row is set to 1, STEP 1728. Having set or retrieved the next column index for the row, the resource associated with the BRAD is stored in the ByBRADResList, STEP 1730, the next column index for the row is incremented by one, STEP 1731, and processing continues at STEP 1710 (FIG. 17A). Data stored in the ByBRADResList for a resource includes the resource identification and the flag indicating whether or not the resource provided a response in the last polling cycle. The RS.BRAD_List is updated when the polling cycle is complete with an indicator for each resource of whether or not a response was received, as described below.

When all resources associated with the RS have been processed, STEP 1710, initialization for the poll cycle is executed. The RS.ObservationToken is set to reflect the current poll cycle, STEP 1732 (FIG. 17C), and the indication for having completed the poll cycle, Rs.ObsDone, is set off, STEP 1733. The number of batches for the poll cycle is calculated based on the number of resources associated with the RS and the number of requests to be processed in each batch, RS.PerBatchNumber, STEP 1734. Within a poll cycle, each batch is allotted a portion of time, MicroInterval, determined by, for instance, dividing the CurrentPokeInterval by the number of batches, STEP 1736.

Data to be used in making dynamic adjustments to the number of requests per batch is initialized for the poll cycle. The number of requests to BRAD(s) is set to zero, as are the number of resources providing responses to the poll cycle, PerObs_Res_Response, and the accumulated wait time across all of the batch MicroInterval(s), STEP 1738. Recording of the minimum time any one request to a BRAD required, RespMin, is used to determine if the number of batches should be decreased. It is initialized to the length of the polling cycle, so that as responses arrive, the minimum of the current response and RespMin can be kept as the running minimum response time, STEP 1740.

The ByBRADResList is prepared for poll cycle processing. Each row of the ByBRADResList, STEP 1742, has the last resource column set based on the next resource column index created when adding resources to a row, STEP 1744. The next resource to be processed for a BRAD is initialized to the first column index (e.g., 1), STEP 1746.

An indication, AllSent, is set to false reflecting that all requests for BRAD(s) have not been sent, STEP 1748 (FIG. 17D), and the start time of the poll cycle, PokeStartTOD, is set to the current time of day (TOD), STEP 1749.

For the poll cycle, a cycle is executed (e.g., STEPs 1750-1769, described below), in which a batch of requests is sent to a BRAD and the MicroInterval for the batch is exhausted before the next request is sent. Requests are sent sequentially to each BRAD in the ByBRADResList, so long as there exist resource(s) for that BRAD which have not been processed in this poll cycle. A determination is made if all requests have been sent for this poll cycle, INQUIRY 1750. If not, the indication that all requests have been sent is set true, STEP 1751. This indication is reset if any requests are sent when processing through the ByBRADResList. An index for moving through the ByBRADResList is initialized to 1, STEP 1752. A loop through the ByBRADResList is performed with checking to determine when all entries in the ByBRADResList have been processed, INQUIRY 1753. When the last row in the ByBRADResList has been processed, the next iteration through the ByBRADResList may be performed INQUIRY 1750. Otherwise, a comparison of the next resource column to the last resource column for the row determines if there are resources associated with this BRAD for which a request has not been made this poll cycle, INQUIRY 1754. If remaining resources do not exist for this BRAD, the next BRAD is processed, STEP 1755. Otherwise, the indication of all processing having been performed is set to false, STEP 1756.

A request for a BRAD is created (e.g., STEPs 1757-1768). The number of requests made to BRAD(s) for this poll cycle is incremented by one, STEP 1757 (FIG. 17E), and recorded in the RS, STEP 1758. If a full batch of requests for the BRAD can be made, the number of remaining resources in the row for the BRAD is greater than the per batch number. If there are at least the per batch number of resources remaining to be processed by the BRAD, INQUIRY 1759, the size of the batch, BatchNo, is set to the per batch number, STEP 1760. Otherwise, the number of requests in the batch is set to the number of remaining resources in the ByBRADResList row, STEP 1761. The next resource to be processed for the BRAD is set to the resource just after the last one in this batch, STEP 1762.

Identification of the BRAD to which the request for resource data is to be sent is set in the request message, STEP 1763. The resource identification for each resource in the batch is moved from the ByBRADResList to the request message, RequestMsg, STEP 1764. The token for this poll cycle (established at STEP 1732) is set in the request message, ObservationToken, for correlation when a response is received, which is also used to determine if delayed responses are to be discarded, STEP 1765 (FIG. 17F). The current TOD is set in the request message, such that when a response is received, the time required for the round trip request/response to the BRAD can be calculated, STEP 1766. The round trip time is utilized in determining if the number of batches should be increased, and therefore, the number of requests in a batch decreased and the portion of the poll cycle time allotted to the requests decreased. The maximum time allotted for this BRAD request is set to the MicroInterval, STEP 1767. The BRAD is invoked with the request message and an indication of this being a periodic poll, STEP 1768. A delay equal in time to the MicroInterval is executed, STEP 1769, before the next batch is processed, STEP 1755 (FIG. 17D).

When all batches for the poll cycle have been processed, INQUIRY 1750, statistics for the periodic poll process are generated. The ending time is set to the current TOD, STEP 1770 (FIG. 17G), and the elapsed time for the poll cycle is determined by subtracting the start time for the cycle, STEP 1772. A scaling factor for the periodic poll process is calculated from the ratio of the desired periodic poll interval, RS.PokeInterval, and the elapsed time for this cycle, PokeElapsed, STEP 1774. A target interval for the next periodic poll cycle, CurrentPokeInterval, is set by multiplying the desired interval by the scaling factor, STEP 1776. This polling cycle is marked in the RS as having completed, which serves as an indication to BRAD client completion processing, STEP 1778. The total number of polling cycles for this RS, RS.Tot_Polls, is incremented by one, STEP 1780.

If the elapsed time for this polling cycle is less than the desired interval, INQUIRY 1782, a delay equal to the difference is introduced, STEP 1784. Otherwise, or when the delay completes, the next periodic poll cycle begins, INQUIRY 1702 (FIG. 17A).

When periodic polling is to stop, INQUIRY 1702, the time for the current cycle is saved in the RS, STEP 1704 (FIG. 17H). The current number of requests in a batch is saved in the RS, STEP 1706, and the initiate periodic poll observation routine terminates.

### BRAD Request Processing

The BRAD logic for when a periodic poll observation request type is sent to the BRAD EJB is initiated by a BRAD client request from one of the WAS containers in the BR environment. Input includes, for instance, a request type (RequestType), a token representing the observation instance so the client can correlate responses with the request, a list of the resources and the data to be retrieved from the resource (ResList), and a time within which a response is required (MaxResponseTime). There are tasks that are submitted to the threadpool that get dispatched as threads become available. A response message is created based on the input request message, populated and then returned.

The assumption on the observation request is that the caller has provided all the necessary information in the ResList to do multiple queries to the same resource if required (e.g., to query an RTO metric, but also to query for state on that resource).

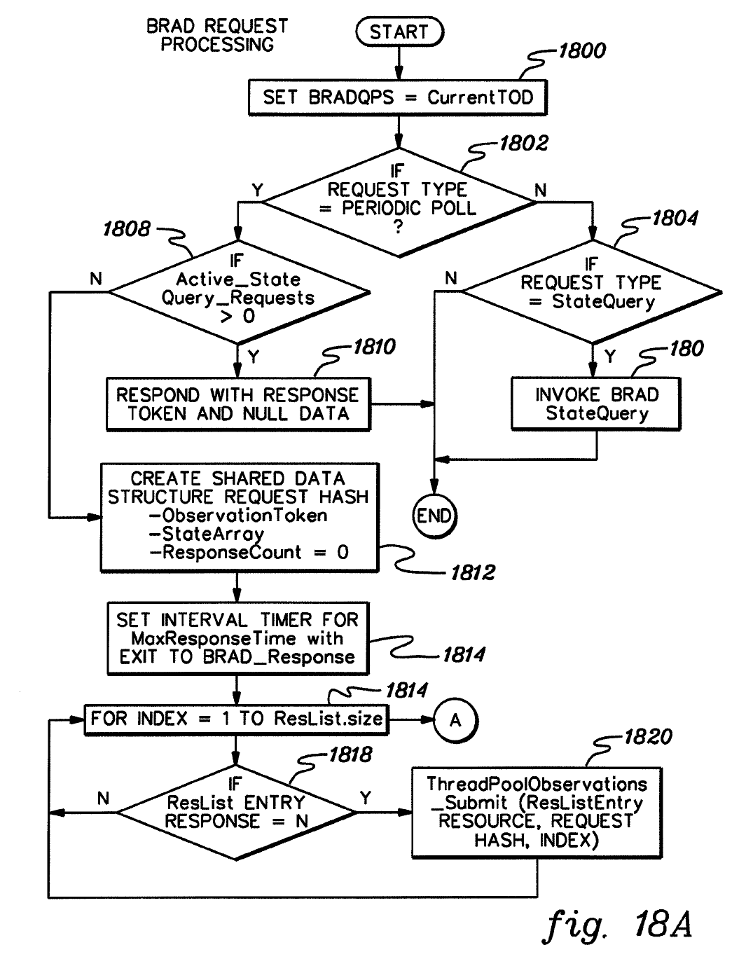

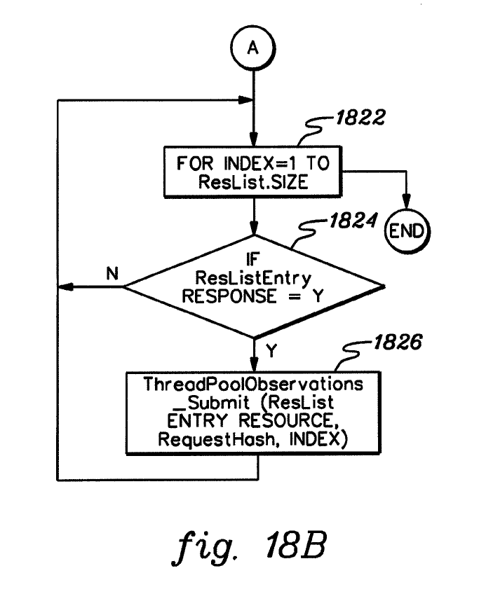

One embodiment of the logic to process BRAD Requests is described with reference to FIGS. 18A-18B. As an example, the BRAD performs this logic.

Referring to FIG. 18A, the current TOD is saved in BRADQPS for later use in calculating the duration of BRAD processing used in determining if the threadpool should decrease in size, STEP 1800. If the request is not for a periodic poll, INQUIRY 1802, the request is checked for being a state query, INQUIRY 1804. If the request is neither for periodic poll or state query, processing terminates. If the request is for a state query, BRAD state query logic (described below) is invoked, STEP 1806. Otherwise, the request is for periodic poll. If there are any active state query requests outstanding, INQUIRY 1808, a null response is returned to the request, STEP 1810, and processing terminates.

For a periodic poll process with no active state queries in process, INQUIRY 1808, a data structure, RequestHash, is created, STEP 1812. Each thread initiated to make a resource request updates an entry in the RequestHash array corresponding to the resource for which data was retrieved. The RequestHash structure includes, for instance, the ObservationToken from the request message, a StateArray which has a row for each resource from which data is to be requested, and a count of responses which have been placed in the structure, which is initialized to 0. An interval timer is set to the maximum time allotted to this batch of requests based on the MaxResponseTime contained in the request message, STEP 1814. At expiration of the interval timer, the BRAD_Response routine is to be given control.

For each resource in the request message ResList, STEP 1816, if the resource did not provide a response to the last poll cycle, INQUIRY 1818, a thread pool work element is submitted, STEP 1820, identifying the resource from the request message, an index into the StateArray for the output of the thread, which is the same index as the index into the request message ResList, and an anchor for the RequestHash shared data structure. This initial pass through the input prioritizes requests to resources which did not respond in the last periodic poll cycle. Processing continues at STEP 1816.

Returning to INQUIRY 1818, if the resource did provide a response, processing continue at STEP 1816.

After the first pass through the input, a second pass through each entry in the input message ResList is made, STEP 1822 (FIG. 18B). For each resource in the input message which did respond in the last periodic poll cycle, INQUIRY 1824, a thread pool work element is submitted, STEP 1826, containing the same data as in STEP 1820, and processing continues at STEP 1822.

Returning to INQUIRY 1824, if the resource did not respond, processing continues at STEP 1822.

When all resources in the input request message have been formed into thread pool work elements, processing completes until the next BRAD request message is received.

### BRAD State Query

The BRAD state query logic executes when a state query request type is sent to the BRAD EJB. It is initiated by a BRAD client request from one of the WAS containers in the BR environment. Tasks are submitted to the threadpool that are dispatched immediately.

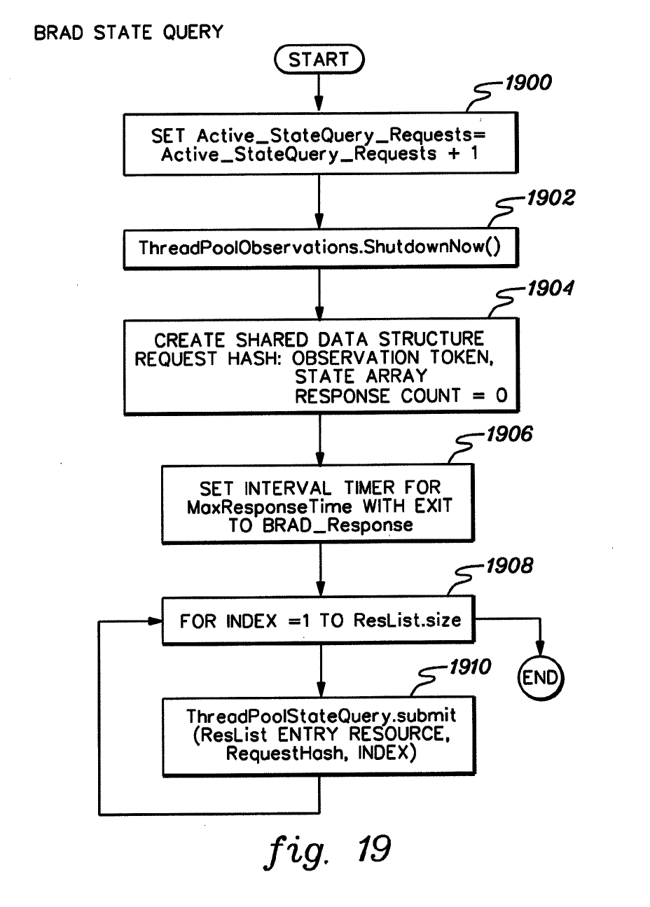

One embodiment of the BRAD state query logic is described with reference to FIG. 19. As an example, this logic is performed by the BRAD.

Referring to FIG. 19, the number of active state queries is incremented by one, STEP 1900. Any new periodic poll request terminates with a null response to the requester while any state query is being processed. The thread pool for observations is immediately terminated, in one example, causing any periodic poll process currently in progress to be terminated, STEP 1902. A shared data structure is created containing the token from the request message (ObservationToken) which enables the response to be correlated to the request, STEP 1904. The shared data structure is created to have one row for each resource for which data is to be obtained, StateArray. A count of responses used to determine when all responses have been placed in the shared data structure is initialized to 0 in the shared data structure. An interval timer is set for the allotted time for the requests from MaxResponseTime in the request message, STEP 1906. On expiration of the interval, the BRAD_Response routine is to be executed. For each resource in the request message, STEP 1908, a thread pool work element is created, STEP 1910. The thread pool work element includes, for example, the resource identification from the request message, a means for accessing the shared data structure (RequestHash) and an index, e.g., the same index as that for the resource into the input message ResList, to be used in determining the row in the shared data structure where the response data is to be placed. When all thread pool work elements have been submitted, processing ends awaiting the next state query request.

### BRAD Query Thread

The BRAD query thread logic describes the process taken by the JAVA threads that actually do the synchronous queries of the resources. They are initiated by the threadpool dispatcher when work elements have been submitted to the threadpool. In one implementation, the resource and property/operation are provided on request and there could be multiples of each which would allow the usage of getMultipleResourceProperty. In the implementation described herein, single requests for individual property/value(s) are processed.

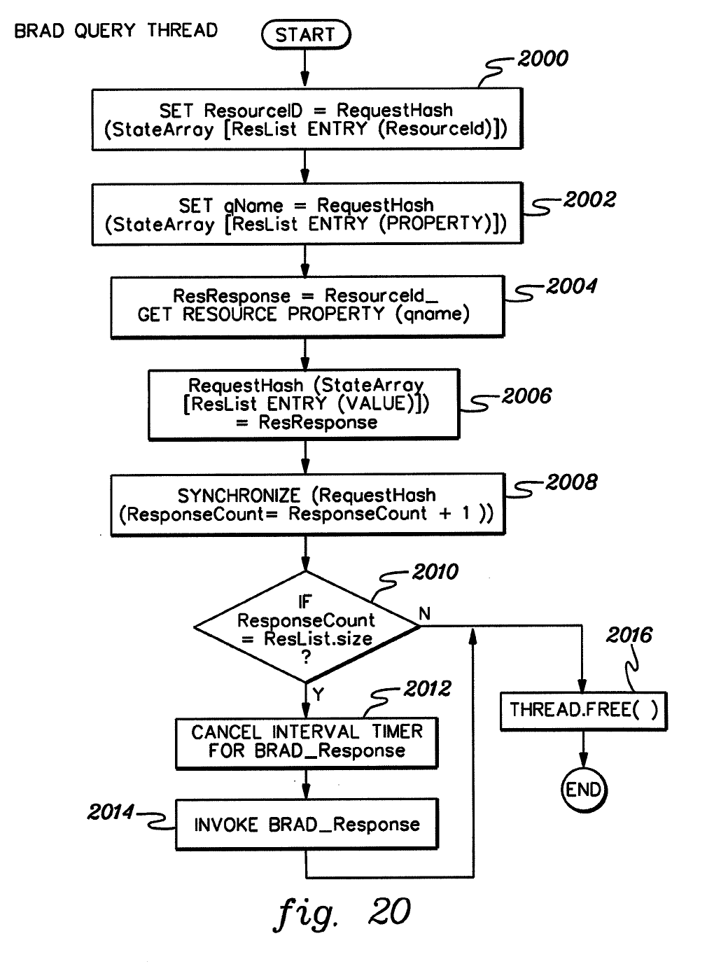

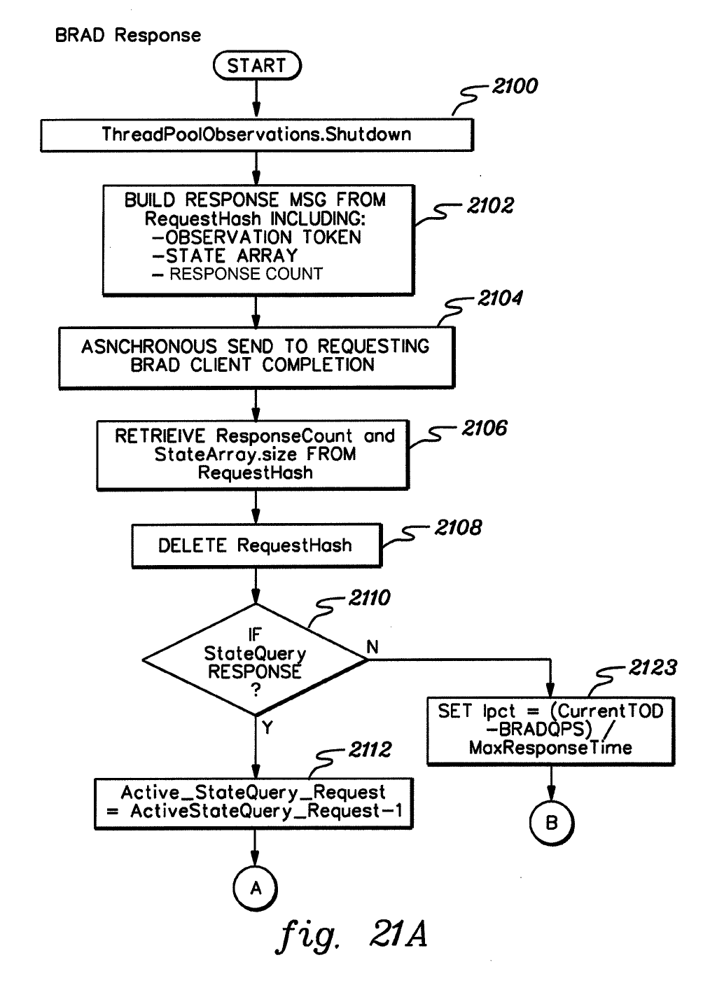

One embodiment of the BRAD query thread logic is described with reference to FIG. 20. As an example, this logic is performed by the BRAD.

Referring to FIG. 20, the resource from which data is to be collected and the specific property for which value(s) are to be collected are retrieved from the work element, STEPs 2000, 2002. A synchronous request to the resource for the data is presented, STEP 2004. When data has been returned, the RequestHash located from the work element is updated with data from the resource, STEP 2006. Within the RequestHash structure, the data area indexed for the specific resource the data was retrieved from is utilized avoiding the need to serialize updates with other query thread(s). The count of responses provided is serialized and incremented by one, as all query threads update the same shared data RequestHash data area, in this example, STEP 2008.

If the response count matches the number of resource requests which were to be processed, INQUIRY 2010, the interval timer for the allotted time for all requests to complete is cancelled, STEP 2012, and the BRAD_Response routine is invoked, STEP 2014. Subsequently, or if all data has not been retrieved, INQUIRY 2010, the thread is freed for processing the next threadpool work element, STEP 2016.

### BRAD Response

The BRAD response logic is given control when all responses have been populated in the RequestHash or on expiration of the timer for the maximum time allotted for this BRAD request batch.

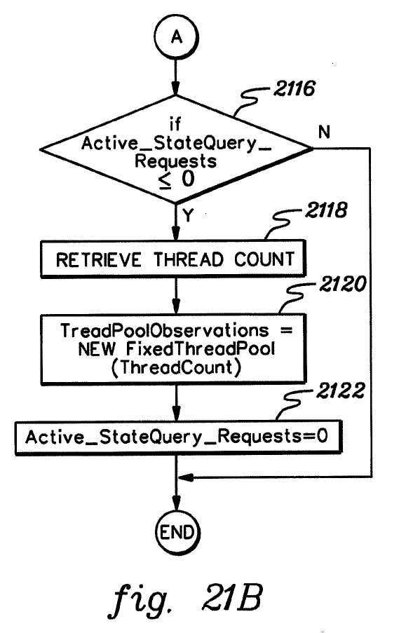

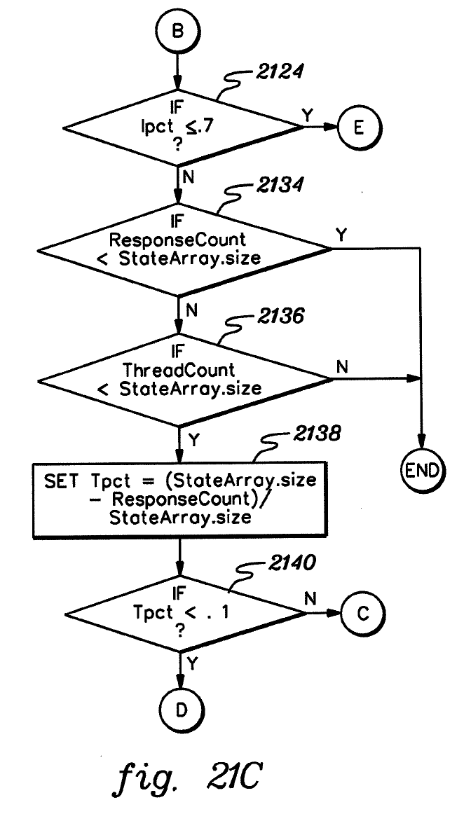

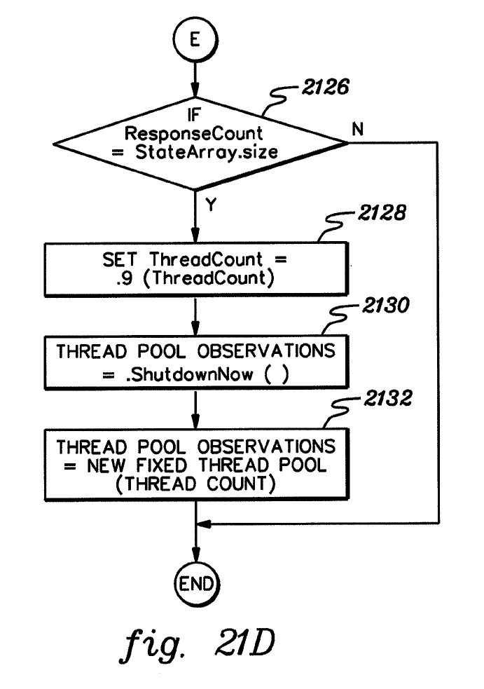

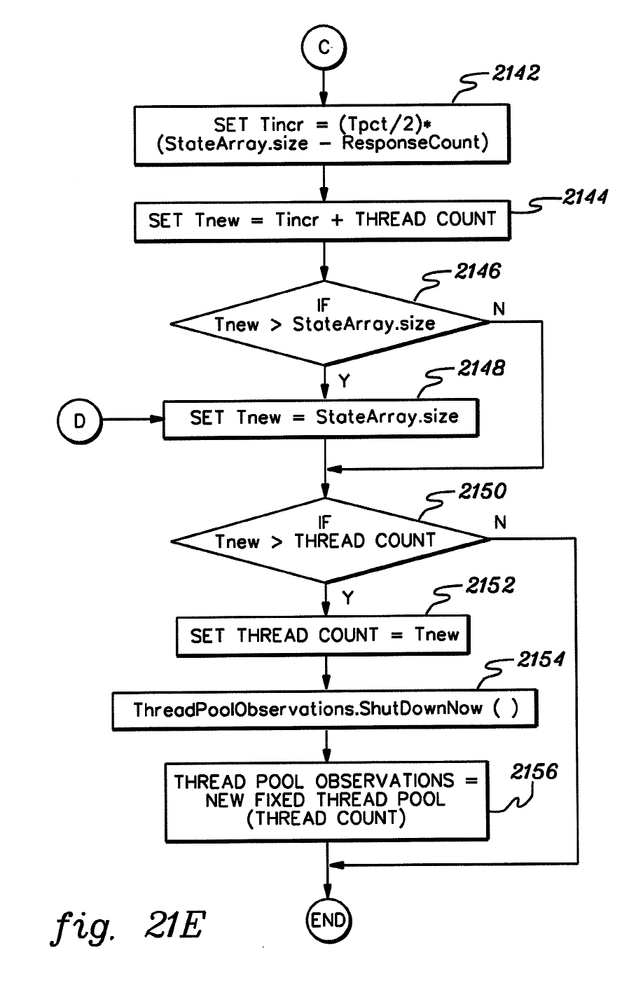

One embodiment of the BRAD Response logic is described with reference to FIGS. 21A-21D. This logic is performed by the BRAD, as one example.

Referring to FIG. 21A, the threads which are inactive are terminated and the threads which are processing a request are scheduled to terminate when the current request has completed, STEP 2100. A response message to the requesting BRAD client is constructed from data in the RequestHash common data area, STEP 2102. The response message includes, for instance, the ObservationToken identifying the originating request, property/value data from resources from the StateArray, and the count of resources responding, ResponseCount. The message is sent asynchronously to the requesting BRAD client completion routine, STEP 2104. The count of responses (ResponseCount) and the number of resource requests in the batch (StateArray.size) are retrieved from the common data area, STEP 2106, before it is deleted, STEP 2108.

If a response to a state query is being processed, INQUIRY 2110, the number of active state queries is decreased by one, STEP 2112. If the active state query count indicates there are no requests in process, INQUIRY 2116 (FIG. 21B), the thread count for observation is retrieved, STEP 2118, and the observation thread pool is created with a fixed number of threads equal to thread count, STEP 2120. The number of active state queries is indicated to be zero, STEP 2122, and processing ends.

Returning to INQUIRY 2100 (FIG. 21A), for response processing of periodic poll, the percent of time utilized in responding to the current batch request is generated from the difference in the current TOD and the time the BRAD request started (BRADQPS set in FIG. 18A, 1800) divided by the time allotted for this batch (from the request message), STEP 2123.

Processing to adjust the thread pool executes (STEPs 2123-2156). If all requests completed before expiration of the allotted interval and less than, for instance, 70% of the interval was used, INQUIRY 2124 (FIG. 21C), the thread pool may be contracted. If all resources provided a response, INQUIRY 2126 (FIG. 21D), the new thread pool size is calculated to be, for instance, 90% of the current size, STEP 2128. The existing thread pool is terminated (e.g., immediately, STEP 2130), and a new thread pool of fixed size is created, STEP 2132, and processing ends. Returning to INQUIRY 2126, if not all resources provided a response, processing ends.

If processing of the current batch required more than 70% of the allotted time, INQUIRY 2124 (FIG. 21C), a determination is made regarding all resources providing a response. If all resources provided a response, INQUIRY 2134, processing ends. Otherwise, the current thread count is compared to the number of resources in the batch. If the current thread count is not less than the number of resources in the batch, INQUIRY 2136, processing ends. Otherwise, the percentage of resources not providing a response is formed from the difference in the number of resources in the batch minus the number providing a response divided by the number of resources in the batch, STEP 2138.

If the percent of resource not providing a response is greater than, for instance, 10%, INQUIRY 2140, a thread count increase is set to half of the percent not responding, STEP 2142 (FIG. 21E). A new target is calculated by adding the increase to the current thread count, STEP 2144. If the new thread count target is greater than the number of resources in the batch, INQUIRY 2146, the target thread count is set to the number of resources in the batch, STEP 2148. Thereafter, or if the new thread count is not greater, if the net target thread count is less than or equal to the current thread count, INQUIRY 2150, processing ends. Otherwise, the thread count is set to the new target thread count, STEP 2152. The thread pool for observations is shutdown (e.g., immediately), STEP 2154, and a new observation thread pool of fixed size is created, STEP 2156.

Returning to INQUIRY 2140 (FIG. 21 C), if the percent of resource not providing a response is less that 10%, the target thread count is set to the number of resources in the batch, STEP 2148 (FIG. 21E), and processing continues as described above.

### BRAD Client Completion

BRAD client completion processes the response message from BRAD(s) which have retrieved resource data. The response message includes, for instance, the observation token identifying the periodic poll cycle or state query request, property value for resource(s) and the request TOD for when the request was originated to the BRAD.

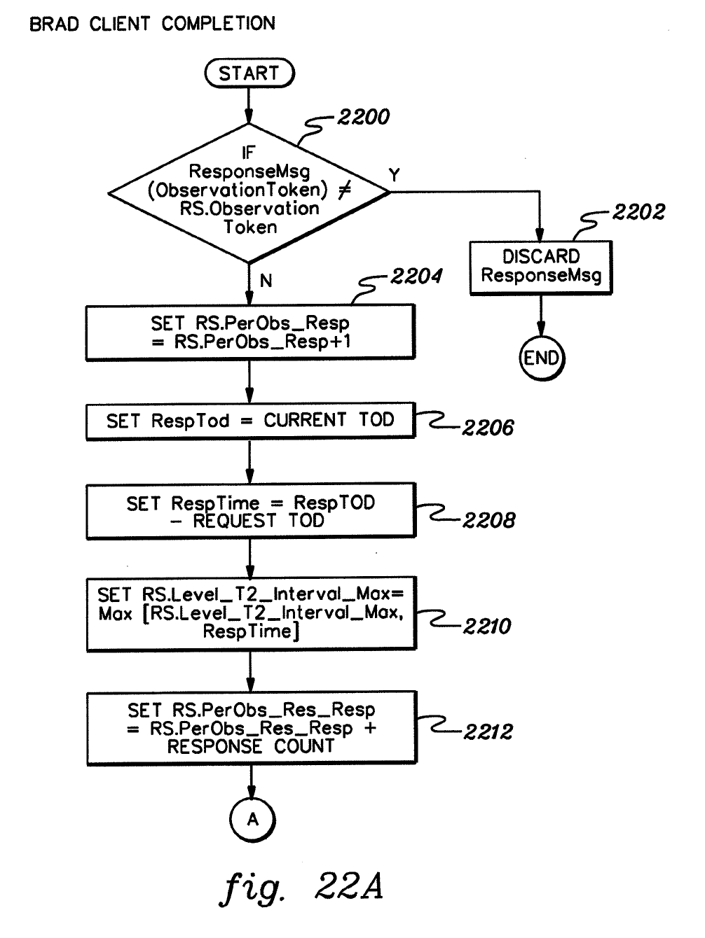

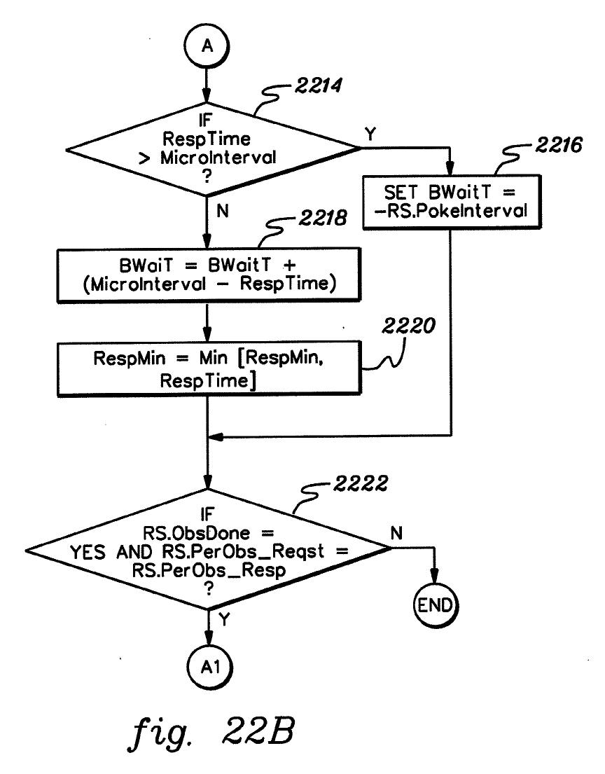

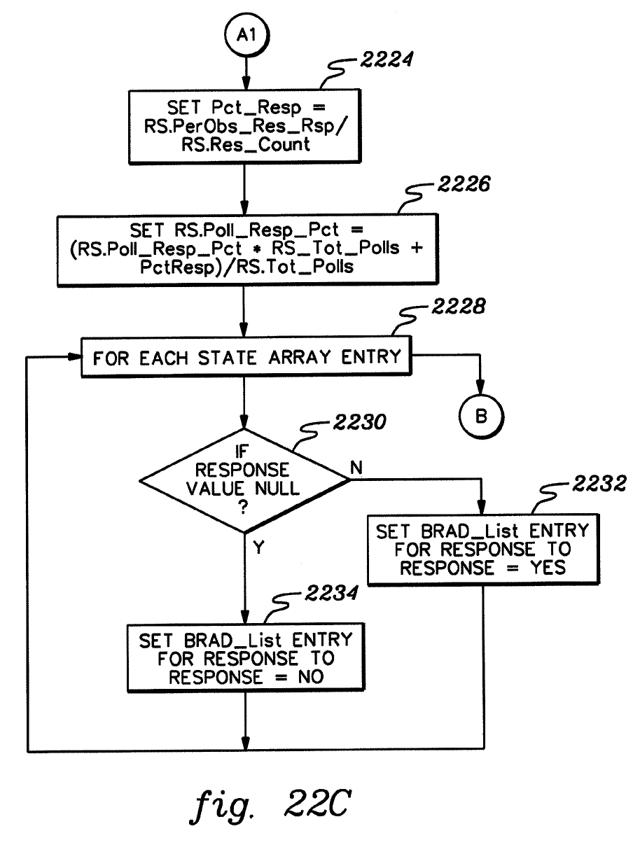

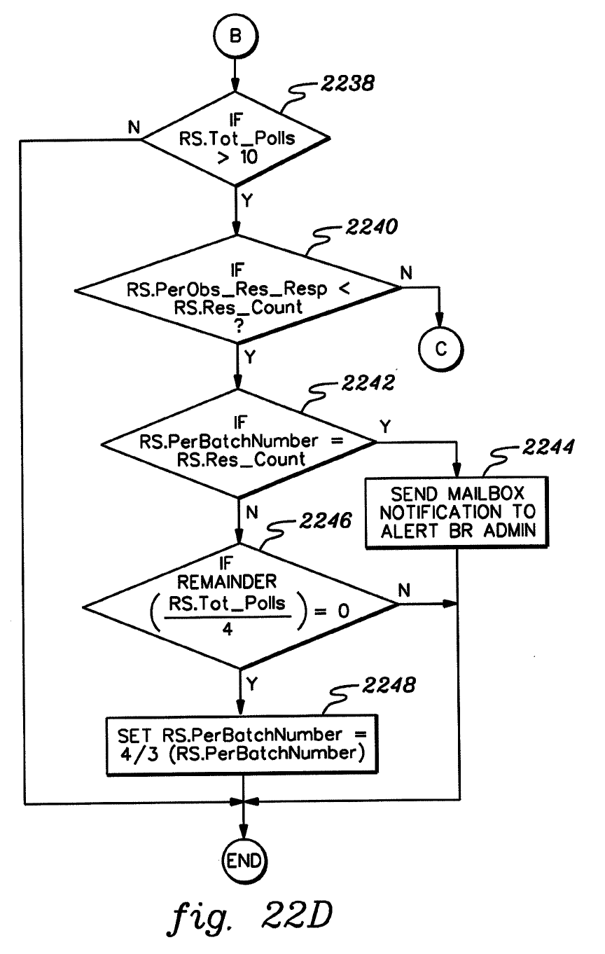

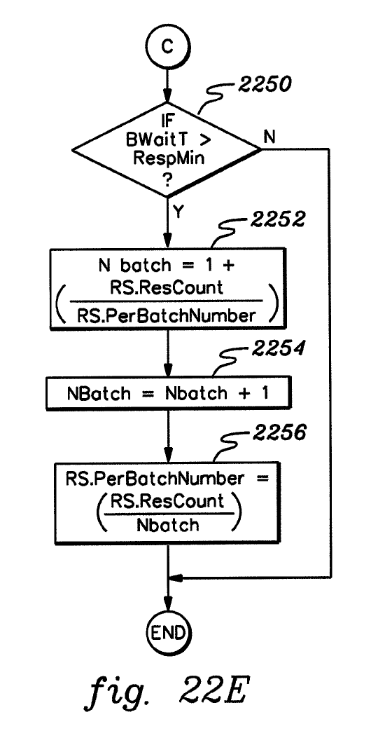

One embodiment of the BRAD client completion processing is described with reference to FIGS. 22A-22E. This logic is performed by the BRAD, as one example.

Referring to FIG. 22A, if the response message does not have the most current observation token as recorded in the RS, INQUIRY 2200, the response message is discarded, STEP 2202, and processing terminates.

Otherwise, statistics are generated for BRAD processing (e.g., STEPS 2204-2212). The number of responses received for this iteration of BRAD requests is incremented by one, STEP 2204. The current TOD is saved, STEP 2206, and used to calculate the response time for this request by subtracting the request TOD returned in the response message, STEP 2208. The maximum response time for a request for resource data is saved in the RS, RS.Level_T2_interval_max, STEP 2210. The number of responses received for the current execution of the BRAD process is updated with the count of resources responding in the current response message, STEP 2212.

Data is maintained for subsequent use in adjusting the number of requests per batch in STEPS 2214-2220 (FIG. 22B). If the current response time is greater than the time allotted for processing of the batch, MicroInterval, INQUIRY 2214, this batch did not complete in a timely manner and there should be no shrinking of the time allotted per batch, and therefore, no decrease in the number of requests per batch. Thus, the BWaitT value is set to equal the negative of the desired periodic poll interval which insures there is less than zero residual wait time influencing subsequent decisions on batch size, STEP 2216. Processing then continues with STEP 2222. Otherwise, the current response was received within the allotted time for the batch, INQUIRY 2214. The difference between the allotted time for the batch and the response time for the current response is added to the accumulated wait time for the current BRAD process, STEP 2218. The minimum response time is set to the minimum of response times processed up to the current response and the current response, STEP 2220.

If all requests for this cycle of BRAD processing have been submitted (RS.ObsDone—YES) and all response messages have been received, INQUIRY 2222, processing continues. Otherwise, processing ends.

When all responses to a BRAD processing cycle have been received, statistics are created. The percent of responses received across all requests is calculated from the sum of resources responding divided by the number of resources in the RS, STEP 2224 (FIG. 22C). The running percent of responding resources across all BRAD processing cycles is calculated by adding the percent resources responding in the current cycle to the product of the number of previous poll cycles and the previous running percentage divided by the total number of poll cycles, STEP 2226.

Processing to determine which resources responded in the current BRAD cycle is performed (e.g., STEPS 2228-2234). For each resource in the current batch, i.e., each StateArray entry in the response message, STEP 2228, the value in the response is checked for being null. If the resource provided a response, INQUIRY 2230, the corresponding BRAD_list entry is marked as having a response, STEP 2232. Otherwise, the BRAD_list entry is marked as not having a response, STEP 2234. In either case, processing continues at STEP 2228.

Adjustment of the number of requests in a batch, and therefore, the number of batches and time allotted for each batch is performed (e.g., STEPS 2238-2256). If, for instance, 10 or fewer periodic poll cycles have executed for the RS, INQUIRY 2238 (FIG. 22D), processing ends. Otherwise, if not all resources provided a response, INQUIRY 2240, it may be necessary or desired to lengthen the allocated time for each batch which will require more requests to be made in each batch. If the number of requests in a batch is at a maximum value of the number of resources in the RS, INQUIRY 2242, notification is sent to the BR administrator via the mailbox, STEP 2244, and processing ends. Otherwise, a determination is made if this is, for instance, the fourth BRAD cycle in which no adjustment has been made to the batch size, INQUIRY 2246. If this is not the fourth cycle with no adjustment, processing ends. Otherwise, the number of requests in a batch is increased by, for instance, ⅓ by setting the RS number of requests per batch to be four-thirds of the existing value, STEP 2248, and processing ends.

Returning to INQUIRY 2240, if all requests are completing in the current BRAD cycle, it may be possible to decrease the number of requests in a batch in order to spread out processing and achieve a more consistent, less disruptive periodic poll process. The accumulated wait time for the batch is compared to the smallest response for a request within the batch, INQUIRY 2250 (FIG. 22E). If the least time consuming requests took longer than the accumulated wait time in the batch, processing ends. Otherwise, the number of batches per BRAD cycle is determined from one added to the quotient of resources in the RS divided by the current number of requests in a batch, STEP 2252. The target number of batches is calculated by adding one to the current count, STEP 2254. The new number of requests per batch is calculated as the quotient of the number of resources in the RS divided by the number of desired batches, STEP 2256, and saved in the RS. Processing for this cycle of the BRAD process is complete.

Described in detail herein is a capability for dynamically managing the processing associated with executing requests to obtain information usable in managing an IT environment.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

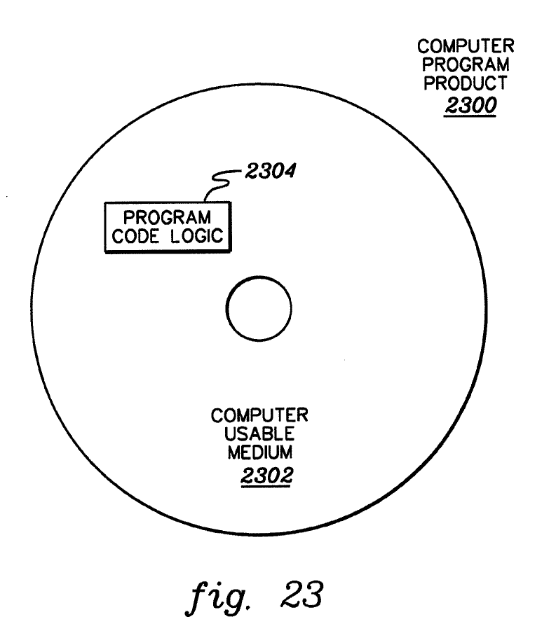

One example of an article of manufacture or a computer program product incorporating one or more aspects of the present invention is described with reference to FIG. 23. A computer program product 2300 includes, for instance, one or more computer usable media 2302 to store computer readable program code means or logic 2304 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Advantageously, a capability is provided for managing in real-time the gathering of information to be used in managing aspects of an Information Technology (IT) environment. Processing associated with the execution of a batch of requests within an allotted time frame is adjusted in real-time, in response to a determination of whether responses were received for the requests. Advantageously, the time period for executing requests can be adjusted, as well as the number of requests in a batch and the priority of the requests in the batch. Advantageously, at least a portion of the requests are executed concurrently.

Although various embodiments are described above, these are only examples. For example, the processing environments described herein are only examples of environments that may incorporate and use one or more aspects of the present invention. Environments may include other types of processing units or servers or the components in each processing environment may be different than described herein. Each processing environment may include additional, less and/or different components than described herein. Further, the types of central processing units and/or operating systems or other types of components may be different than described herein. Again, these are only provided as examples.

Moreover, an environment may include an emulator (e.g., software or other emulation mechanisms), in which a particular architecture or subset thereof is emulated. In such an environment, one or more emulation functions of the emulator can implement one or more aspects of the present invention, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to obtain instructions from memory and to optionally, provide local buffering for the obtained instruction; an instruction decode unit to receive the instruction fetched and to determine the type of instructions that have been fetched; and an instruction execution unit to execute the instructions. Execution may include loading data into a register for memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

Further, although the environments described herein are related to the management of availability of a customer's environment, one or more aspects of the present invention may be used to manage aspects other than or in addition to availability. Further, one or more aspects of the present invention can be used in environments other than a business resiliency environment.

Yet further, many examples are provided herein, and these examples may be revised without departing from the spirit of the present invention. For example, in one embodiment, the description is described in terms of availability and recovery; however, other goals and/or objectives may be specified in lieu of or in addition thereto. Additionally, the resources may be other than IT resources. Further, there may be references to particular products offered by International Business Machines Corporation or other companies. These again are only offered as examples, and other products may also be used. Additionally, although tables and databases are described herein, any suitable data structure may be used. There are many other variations that can be included in the description described herein and all of these variations are considered a part of the claimed invention.

Further, for completeness in describing one example of an environment in which one or more aspects of the present invention may be utilized, certain components and/or information is described that is not needed for one or more aspects of the present invention. These are not meant to limit the aspects of the present invention in any way.

One or more aspects of the present invention can be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider can receive payment from the customer under a subscription and/or fee agreement, as examples. Additionally or alternatively, the service provider can receive payment from the sale of advertising content to one or more third parties.

In one aspect of the present invention, an application can be deployed for performing one or more aspects of the present invention. As one example, the deploying of an application comprises providing computer infrastructure operable to perform one or more aspects of the present invention.

As a further aspect of the present invention, a computing infrastructure can be deployed comprising integrating computer readable code into a computing system, in which the code in combination with the computing system is capable of performing one or more aspects of the present invention.

As yet a further aspect of the present invention, a process for integrating computing infrastructure, comprising integrating computer readable code into a computer system may be provided. The computer system comprises a computer usable medium, in which the computer usable medium comprises one or more aspects of the present invention. The code in combination with the computer system is capable of performing one or more aspects of the present invention.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A computer-implemented method of managing the collection of information in an Information Technology (IT) environment, said computer-implemented method comprising:
executing a batch of queries within an allocated time period;
determining, in response to completion of the allocated time period, whether a response was not obtained for one or more queries of the batch of queries; and
dynamically adjusting, in real-time, processing associated with the batch of queries, in response to the determining.

2. The computer-implemented method of claim 1, wherein the dynamically adjusting processing associated with the batch of queries comprises dynamically adjusting the allocated time period.

3. The computer-implemented method of claim 1, wherein the dynamically adjusting processing associated with the batch of queries comprises dynamically adjusting the number of queries included in the batch of queries.

4. The computer-implemented method of claim 1, wherein the dynamically adjusting processing associated with the batch of queries comprises adjusting priority of one or more queries of the batch of queries.

5. The computer-implemented method of claim 1, wherein at least two queries of the batch of queries are executed concurrently.

6. The computer-implemented method of claim 1, wherein the batch of queries requests information relating to one or more resources of the IT environment.

7. The computer-implemented method of claim 6, wherein the information is used in managing the IT environment.

8. The computer-implemented method of claim 7, wherein the managing the IT environment comprises managing one or more of availability of the IT environment or monitoring of the IT environment.

9. The computer-implemented method of claim 6, wherein the time period is provided by a requester of the information.

10. The computer-implemented method of claim 1, wherein the batch of queries comprises a plurality of synchronous queries.

11. The computer-implemented method of claim 1, further comprising executing the batch of queries, in a next iteration, taking into consideration adjustments made by the dynamically adjusting, the batch of queries including a plurality of queries in which zero or more of those queries are unexecuted queries from a previous batch of queries.

12. The computer-implemented method of claim 1, wherein the allocated time period is dependent on a type of request provided by the batch of queries.

13. The computer-implemented method of claim 1, wherein the batch of queries is executed by one or more asynchronous distributors.

14. The computer-implemented method of claim 13, wherein the batch of queries request information from one or more resources, and wherein the one or more asynchronous distributors are co-located with the one or more resources.

15. A system of managing the collection of information in an Information Technology (IT) environment, said system comprising:
at least one asynchronous distributor to:
execute a batch of queries within an allocated time period;
determine, in response to completion of the allocated time period, whether a response was not obtained for one or more queries of the batch of queries; and
dynamically adjust, in real-time, processing associated with the batch of queries, in response to the determining.

16. The system of claim 15, wherein at least two queries of the batch of queries are executed concurrently.

17. The system of claim 15, further comprising executing the batch of queries in a next iteration taking into consideration adjustments made by the dynamically adjusting, the batch of queries including a plurality of queries in which zero or more of those queries are unexecuted queries from a previous batch of queries.

18. An article of manufacture comprising:
at least one computer usable medium having computer readable program code logic to manage the collection of information in an Information Technology (IT) environment, said computer readable program code logic when executing performing the following:
executing a batch of queries within an allocated time period;
determining, in response to completion of the allocated time period, whether a response was not obtained for one or more queries of the batch of queries; and
dynamically adjusting, in real-time, processing associated with the batch of queries, in response to the determining.

19. The article of manufacture of claim 18, wherein at least two queries of the batch of queries are executed concurrently.

20. The article of manufacture of claim 18, further comprising executing the batch of queries in a next iteration taking into consideration adjustments made by the dynamically adjusting, the batch of queries including a plurality of queries in which zero or more of those queries are unexecuted queries from a previous batch of queries.
